(19) United States
(12) Patent Application Publication
(10) Pub. No.: US 2026/0281901 A1
(43) Pub. Date: Sep. 17, 2026

(54) METHOD AND DEVICE FOR REDUCING POWER CONSUMPTION OF BASE STATION IN WIRELESS COMMUNICATION SYSTEM

(71) Applicant: Samsung Electronics Co., Ltd., Gyeonggi-do (KR)

(72) Inventors: Sungjin PARK, Gyeonggi-do (KR); Youngbum KIM, Gyeonggi-do (KR); Hyunseok RYU, Gyeonggi-do (KR); Junyung YI, Gyeonggi-do (KR)

(21) Appl. No.: 19/163,253

(22) PCT Filed: Mar. 4, 2024
(86) PCT No.: PCT/KR2024/002740

§ 371 Date: Sep. 8, 2025

(30) Foreign Application Priority Data
Mar. 8, 2023 (KR) 10-2023-0030686

(51) Int. Cl. H04W 52/02; H04W 72/21; H04W 76/28

(52) U.S. Cl. CPC H04W 52/0235; H04W 72/21; H04W 76/28

(57) ABSTRACT

The present disclosure relates to a 5G or 6G communication system for supporting higher data transmission rates. A method performed by a UE in a wireless communication system according to the present disclosure comprises the steps of: receiving a first signal, including cell discontinuous reception (DRX)-related information about a first cell, from a base station; and identifying a cell DRX non-active period on the basis of the cell DRX-related information, wherein a second signal may not be transmitted to the base station in a slot corresponding to the cell DRX non-active period.

### TECHNICAL FIELD

The disclosure relates to an operation of a terminal and a base station in a wireless communication system. Specifically, the disclosure relates to a method and a device for reducing the power consumption of a base station in a multi-cell environment in a wireless communication system.

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure is to provide a device and a method capable of effectively providing services in a wireless communication system.

### Solution to Problem

According to an embodiment of the disclosure, a method performed by a terminal in a wireless communication system of the disclosure may include receiving configuration information of cell DRX through a second signal indicating a second period, determining whether at least one symbol of a time resource of a first signal scheduled to a first cell is included in a first period, in case that at least one symbol in the time resource of the first signal overlaps with the second period, determining whether transmission is possible in a cell other than the first cell, and in case that another cell where transmission is possible is determined, transmitting the first signal through the determined other cell.

### Advantageous Effects of Invention

Embodiments proposed in the disclosure can provide a device and a method capable of effectively providing services in a wireless communication system.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a basic structure of a time-frequency domain in a wireless communication system according to an embodiment of the disclosure.

FIG. 2 illustrates a structure of a frame, a subframe, and a slot in a wireless communication system according to an embodiment of the disclosure.

FIG. 3 illustrates an example of a bandwidth part configuration in a wireless communication system according to an embodiment of the disclosure.

FIG. 4 illustrates an example of a control resource set configuration of a downlink control channel in a wireless communication system according to an embodiment of the disclosure.

FIG. 5 illustrates a structure of a downlink control channel in a wireless communication system according to an embodiment of the disclosure.

FIG. 6 illustrates, in terms of spans, a case in which a UE may have multiple PDCCH monitoring occasions within a slot in a wireless communication system according to an embodiment of the disclosure.

FIG. 7 illustrates an example of base station beam allocation according to a TCI state configuration in a wireless communication system according to an embodiment of the disclosure.

FIG. 8 illustrates an example of a method for TCI state allocation with regard to a PDCCH in a wireless communication system according to an embodiment of the disclosure.

FIG. 9 illustrates a TCI indication MAC CE signaling structure for a PDCCH DMRS in a wireless communication system according to an embodiment of the disclosure.

FIG. 10 illustrates an example of beam configuration with regard to a control resource set and a search space in a wireless communication system according to an embodiment of the disclosure.

FIG. 11 illustrates an example of a method in which a base station and a UE transmit/receive data in consideration of a downlink data channel and a rate matching resource in a wireless communication system according to an embodiment of the disclosure.

FIG. 12 illustrates an example of a method in which, upon receiving a downlink control channel, a UE selects a receivable control resource set in consideration of priority in a wireless communication system according to an embodiment of the disclosure.

FIG. 13 illustrates an example of an aperiodic CSI reporting method according to an embodiment of the disclosure.

FIG. 14 illustrates an example of PUSCH repetition type B transmission in a wireless communication system according to an embodiment of the disclosure.

FIG. 15 illustrates radio protocol structures of a base station and a UE in single cell, carrier aggregation, and dual connectivity situations according to an embodiment of the disclosure.

FIG. 16 illustrates an example of an antenna port configuration and resource allocation for cooperative communication in a wireless communication system according to an embodiment of the disclosure.

FIG. 17 illustrates an example of a downlink control information (DCI) configuration for cooperative communication in a wireless communication system according to an embodiment of the disclosure.

FIG. 18 illustrates a procedure in which a base station controls transmission power of a UE in a cellular system.

FIG. 19 illustrates a signal transmission/reception period of a base station in a wireless communication system according to an embodiment of the disclosure.

FIG. 20 illustrates an operation of a terminal when DTX/DRX is applied in a CA environment in a wireless communication system according to an embodiment of the disclosure.

FIG. 21 illustrates an operation of a terminal when DTX/DRX is applied in a CA environment in a wireless communication system according to an embodiment of the disclosure.

FIG. 22 illustrates an operation of a terminal when DTX/DRX is applied in a CA environment in a wireless communication system according to an embodiment of the disclosure.

FIG. 23 illustrates an operation of a terminal when DTX/DRX is applied in a CA environment in a wireless communication system according to an embodiment of the disclosure.

FIG. 24 illustrates an operation of a terminal when DTX/DRX is applied in a CA environment in a wireless communication system according to an embodiment of the disclosure.

FIG. 25 illustrates an operation of a terminal in a wireless communication system according to an embodiment of the disclosure.

FIG. 26 illustrates a structure of a UE in a wireless communication system according to an embodiment of the disclosure.

FIG. 27 illustrates a structure of a base station in a wireless communication system according to an embodiment of the disclosure.

### MODE FOR THE INVENTION

To meet the demand for wireless data traffic having increased since deployment of 4G communication systems, efforts have been made to develop an improved 5G or pre-5G communication system. Therefore, the 5G or pre-5G communication system is also called a “beyond 4G network” communication system or a “post LTE” system. The 5G communication system is considered to be implemented in ultrahigh frequency (mmWave) bands, (e.g., 60 GHz bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems. In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (CoMPs), reception-end interference cancellation, and the like. In the 5G system, hybrid FSK and QAM modulation (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems (5th generation communication system or new radio (NR)) to IoT networks. For example, technologies such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology.

With the advance of wireless communication systems as described above, various services can be provided, and accordingly there is a need for ways to smoothly provide these services.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to abase station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB). IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS, eNode B, or gNode B), and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB. URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

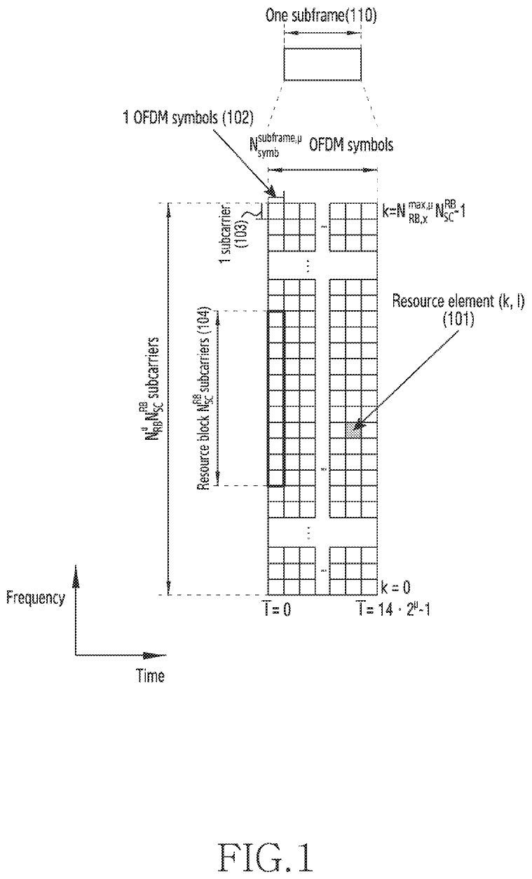

FIG. 1 illustrates a basic structure of a time-frequency domain in a wireless communication system according to an embodiment of the disclosure.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104.

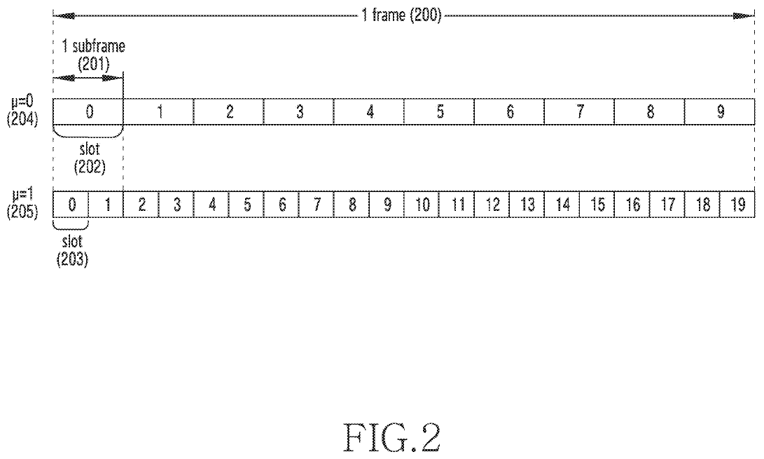

FIG. 2 illustrates a structure of a frame, a subframe, and a slot in a wireless communication system according to an embodiment of the disclosure.

Referring to FIG. 2, an example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{symb}^{slot} = 14 ) .$$

One subframe 201 may include one or multiple slots 202 and 203, and the number of slots 202 and 203 per one subframe 201 may vary depending on configuration values p for the subcarrier spacing 204 or 205. FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration μ as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

[Bandwidth part (BWP)] Next, a bandwidth part (BWP) configuration in a 5G communication system will be described in detail with reference to the accompanying drawings.

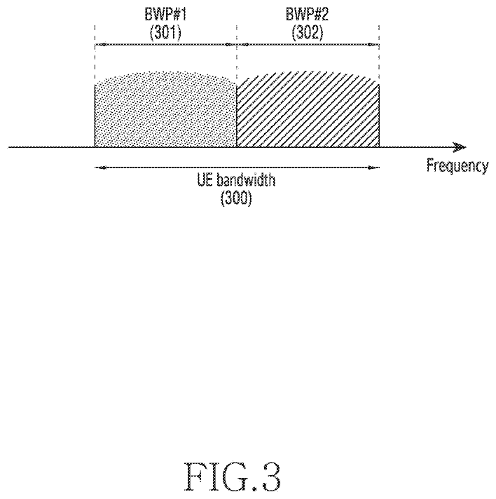

FIG. 3 illustrates an example of a bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Obviously, the above example is not limiting, and various parameters related to the bandwidth part may be configured for the UE, in addition to the above configuration information. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI). According to some embodiments, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1)necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient in terms of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given in Table 3 below, for example.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
^{Note 2}
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part change delay time type to the base station. If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. In addition, the UE may transmit/receive a data channel scheduled by the corresponding DCI in the changed new bandwidth part. According to an embodiment, if the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [SS/PBCH Block]

Next, synchronization signal (SS)/PBCH blocks in 5G will be described.

An SS/PBCH block may refer to a physical layer channel block including a primary synchronization signal (PSS), a secondary synchronization signal (SSS), and a PBCH. Details thereof are as follows.
PSS: a signal which becomes a reference of downlink time/frequency synchronization, and provides partial information of a cell ID.
SSS: A reference for downlink time/frequency synchronization, and may provide the remaining cell ID information not provided by the PSS. Additionally, the SSS may serve as a reference signal for PBCH demodulation of a PBCH.
PBCH: provides an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: may include a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) may be transferred from abase station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

```
TABLE 4
  - Identifier for DCI formats - [1] bit
  - Frequency domain resource assignment
$[ ⌈ {log}_{2} ( {N}_{RB}^{UL , BWP} ( {N}_{RB}^{UL , BWP} + 1 ) / 2 ) ⌉ ] bits$
  - Time domain resource assignment - X bits
  - Frequency hopping flag - 1 bit.
  - Modulation and coding scheme - 5 bits
  - New data indicator - 1 bit
  - Redundancy version - 2 bits
  - HARQ process number - 4 bits
  - Transmit power control (TPC) command for scheduled PUSCH - [2] bits
  - Uplink/supplementary uplink (UL/SUL) indicator - 0 or 1 bit
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

```
TABLE 5
  - Carrier indicator - 0 or 3 bits
  - UL/SUL indicator - 0 or 1 bit
  - Identifier for DCI formats - [1] bits
  - Bandwidth part indicator -- 0, 1 or 2 bits
  - Frequency domain resource assignment
            $* For resource allocation type 0 , ⌈ {N}_{RB}^{UL , BWP} / P ⌉ bits$
            $* For resource allocation type 1 , ⌈ {log}_{2} ( {N}_{RB}^{UL , BWP} ( {N}_{RB}^{UL , BWP} + 1 ) / 2 ) ⌉$
            bits
  - Time domain resource assignment -1, 2, 3, or 4 bits
  - Virtual resource block (VRB)-to-physical resource block (PRB) mapping -
0 or 1 bit, only for resource allocation type 1.
            * 0 bit if only resource allocation type 0 is configured;
            * 1 bit otherwise.
  - Frequency hopping flag - 0 or 1 bit, only for resource allocation type 1.
            * 0 bit if only resource allocation type 0 is configured;
            * 1 bit otherwise.
  - Modulation and coding scheme - 5 bits
  - New data indicator - 1 bit
  - Redundancy version - 2 bits
  - HARQ process number - 4 bits
  - 1st downlink assignment index- 1 or 2 bits
            * 1 bit for semi-static HARQ-ACK codebook;
            * 2 bits for dynamic HARQ-ACK codebook with single HARQ-
            ACK codebook.
  - 2nd downlink assignment index - 0 or 2 bits
            * 2 bits for dynamic HARQ-ACK codebook with two HARQ-
            ACK sub-codebooks;
            * 0 bit otherwise.
  - TPC command for scheduled PUSCH - 2 bits
$‐ SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
            $* ⌈ {log}_{2} ( {\sum }_{k = 1}^{{L}_{max}} ( \begin{matrix}{N}_{SRS} \\ k\end{matrix} ) ) ⌉ bits for non - codebook based PUSCH$
            transmission;
            * ┌log₂(N_{SRS})┐ bits for codebook based PUSCH transmission.
  - Precoding information and number of layers - up to 6 bits
  - Antenna ports - up to 5 bits
  - SRS request - 2 bits
  - Channel state information (CSI) request - 0, 1, 2, 3, 4, 5, or 6 bits
  - Code block group (CBG) transmission information - 0, 2, 4, 6, or 8 bits
  - Phase tracking reference signal (PTRS)-demodulation reference signal
(DDMRS) association - 0 or 2 bits.
  - beta offset indicator - 0 or 2 bits
  - DMRS sequence initialization - 0 or 1 bit
```

DOI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

```
TABLE 6
  - Identifier for DCI formats - [1] bit
  - Frequency domain resource assignment -
$[ ⌈ {log}_{2} ( {N}_{RB}^{DL , BWP} ( {N}_{RB}^{DL , BWP} + 1 ) / 2 ) ⌉ ] bits$
  - Time domain resource assignment - X bits
  - VRB-to-PRB mapping - 1 bit.
  - Modulation and coding scheme - 5 bits
  - New data indicator - 1 bit
  - Redundancy version - 2 bits
  - HARQ process number - 4 bits
  - Downlink assignment index - 2 bits
  - TPC command for scheduled PUCCH - [2] bits
  - Physical uplink control channel (PUCCH) resource indicator - 3 bits
  - PDSCH-to-HARQ feedback timing indicator - [3] bits
```

DCI format 1_1 may be used as non-fallback DCI for scheduling a PDSCH, and in this case, the CRC may be scrambled by a C-RNTI. DCI format 1_1 in which the CRC is scrambled by a C-ENRI may include the following pieces of information given in Table 7 below, for example.

```
TABLE 7
  - Carrier indicator - 0 or 3 bits
  - Identifier for DCI formats - [1] bits
  - Bandwidth part indicator - 0, 1 or 2 bits
  - Frequency domain resource assignment
            $* For resource allocation type 0 , ⌈ {N}_{RB}^{DL , BWP} / P ⌉ bits$
            $* For resource allocation type 1 , ⌈ {log}_{2} ( {N}_{RB}^{DL , BWP} ( {N}_{RB}^{DL , BWP} + 1 ) / 2 ) ⌉$
            bits
  - Time domain resource assignment -1, 2, 3, or 4 bits
  - VRB-to-PRB mapping - 0 or 1 bit, only for resource allocation type 1.
            * 0 bit if only resource allocation type 0 is configured;
            * 1 bit otherwise.
  - Physical resource block (PRB) bundling size indicator - 0 or 1 bit
  - Rate matching indicator - 0, 1, or 2 bits
  - Zero power (ZP) channel state information (CSI)-reference signal (RS)
trigger - 0, 1, or 2 bits
  For transport block 1:
    -  Modulation and coding scheme - 5 bits
    -  New data indicator - 1 bit
    -  Redundancy version - 2 bits
  For transport block 2:
    -  Modulation and coding scheme - 5 bits
    -  New data indicator - 1 bit
    -  Redundancy version - 2 bits
  - HARQ process number - 4 bits
  - Downlink assignment index - 0 or 2 or 4 bits
  - TPC command for scheduled PUCCH - 2 bits
  - PUCCH resource indicator - 3 bits
  - PDSCH-to-HARQ feedback timing indicator - 3 bits
  - Antenna ports - 4, 5 or 6 bits
  - Transmission configuration indication - 0 or 3 bits
  - SRS request - 2 bits
  - CBG transmission information - 0, 2, 4, 6, or 8 bits
  - CBG flushing out information - 0 or 1 bit
  - DMRS sequence initialization - 1 bit
```

[PDCCH: CORESET, REG, CCE, and Search Space] Hereinafter, a downlink control channel in a 5G communication system will be described in more detail with reference to the accompanying drawings.

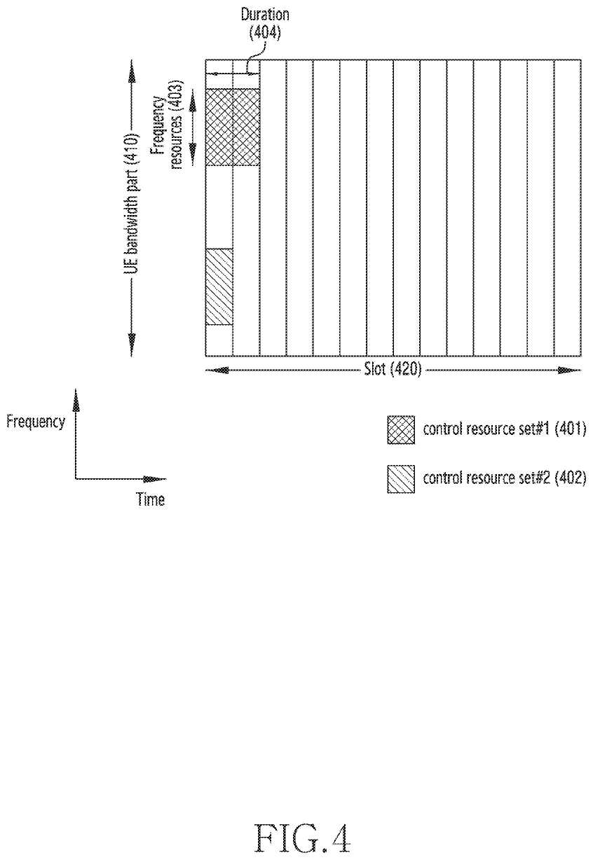

FIG. 4 illustrates an example of a control resource set (CORESET) used to transmit a downlink control channel in a 5G wireless communication system.

FIG. 4 illustrates an example in which a UE bandwidth part 410 is configured along the frequency axis, and two control resource sets (control resource set #1 401 and control resource set #2 402) are configured within one slot 420 along the time axis. The control resource sets 401 and 402 may be configured in a specific frequency resource 410 within the entire UE bandwidth part 403 along the frequency axis. The control resource sets 401 and 402 may be each configured as one or multiple OFDM symbols along the time domain, and the number of the OFDM symbols may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through upper layer signaling (for example, system information, master information block (MIB), radio resource control (RRC)signaling). The description that a control resource set is configured for a UE means that information such as a control resource set identity, the control resource set's frequency location, and the control resource set's symbol duration is provided. For example, the control resource set may include the following pieces of information: given in Table 8 below.

TABLE 8

| ConControlResourceSet ::= | SEQUENCE { |
|---|---|
| -- Corresponds to L1 parameter ‘CORESET-ID’ | |
| controlResourceSetId | ControlResourceSetId, |
| (control resource set identity) | |
| frequencyDomainResources | BIT STRING (SIZE (45)), |
| (frequency domain resource assignment information) | |
| duration | INTEGER (1..maxCoReSetDuration), |
| (time domain resource assignment information) | |
| cce-REG-MappingType | CHOICE { |
| (CCE-to-REG mapping type) | |
| interleaved | SEQUENCE { |
| reg-BundleSize | ENUMERATED {n2, n3, n6}, |
| (REG bundle size) | |
| precoderGranularity | ENUMERATED {sameAsREG- |
| bundle, allContiguousRBs}, | |
| interleaverSize | ENUMERATED {n2, n3, n6} |
| (interleaver size) | |
| shiftIndex | INTEGER(0..maxNrofPhysicalR |
| esourceBlocks-1) | OPTIONAL |
| (interleaver shift) | |
| }, | |
| nonInterleaved | NULL |
| }, | |
| tci-StatesPDCCH | SEQUENCE(SIZE (1..maxNrof |
| TCI-StatesPDCCH)) OF TCI-StateId | OPTIONAL, |
| (QCL configuration information) | |
| tci-PresentInDCI | ENUMERATED {enabled} |
| | OPTIONAL, ... Need S |
| } | |

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set.

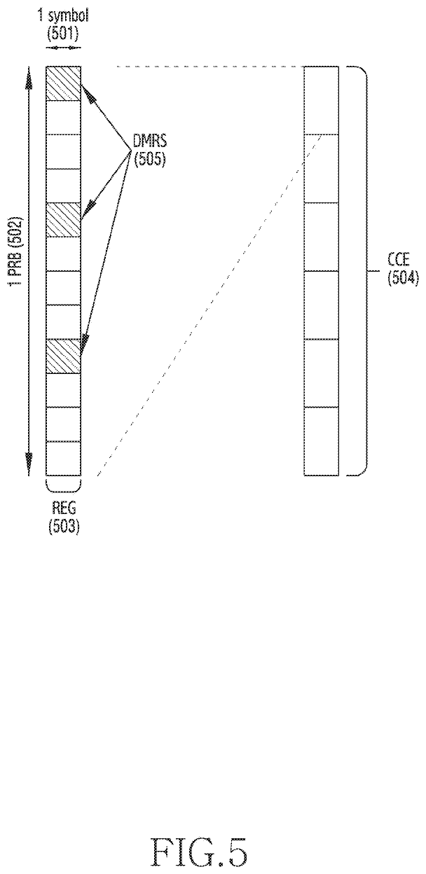

FIG. 5 illustrates a structure of a downlink control channel in a wireless communication system according to an embodiment of the disclosure. FIG. 5 illustrates an example of a basic unit of time and frequency resources constituting a downlink control channel available in 5G.

According to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element 504 as illustrated in FIG. 5, one CCE 504 may include multiple REGs 503. To describe the REG 503 illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the control resource set may include the following pieces of information: given in Table 9 below.

TABLE 9

| | |
|---|---|
| SearchSpace ::= | SEQUENCE { |

-- Identity of the search space. SearchSpaceId = 0 identifies the SearchSpace
configured via PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration (monitoring duration) | INTEGER (2..2559) |
| monitoringSymbolsWithinSlot | BIT STRING (SIZE (14)) |

```
        OPTIONAL,
  (monitoring symbols within slot)
```

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, |

n6, n8},

| | |
|---|---|
| aggregationLevel2 | ENUMERATED {n0, n1, n2, n3, n4, n5, |

n6, n8},

| | |
|---|---|
| aggregationLevel4 | ENUMERATED {n0, n1, n2, n3, n4, n5, |

n6, n8},

| | |
|---|---|
| aggregationLevel8 | ENUMERATED {n0, n1, n2, n3, n4, n5, |

n6, n8},

| | |
|---|---|
| aggregationLevel16 | ENUMERATED {n0, n1, n2, n3, n4, n5, |

n6, n8}
},

| | |
|---|---|
| searchSpaceType | CHOICE { |

```
  (search space type)
      -- Configures this search space as common search space (CSS) and DCI formats
to monitor.
```

| | |
|---|---|
| common | SEQUENCE { |

```
  (common search space)
    }
```

| | |
|---|---|
| ue-Specific | SEQUENCE { |

```
  (UE-specific search space)
        -- Indicates whether the UE monitors in this USS for DCI formats 0-0 and 1-0 or
for formats 0-1 and 1-1.
```

| | |
|---|---|
| formats | ENUMERATED {formats0-0-And-1-0, formats0-1-A |

nd-1-1},
...
}

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2. According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the examples given below are not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI
Enumerated RNTIs may follow the definition and usage given below
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS
The DCI formats enumerated above may follow the definitions given in Table 10 below, for example. However, the disclosure is not limited thereto.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH |
| | and PUSCH |
| 2_3 | Transmission of a group of TPC commands for SRS |
| | transmissions by one or more UEs |

In 5G, the search space at aggregation level L in connection with control resource set p and search space set s may be expressed by the equation below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level
   n_{CI}: carrier index
      N_{CCE,p}: total number of CCEs existing in control resource set p

$${n}_{s , f}^{μ} :$$

slot index

$${M}_{s , max}^{( L )} :$$

number of PDCCH candidates at aggregation level L
m_{s,n}_{_{CI}}=0, . . . ,

$${M}_{s , max}^{( L )} - 1 :$$

PDCCH candidate index at aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The

$${Y}_{p , {n}_{s , f}^{μ}}$$

value may correspond to 0 in the case of a common search space. The

$${Y}_{p , {n}_{s , f}^{μ}}$$

value may correspond to a value changed by the UE's identity (C-RNTI or ID configured for the UE by the base station) and the time index in the case of a UE-specific search space.

In 5G, multiple search space sets may be configured by different parameters (for example, parameters in Table 10), and the group of search space sets monitored by the UE at each time point may differ accordingly. For example, if search space set #1 is configured at X-slot periodicity, if search space set #2 is configured at Y-slot periodicity, and if X and Y are different, the UE may monitor search space set #1 and search space set #2 both in a specific slot, and may monitor one of search space set #1 and search space set #2 both in another specific slot.

### [PDCCH: Span]

The UE may perform UE capability reporting at each subcarrier spacing with regard to a case in which the same has multiple PDCCH monitoring occasions inside a slot, and the concept “span” may be used in this regard. A span refers to consecutive symbols configured such that the UE can monitor the PDCCH inside the slot, and each PDCCH monitoring occasion is inside one span. A span may be described by (X,Y) wherein X refers to the minimum number of symbols by which the first symbols of two consecutive spans are spaced apart from each other, and Y refers to the number of consecutive symbols configured such that the PDCCH can be monitored inside one span. The UE may monitor the PDCCH in a range inside a span corresponding to Y symbols from the first symbol of the span.

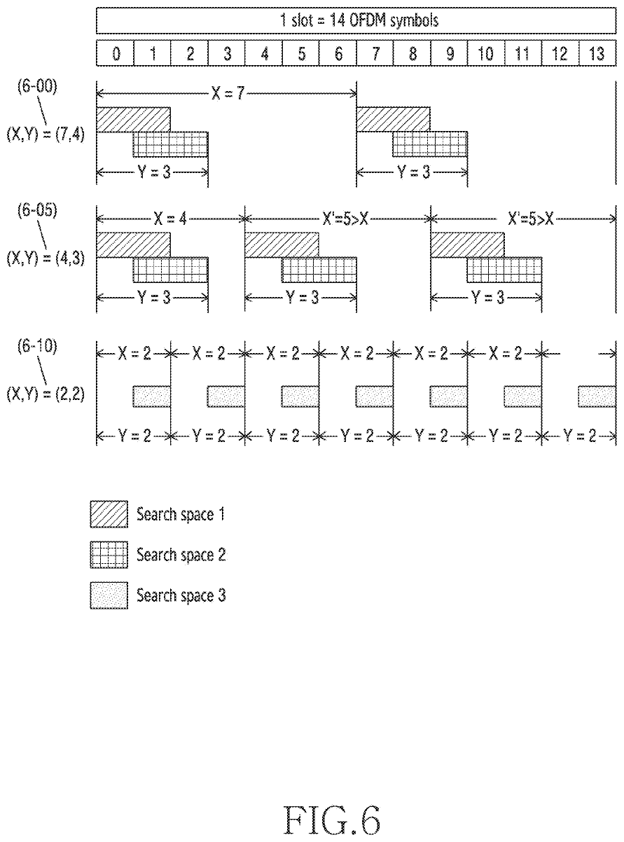

FIG. 6 illustrates, in terms of spans, a case in which a UE may have multiple PDCCH monitoring occasions inside a slot in a wireless communication system. Possible spans are (X,Y)=(7,3), (4,3), (2,2), and the three cases may be indicated by “6-00”, “6-05”, and “6-10” in FIG. 6, respectively. As an example, “6-00” may describe a case in which there are two spans described by (7,4) inside a slot. The spacing between the first symbols of two spans is described as X=7, a PDCCH monitoring occasion may exist inside a total of Y=3 symbols from the first symbol of each span, and search spaces 1 and 2 may exist inside Y=3 symbols, respectively. As another example, “6-05” may describe a case in which there are a total of three spans described by (4,3) inside a slot, and the second and third spans are spaced apart by X′=5 symbols which are larger than X=4.

### [PDCCH: UE Capability Report]

The slot location at which the above-described common search space and the UE-specific search space are positioned is indicated by parameter “monitoringSymbolsWithinSlot” in Table 13-1, and the symbol location inside the slot is indicated as a bitmap through parameter “monitoringSymbolsWithinSlot” in Table 9. Meanwhile, the symbol location inside a slot at which the UE can monitor search spaces may be reported to the base station through the following UE capabilities.
UE capability 1 (hereinafter referred to as FG 3-1). This UE capability may have the following meaning: if there is one monitoring occasion (MO) regarding type 1 and type 3 common search spaces or UE-specific search spaces inside a slot, as in Table 11 below, the UE can monitor the corresponding MO when the corresponding MO is located inside the first three symbols within the slot. This UE capability is a mandatory capability which is to be supported by all UEs that support NR, and whether or not UE capability 1 is supported is not explicitly reported to the base station.

TABLE 11

| | Feature | | Field name in |
|---|---|---|---|
| Index | group | Components | TS 38.331 [2] |
| 3-1 | Basic DL | 1) One configured CORESET per BWP per cell in addition | n/a |
| | control | to CORESET0 | |
| | channel | CORESET resource allocation of 6RB bit-map and | |
| | | duration of 1-3 OFDM symbols for FR1 | |
| | | For type 1 CSS without dedicated RRC configuration and | |
| | | for type 0, 0A, and 2 CSSs, CORESET resource allocation | |
| | | of 6RB bit-map and duration 1-3 OFDM symbols for FR2 | |
| | | For type 1 CSS with dedicated RRC configuration and | |
| | | for type 3 CSS, UE specific SS, CORESET resource | |
| | | allocation of 6RB bit-map and duration 1-2 OFDM | |
| | | symbols for FR2 | |
| | | REG-bundle sizes of 2/3 RBs or 6 RBs | |
| | | Interleaved and non-interleaved CCE-to-REG mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast PDCCH | |
| | | transmission per BWP per cell | |
| | | PDCCH aggregation levels 1, 2, 4, 8, 16 | |
| | | UP to 3 search space sets in a slot for a scheduled SCell | |
| | | per BWP | |
| | | This search space limit is before applying all dropping | |
| | | rules. | |
| | | For type 1 CSS with dedicated RRC configuration, type 3 | |
| | | CSS, and UE-SS, the monitoring occasion is within the | |
| | | first 3 OFDM symbols of a slot | |
| | | For type 1 CSS without dedicated RRC configuration and | |
| | | for type 0, 0A, and 2 CSS, the monitoring occasion can be | |
| | | any OFDM symbol(s) of a slot, with the monitoring | |
| | | occasions for any of Type 1- CSS without dedicated RRC | |
| | | configuration, or Types 0, 0A, or 2 CSS configurations | |
| | | within a single span of three consecutive OFDM symbols | |
| | | within a slot | |
| | | 3) Monitoring DCI formats 0_0, 1_0, 0_1, 1_1 | |
| | | 4) Number of PDCCH blind decodes per slot with a given | |
| | | SCS follows Case 1-1 table | |
| | | 5) Processing one unicast DCI scheduling DL and one | |
| | | unicast DCI scheduling UL per slot per scheduled CC for | |
| | | FDD | |
| | | 6) Processing one unicast DCI scheduling DL and 2 | |
| | | unicast DCI scheduling UL per slot per scheduled CC for | |
| | | TDD | |

UE capability 2 (hereinafter referred to as FG 3-2). This UE capability has the following meaning: if there is one monitoring occasion (MO) regarding a common search space or a UE-specific search space inside a slot, as in Table 12 below, the UE can monitor the corresponding MO no matter what of the start symbol location of the corresponding MO may be. This UE capability is optionally supported by the UE, and whether or not this UE capability is supported is explicitly reported to the base station.

TABLE 12

| Index | Feature group | Components | Field name in TS 38.331 [2] |
|---|---|---|---|
| 3-2 | PDCCH | For a given UE, all search space | pdcchMonitoringSingleOccasion |
| | monitoring on | configurations are within the same | |
| | any span of up | span of 3 consecutive OFDM | |
| | to 3 | symbols in the slot | |
| | consecutive | | |
| | OFDM | | |
| | symbols of a | | |
| | slot | | |

UE capability 3 (hereinafter, referred to as FG 3-5, 3-5a, or 3-5b). This UE capability has the following meaning if there are multiple monitoring occasions (MO) regarding a common search space or a UE-specific search space inside a slot, as in Table 13 below, the pattern of the MO which the UE can monitor is indicated. The above-mentioned pattern includes the spacing X between start symbols of different MOs and the maximum symbol length Y regarding one MO. The combination of (X,Y) supported by the UE may be one or multiple among {(2,2), (4,3), (7,3)}. This UE capability is optionally supported by the UE, and whether or not this UE capability is supported and the above-mentioned combination of (X,Y) are explicitly reported to the base station.

TABLE 13

| | | | Field name in TS 38.331 |
|---|---|---|---|
| Index | Feature group | Components | [2] |
| 3-5 | For type 1 | For type 1 CSS with dedicated | pdcch- |
| | CSS with | RRC configuration, type 3 CSS, | MonitoringAnyOccasions |
| | dedicated | and UE-SS, monitoring occasion | {3-5. withoutDCI-Gap |
| | RRC | can be any OFDM symbol(s) of a | 3-5a. withDCI-Gap} |
| | configuration, | slot for Case 2 | |
| | type 3 CSS, | | |
| | and UE-SS, | | |
| | monitoring | | |
| | occasion can | | |
| | be any OFDM | | |
| | symbol(s) of a | | |
| | slot for Case 2 | | |
| 3-5a | For type 1 | For type 1 CSS with dedicated | |
| | CSS with | RRC configuration, type 3 CSS | |
| | dedicated | and UE-SS, monitoring occasion | |
| | RRC | can be any OFDM symbol(s) of a | |
| | configuration, | slot for Case 2, with minimum | |
| | type 3 CSS, | time separation (including the | |
| | and UE-SS, | cross-slot boundary case) between | |
| | monitoring | two DL unicast DCIs, between two | |
| | occasion can | UL unicast DCIs, or between a DL | |
| | be any OFDM | and an UL unicast DCI in different | |
| | symbol(s) of a | monitoring occasions where at | |
| | slot for Case 2 | least one of them is not the | |
| | with a DCI | monitoring occasions of FG-3-1, | |
| | gap | for a same UE as | |
| | | 2OFDM symbols for | |
| | | 15 kHz | |
| | | 4OFDM symbols for | |
| | | 30 kHz | |
| | | 7OFDM symbols for | |
| | | 60 kHz with NCP | |
| | | 11OFDM symbols for | |
| | | 120 kHz | |
| | | Up to one unicast DL DCI and up | |
| | | to one unicast UL DCI in a | |
| | | monitoring occasion except for the | |
| | | monitoring occasions of FG 3-1. | |
| | | In addition for TDD the minimum | |
| | | separation between the first two | |
| | | UL unicast DCIs within the first 3 | |
| | | OFDM symbols of a slot can be | |
| | | zero OFDM symbols. | |
| 3-5b | All PDCCH | PDCCH monitoring occasions of | |
| | monitoring | FG-3-1, plus additional PDCCH | |
| | occasion can | monitoring occasion(s) can be any | |
| | be any OFDM | OFDM symbol(s) of a slot for | |
| | symbol(s) of a | Case 2, and for any two PDCCH | |
| | slot for Case 2 | monitoring occasions belonging to | |
| | with a span | different spans, where at least one | |
| | gap | of them is not the monitoring | |
| | | occasions of FG-3-1, in same or | |
| | | different search spaces, there is a | |
| | | minimum time separation of X | |
| | | OFDM symbols (including the | |
| | | cross-slot boundary case) between | |
| | | the start of two spans, where each | |
| | | span is of length up to Y | |
| | | consecutive OFDM symbols of a | |
| | | slot. Spans do not overlap. Every | |
| | | span is contained in a single slot. | |
| | | The same span pattern repeats in | |
| | | every slot. The separation between | |
| | | consecutive spans within and | |
| | | across slots may be unequal but | |
| | | the same (X, Y) limit must be | |
| | | satisfied by all spans. Every | |
| | | monitoring occasion is fully | |
| | | contained in one span. In order to | |
| | | determine a suitable span pattern, | |
| | | first a bitmap b(1), 0 <= 1 <= 13 is | |
| | | generated, where b(1) = 1 if symbol | |
| | | 1 of any slot is part of a monitoring | |
| | | occasion, b(1) = 0 otherwise. The | |
| | | first span in the span pattern | |
| | | begins at the smallest 1 for which | |
| | | b(1) = 1. The next span in the span | |
| | | pattern begins at the smallest 1 not | |
| | | included in the previous span(s) | |
| | | for which b(1) = 1. The span | |
| | | duration is max (maximum value | |
| | | of all CORESET durations, | |
| | | minimum value of Y in the UE | |
| | | reported candidate value} except | |
| | | possibly the last span in a slot | |
| | | which can be of shorter duration. A | |
| | | particular PDCCH monitoring | |
| | | configuration meets the UE | |
| | | capability limitation if the span | |
| | | arrangement satisfies the gap | |
| | | separation for at least one (X, Y) | |
| | | in the UE reported candidate value | |
| | | set in every slot, including cross | |
| | | slot boundary. | |
| | | For the set of monitoring | |
| | | occasions which are within the | |
| | | same span: | |
| | | Processing one unicast | |
| | | DCI scheduling DL and one | |
| | | unicast DCI scheduling UL per | |
| | | scheduled CC across this set of | |
| | | monitoring occasions for FDD | |
| | | Processing one unicast | |
| | | DCI scheduling DL and two | |
| | | unicast DCI scheduling UL per | |
| | | scheduled CC across this set of | |
| | | monitoring occasions for TDD | |
| | | Processing two unicast | |
| | | DCI scheduling DL and one | |
| | | unicast DCI scheduling UL per | |
| | | scheduled CC across this set of | |
| | | monitoring occasions for TDD | |
| | | The number of different start | |
| | | symbol indices of spans for all | |
| | | PDCCH monitoring occasions per | |
| | | slot, including PDCCH monitoring | |
| | | occasions of FG-3-1, is no more | |
| | | than floor(14/X) (X is minimum | |
| | | among values reported by UE). | |
| | | The number of different start | |
| | | symbol indices of PDCCH | |
| | | monitoring occasions per slot | |
| | | including PDCCH monitoring | |
| | | occasions of FG-3-1, is no more | |
| | | than 7. | |
| | | The number of different start | |
| | | symbol indices of PDCCH | |
| | | monitoring occasions per half-slot | |
| | | including PDCCH monitoring | |
| | | occasions of FG-3-1 is no more | |
| | | than 4 in SCell. | |

The UE may report whether the above-described UE capability 2 and/or UE capability 3 are supported and relevant parameters to the base station. The base station may allocate time-domain resources to the common search space and the UE-specific search space, based on the UE capability report. During the resource allocation, the base station may ensure that the MO is not positioned at a location at which the UE cannot monitor the same.

### [QCL, TCI State]

In a wireless communication system, one or more different antenna ports (which may also be replaced with one or more channels, signals, and combinations thereof, but will hereinafter be referred to as different antenna ports for convenience of description) may be associated with each other by a quasi co-location (QCL) configuration as in Table 3 below. A TCI state is for announcing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 3 below.

TABLE 14

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 4 below. Referring to Table 15, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) included in each TCI state includes the serving cell index and the BWP index of the reference RS indicated by the corresponding QCL information, the type and ID of the reference RS, and a QCL type as in Table 14 above.

TABLE 15

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first refernece RS of RS (target RS) referring to
corresponding TCI state ID)

| | |
|---|---|
| qcl-Type2 | QCL-Info OPTIONAL, |

```
  -- Need R
  (QCL information of second refernece RS of RS (target RS) referring
to corresponding TCI state ID)
  ...
}
```

| | |
|---|---|
| QCL-Info ::= | SEQUENCE { |
| cell | ServCellIndex OPTIONAL, -- |

```
Need R
  (serving cell index of reference RS indicated by corresponding QCL
  information)
```

| | |
|---|---|
| bwp-Id | BWP-Id OPTIONAL, - |

```
- Cond CSI-RS-Indicated
  (BWP index of reference RS indicated by corresponding QCL
  information)
```

| | |
|---|---|
| referenceSignal | CHOICE { |
| csi-rs | NZP-CSI-RS-ResourceId, |
| ssb | SSB-Index |

```
    (one of CSI-RS ID or SSB ID indicated by corresponding QCL
    information)
  },
```

| | |
|---|---|
| qcl-Type | ENUMERATED {typeA, typeB, typeC, |

typeD},
...
}

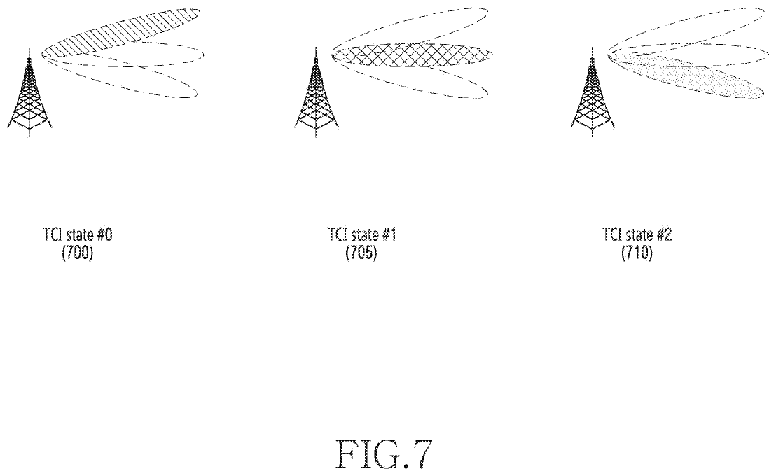

FIG. 7 illustrates an example of base station beam allocation according to TCI state configuration in a wireless communication system according to an embodiment of the disclosure. Referring to FIG. 7, the base station may transfer information regarding N different beams to the UE through N different TCI states. For example, in the case of N=3 as in FIG. 7, the base station may configure qcl-Type2 parameters included in three TCI states 700, 705, and 710 in QCL type D while being associated with CSI-RSs or SSBs corresponding to different beams, thereby notifying that antenna ports referring to the different TCI states 700, 705, and 710 are associated with different spatial Rx parameters, that is, different beams.

Tables 16 to 20 below enumerate valid TCI state configurations according to the target antenna port type.

Table 16 enumerates valid TCI state configurations when the target antenna port is a CSI-RS for tracking (TRS). The TRS may refer to an NZP CSI-RS which has no repetition parameter configured therefor, and trs-Info of which is configured as “true”, among CRI-RSs. In Table 16, configuration no. 3 may be used for an aperiodic TRS.

TABLE 16

| Valid TCI | | | DL RS 2 | qcl- Type2 |
|---|---|---|---|---|
| state | | | (If | (If |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 17 enumerates valid TCI state configurations when the target antenna port is a CST-RS for CSI. The CSI-RS for CST may refer to an NZP CST-RS which has no parameter indicating repetition (for example, repetition parameter) configured therefor, and trs-Info of which is not configured as “true”, among CRI-RSs.

TABLE 17

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS | QCL-TypeD |
| | | | (same as DL | |
| | | | RS 1) | |
| 4 | TRS | QCL-TypeB | | |

Table 18 enumerates valid TCI state configurations when the target antenna port is a CSI-RS for beam management (BM) (which has the same meaning as CSI-RS for L1 RSRP reporting). The CSI-RS for BM refers to an NZP CST-RS which has petition parameter configured to have a value of “on” or “off”, and trs-Info of which is not configured as “true”, among CRI-RSs.

TABLE 18

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 19 enumerates valid TCI state configurations when the target antenna port is a PDCCH DMRS.

TABLE 19

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 20 enumerates valid TCI state configurations when the target antenna port is a PDSCH DMRS.

TABLE 20

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

According to a representative QCL configuration method based on Tables 16 to 20 above, the target antenna port and reference antenna port for each step are configured and operated such as “SSB”->“TRS”->“CSI-RS for CSI, or CSI-RS for BM, or PDCCH DMRS, or PDSCH DMRS”. Accordingly, it may be possible to help the UE's receiving operation by associating statistical characteristics that can be measured from the SSB and TRS with respective antenna ports.

### [PDCCH: Regarding TCI State]

Specific TCI state combinations applicable to a PDCCH DMRS antenna port may be given in Table 21 below. The fourth row in Table 21 corresponds to a combination assumed by the UE before RRC configuration, and no configuration is possible after the RRC.

TABLE 21

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | | |
| | (CSI) | | | |
| 4 | SS/PBCH | QCL-TypeA | SS/PBCH | QCL-TypeD |
| | Block | | Block | |

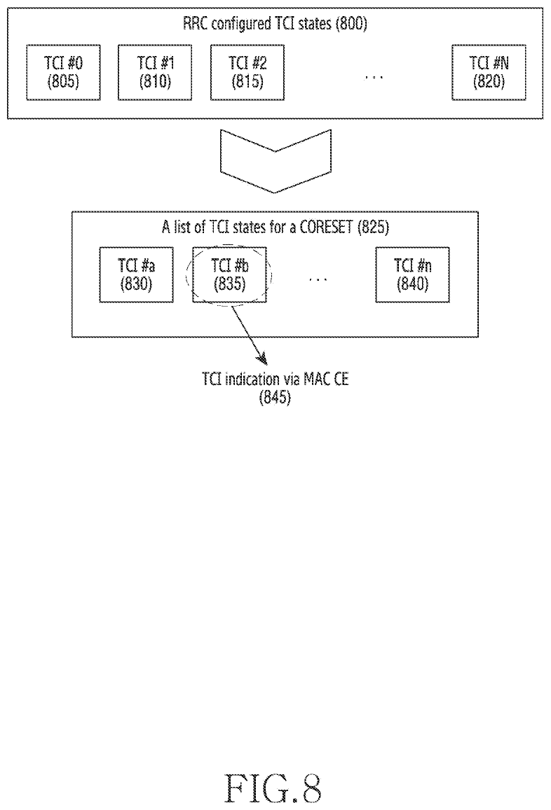

FIG. 8 illustrates an example of a method for TCI state allocation with regard to a PDCCH in a wireless communication system according to an embodiment of the disclosure. In NR, a hierarchical signaling method as illustrated in FIG. 8 is supported for dynamic allocation regarding a PDCCH beam.

Referring to FIG. 8, the base station may configure NTCI states 805, 810, . . . , 820 for the UE through RRC signaling 800, and may configure some of the states as TCI states for a CORESET (825). The base station may then indicate one of the TCI states 830, 835, and 840 for the CORESET to the UE through MAC CE signaling (845). The UE may then receive a PDCCH, based on beam information included in the TCI state indicated by the MAC CE signaling.

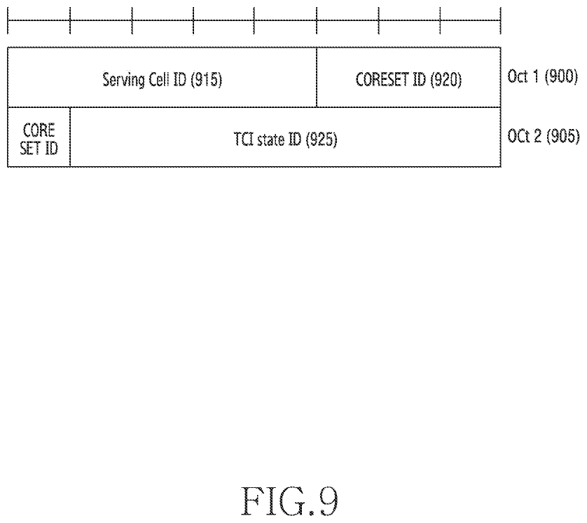

FIG. 9 illustrates a TCI indication MAC CE signaling structure for a PDCCH DMRS in a wireless communication system according to an embodiment of the disclosure.

Referring to FIG. 9, the TCI indication MAC CE signaling for the PDCCH DMRS may be configured by 2 bytes (16 bits), and include a 5-bit serving cell ID 915, a 4-bit CORESET ID 920, and a 7-bit TCI state ID 925.

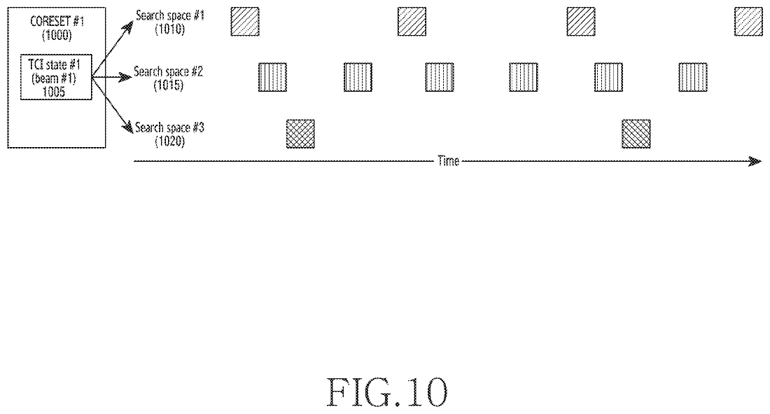

FIG. 10 illustrates an example of beam configuration with regard to a control resource set and a search space in a wireless communication system according to an embodiment of the disclosure.

Referring to FIG. 10, the base station may indicate one of TCI state lists included in CORESET 1000 configuration through MAC CE signaling (1005). Until a different TCI state is indicated for the corresponding CORESET through different MAC CE signaling, the UE may consider that identical QCL information (beam #1) 1005 is all applied to one or more search spaces 1010, 1015, and 1020 connected to the CORESET. The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide more flexible PDCCH beam configuration and operation methods. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set, and may activate one of the configured TCI states through a MAC CE activation command. For example, if {TCI state #0, TCI state #1, TCI state #2} are configured as TCI states for control resource set #1, the base station may transmit an activation command to the UE through a MAC CE such that TCI state #0 is assumed as the TCI state regarding control resource set #1. Based on the activation command regarding the TCI state received through the MAC CE, the UE may correctly receive the DMRS of the corresponding control resource set, based on QCL information in the activated TCI state.

With regard to a control resource set having a configured index of 0 (control resource set #0), if the UE has failed to receive a MAC CE activation command regarding the TCI state of control resource set #0, the UE may assume that the DMRS transmitted in CORESET #0 has been QCL-ed with a SS/PBCH block identified in the initial access process, or in a non-contention-based random access process not triggered by a PDCCH command.

With regard to a control resource set having a configured index value other than 0 (control resource set #X), if the UE has no TCI state configured regarding control resource set #X, or if the UE has one or more TCI states configured therefor but has failed to receive a MAC CE activation command for activating one thereof, the UE may assume that the DMRS transmitted in control resource set #X has been QCL-ed with a SS/PBCH block identified in the initial access process.

### [PDCCH: Regarding QCL Prioritization Rule]

Hereinafter, operations for determining QCL priority regarding a PDCCH will be described in detail.

The UE may operate according to carrier aggregation inside a single cell or band. If multiple control resource sets which operate according to carrier aggregation inside a single cell or band and which exist inside a single or multiple in-cell activated bandwidth parts overlap temporally while having identical or different QCL-TypeD characteristics in a specific PDCCH monitoring occasion, the UE may select a specific control resource set according to a QCL priority determining operation and may monitor control resource sets having the same QCL-TypeD characteristics as the corresponding control resource set. That is, if multiple control resource sets overlap temporally, only one QCL-TypeD characteristic can be received. The QCL priority may be determined by the following criteria.
Criterion 1. A control resource set connected to a common search space having the lowest index inside a cell corresponding to the lowest index among cells including a common search space
Criterion 2. A control resource set connected to a UE-specific search space having the lowest index inside a cell corresponding to the lowest index among cells including a UE-specific search space

As described above, if one criterion among the criteria is not satisfied, the next criterion may be applied. For example, if control resource sets overlap temporally in a specific PDCCH monitoring occasion, and if all control resource sets are not connected to a common search space but connected to a UE-specific search space (for example, if criterion 1 is not satisfied), the UE may omit application of criterion 1 and apply criterion 2.

If selecting control resource set according to the above-mentioned criteria, the UE may additionally consider the two aspects with regard to QCL information configured for the control resource set. Firstly, if control resource set 1 has CSI-RS 1 as a reference signal having a relation of QCL-TypeD, if this CSI-RS 1 has a relation of QCL-TypeD with reference signal SSB 1, and if another control resource set 2 has a relation of QCL-TypeD with reference signal SSB 1, the UE may consider that the two control resource sets 1 and 2 have different QCL-TypeD characteristics. Secondly, if control resource set 1 has CSI-RS 1 configured for cell 1 as a reference signal having a relation of QCL-TypeD, if this CSI-RS 1 has a relation of QCL-TypeD with reference signal SSB 1, if control resource set 2 has a relation of QCL-TypeD with reference signal CSI-RS 2 configured for cell 2, and if this CSI-RS 2 has a relation of QCL-TypeD with the same reference signal SSB 1, the UE may consider that the two control resource sets have the same QCL-TypeD characteristics.

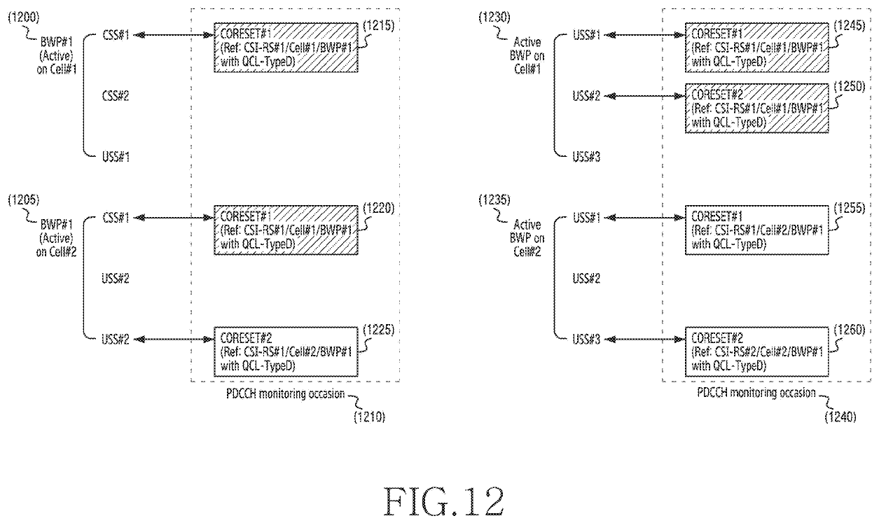

For reference, FIG. 12 illustrates a method in which, upon receiving a downlink control channel, a UE selects a receivable control resource set in consideration of priority in a wireless communication system according to an embodiment of the disclosure.

### [Regarding Rate Matching/Puncturing]

Hereinafter, a rate matching operation and a puncturing operation will be described in detail.

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

### Rate Matching Operation

The base station may transmit channel A after mapping the same only to remaining resource domains other than resource C (area overlapping resource B) among the entire resource A which is to be used to transmit symbol sequence A to the UE. For example, if symbol sequence A is configured as {symbol #1, symbol #2, symbol #3, symbol #4), if resource A is {resource #1, resource #2, resource #3, resource #4}, and if resource B is {resource #3, resource #5}, the UE may receive symbol sequence A based on an assumption that the same has been successively mapped to remaining resources{resource #1, resource #2, resource #4} other than {resource #3} (corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped and transmitted in the remaining area other than resource C among the entire resource A. For example, if symbol sequence A is configured as {symbol #1, symbol #2, symbol #3, symbol #4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, if symbol sequence A is configured as {symbol #1, symbol #2, symbol #3, symbol #4}, if resource A is {resource #1, resource #2, resource #3, resource #4}, and if resource B is {resource #3, resource #5}, the UE may assume that symbol sequence A {symbol #1, symbol #2, symbol #3, symbol #4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the base station may transmit symbol sequence {symbol #1, symbol #2, symbol #4} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped to the entire resource A but transmitted only in the remaining area other than resource C among the resource A. For example, if symbol sequence A is configured as {symbol #1, symbol #2, symbol #3, symbol #4}, if resource A is {resource #1, resource #2, resource #3, resource #4}, and if resource B is {resource #3, resource #5}, the UE may assume that symbol sequence A {symbol #1, symbol #2, symbol #3, symbol #4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Hereinafter, a method for configuring a rate matching resource for the purpose of rate matching in a 5G communication system will be described. Rate matching refers to adjusting the size of a signal in consideration of the amount of resources that can be used to transmit the signal. For example, data channel rate matching may mean that a data channel is not mapped and transmitted with regard to specific time and frequency resource domains, and the size of data is adjusted accordingly.

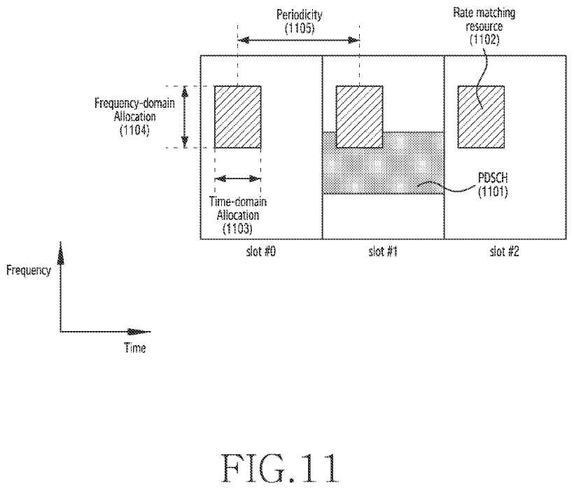

FIG. 11 illustrates an example of a method in which a base station and a UE transmit/receive data in consideration of a downlink data channel and a rate matching resource in a wireless communication system according to an embodiment of the disclosure.

FIG. 11 illustrates a downlink data channel (PDSCH) 1101 and a rate matching resource 1102. The base station may configure one or multiple rate matching resources 1102 for the UE through upper layer signaling (for example, RRC signaling). Rate matching resource 1102 configuration information may include time-domain resource allocation information 1103, frequency-domain resource allocation information 1104, and periodicity information 1105. A bitmap corresponding to the frequency-domain resource allocation information 1104 will hereinafter be referred to as “first bitmap”, a bitmap corresponding to the time-domain resource allocation information 1103 will be referred to as “second bitmap”, and a bitmap corresponding to the periodicity information 1105 will be referred to as “third bitmap”. If all or some of time and frequency resources of the scheduled PDSCH 1101 overlap a configured rate matching resource 1102, the base station may ratematch and transmit the data channel 1102 in a rate matching resource 1101 part, and the UE may perform reception and decoding after assuming that the data channel 1102 has been rate-matched in a rate matching resource 1101 part.

The base station may dynamically notify the UE, through DCI, of whether the PDSCH will be rate-matched in the configured rate matching resource part through an additional configuration (for example, corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described rate matching resources for a UE. More specifically, the following configuration method may be followed.

### RB Symbol Level

The UE may have a maximum of four RateMatchPatterns configured per each bandwidth part through upper layer signaling, and one RateMatchPattern may include the following contents.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. A time domain pattern (periodicityAndPattern) may be additionally configured wherein time and frequency domains including respective RB-level and symbol-level bitmap pairs are repeated.
may include a resource area corresponding to a time domain pattern configured by time and frequency domain resource areas configured by a CORESET inside a bandwidth part and a search space configuration in which corresponding resource areas are repeated.

### RE Level

The UE may have the following contents configured through upper layer signaling.
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

### [Regarding LTE CRS Rate Match]

Next, a rate matching process regarding the above-mentioned LTE CRS will be described in detail. In NR, for coexistence between long term evolution (LTE) and new RAT (NR) (LTE-NR coexistence), the pattern of cell-specific reference signal (CRS) of LTE may be configured for an NR UE. More specifically, the CRS pattern may be provided by RRC signaling including at least one parameter inside ServingCellConfig IE (information element) or ServingCellConfigCommonIE. Examples of the parameter may include lte-CRS-ToMatchAround, lite-CRS-PatternList1-r16, lte-CRS-PatternList2-r16, crs-RateMatch-PerCORESETPoolIndex-r16, and the like.

Rel-15 NR provides a function by which one CRS pattern can be configured per serving cell through parameter lte-CRS-ToMatchAround. In Rel-16 NR, the above function has been expanded such that multiple CRS patterns can be configured per serving cell. More specifically, a UE having a single-TRP (transmission and reception point) configuration may now have one CRS pattern configured per one LTE carrier, and a UE having a multi-TRP configuration may now have two CRS patterns configured per one LTE carrier. For example, the UE having a single-TRP configuration may have a maximum of three CRS patterns configured per serving cell through parameter lte-CRS-PatternList1-r16. As another example, the UE having a multi-TRP configuration may have a CRS configured for each TRP. That is, the CRS pattern regarding TRP1 may be configured through parameter lte-CRS-PatternList1-r16, and the CRS pattern regarding TRP2 may be configured through parameter lte-CRS-PatternList2-r16. If two TRPs are configured as above, whether the CRS patterns of TRP1 and TRP2 are both to be applied to a specific physical downlink shared channel (PDSCH) or only the CRS pattern regarding one TRP is to be applied is determined through parameter crs-RateMatch-PerCORESETPoolIndex-r16, wherein if parameter crs-RateMatch-PerCORESETPoolIndex-r16 is configured “enabled”, only the CRS pattern of one TRP is applied, and both CRS patterns of the two TRPs are applied in other cases.

Table 22 shows a ServingCellConfig IE including the CRS patterns, and Table 23 shows a RateMatchPatternLTE-CRS IE including at least one parameter regarding CRS patterns.

TABLE 22
ServingCellConfig ::= SEQUENCE {

| | |
|---|---|
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF |
| BWP-Id | OPTIONAL, -- Need N |
| downlinkBWP-ToAddModList | SEQUENCE (SIZE (1..maxNrofBWPs)) OF |
| BWP-Downlink | OPTIONAL, -- Need N |
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, |

ms5, ms6, ms8, ms10, ms20, ms30,
ms40,ms50, ms60, ms80,ms100, ms200,ms300, ms500,
ms750, ms1280, ms1920, ms2560, spare10, spare9, spare8,
spare7, spare6, spare5, spare4, spare3, spare2, spare1 } OPTIONAL, --Need R

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH- |
| ServingCellConfig } | OPTIONAL, -- Need. M |
| pdsch-ServingCellConfig | SetupRelease { PDSCH- |
| ServingCellConfig } | OPTIONAL, -- Need M |
| csi-MeasConfig | SetupRelease { CSI- |
| MeasConfig } | OPTIONAL, -- Need M |
| sCellDeactivationTimer | ENUMERATED {ms20, ms40, ms80, |

ms160, ms200, ms240,
ms320, ms400, ms480, ms520, ms640, ms720,

| | |
|---|---|
| ms840, ms1280, spare2,spare1} | OPTIONAL, -- Cond |

ServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |
| dummy | ENUMERATED |
| {enabled} | OPTIONAL, -- |

Need R

| | |
|---|---|
| pathlossReferenceLinking | ENUMERATED {spCell, sCell} |

OPTIONAL, -- Cond SCellOnly

| | |
|---|---|
| servingCellMO | MeasObjectId |

```
OPTIONAL, -- Cond MeasObject
    ...,
    [[
```

| | |
|---|---|
| lte-CRS-ToMatchAround | SetupRelease { RateMatchPatternLTE-CRS } |

OPTIONAL, -- Need M

| | |
|---|---|
| rateMatchPatternToAddModList | SEQUENCE (SIZE |

(1..maxNrofRateMatchPatterns)) OF RateMatchPattern OPTIONAL, -- Need N

| | |
|---|---|
| rateMatchPatternToReleaseList | SEQUENCE (SIZE |

(1..maxNrofRateMatchPatterns)) OF RateMatchPatternId OPTIONAL, -- Need N

| | |
|---|---|
| downlinkChannelBW-PerSCS-List | SEQUENCE (SIZE (1..maxSCSs)) OF |
| SCS-SpecificCarrier | OPTIONAL -- Need S |

```
  ]],
  [[
```

| | |
|---|---|
| supplementaryUplinkRelease | ENUMERATED {true} |

OPTIONAL, -- Need N
tdd-UL-DL-ConfigurationDedicated-IAB-MT-r16 TDD-UL-DL-ConfigDedicated-IAB-
MT-r16 OPTIONAL, -- Cond TDD_IAB

| | |
|---|---|
| dormantBWP-Config-r16 | SetupRelease { DormantBWP- |
| Config-r16 } | OPTIONAL, -- Need M |
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

}
OPTIONAL, -- Cond AsyncCA

| | |
|---|---|
| channelAccessConfig-r16 | SetupRelease { |
| ChannelAccessConfig-r16 } | OPTIONAL, -- Need M |
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWith-DCI-r16 | ENUMERATED {enabled} |

OPTIONAL, -- Need R

| | |
|---|---|
| lte-CRS-PatternList1-r16 | SetupRelease { LTE-CRS- |
| PatternList-r16 } | OPTIONAL, -- Need M |
| lte-CRS-PatternList2-r16 | SetupRelease { LTE-CRS- |
| PatternList-r16 } | OPTIONAL, -- Need M |

crs-RateMatch-PerCORESETPoolIndex-r16 ENUMERATED {enabled}
OPTIONAL, -- Need R

| | |
|---|---|
| enableTwoDefaultTCI-States-r16 | ENUMERATED {enabled} |

OPTIONAL, -- Need R
enableDefaultTCI-StatePerCoresetPoolIndex-r16 ENUMERATED {enabled}
OPTIONAL, -- Need R

| | |
|---|---|
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

TABLE 23
-- RateMatchPatternLTE-CRS
The IE RateMatchPatternLTE-CRS is used to configure a pattern to rate match around LTE CRS.
See TS 38.214 [19], clause 5.1.4.2.

RateMatchPatternLTE-CRS information element

-- ASN1START
-- TAG-RATEMATCHPATTERNLTE-CRS-START

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, |

n75, n100, spare2, spare1},

| | |
|---|---|
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, |

n2, n3, n4, n5}
}

| | |
|---|---|
| LTE-CRS-PatternList-r16 ::= | SEQUENCE (SIZE (1..maxLTE-CRS-Patterns- |

r16)) OF RateMatchPatternLTE-CRS
-- TAG-RATEMATCHPATTERNLTE-CRS-STOP
-- ASN1STOP

RateMatchPatternLTE-CRS field descriptions

carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause 5.1.4.2).
v-Shift
Shifting value v-shift in LTE to rate match around LTE CRS (see TS 38.214 [19], clause 5.1.4.2).

### [PDSCH: Processing Time]

Next, a PDSCH processing time (PDSCH processing procedure time) will be described. If the base station schedules the UE to transmit a PDSCH by using DCI format 1_0, 1_1 or 1_2, the UE may need a PDSCH processing time for receiving a PDSCH by applying a transmission method (modulation/demodulation and coding indication index (MCS), demodulation reference signal-related information, time and frequency resource allocation information, and the like) indicated through DCI. The PUSCH preparation procedure time is defined in NR in consideration thereof. The PUSCH processing time of the UE may follow the equation given below.

$${T}_{proc , 1} = ( {N}_{1} - {d}_{1 , 1} + {d}_{2} ) ( 2048 + 144 ) {κ2}^{- μ} {T}_{c} + {T}_{ext} \qquad [ Equation 2 ]$$

Each parameter in T_{proc,1} described above in Equation 2 may have the following meaning.
N₁: the number of symbols determined according to UE processing capability 1 or 2 based on the UE's capability and numerology μ. N₁ may have a value in Table 24 if UE processing capability 1 is reported according to the UE's capability report, and may have a value in Table 25 if UE processing capability 2 is reported, and if availability of UE processing capability 2 is configured through upper layer signaling. The numerology μ may correspond to the minimum value among μ_{PDCCH}, μ_{PDSCH}, μ_{UL} so as to maximize T_{proc,1}, and μ_{PDCCH}, μ_{PDSCH}, μ_{UL} may refer to the numerology of a PDCCH that scheduled a PDSCH, the numerology of the scheduled PDSCH, and numerology of an uplink channel in which a HARQ-ACK is to be transmitted.

Table 24 below shows the PDSCH processing time in the case of PDSCH processing capability 1.

TABLE 24

| | PDSCH decoding time N₁ [symbols] | |
|---|---|---|
| | | If PDSCH mapping type A and B both do |
| | If PDSCH mapping type A and B | not correspond to dmrs- |
| | both correspond to dmrs- | AdditionalPosition = pos0 inside DMRS- |
| | AdditionalPosition = pos0 inside | DownlinkConfig which is upper layer |
| | DMRS-DownlinkConfig which | signaling, or if no upper layer parameter |
| μ | is upper layer signaling | is configured |
| 0 | 8 | N_{1, 0} |
| 1 | 10 | 13 |
| 2 | 17 | 20 |
| 3 | 20 | 24 |

Table 25 below shows the PDSCH processing time in the case of PDSCH processing capability 2.

TABLE 25

| | PDSCH decoding time |
|---|---|
| | N₁ [symbols] |
| | If PDSCH mapping type A and B |
| | both correspond to dmrs- |
| | AdditionalPosition = pos0 |
| | inside DMRS-DownlinkConfig which is upper |
| μ | layer signaling |
| 0 | 3 |
| 1 | 4.5 |
| 2 | 9 for frequency range 1 |

κ: 64
Tₑₓₜ: if the UE uses a shared spectrum channel access scheme, the UE may calculate Tₑₓₜ and apply the same to the PDSCH processing time. Otherwise, Tₑₓₜ is assumed to be 0.
If l₁ which represents the PDSCH DMRS location value is 12, N_{1,0} in [table 24] above has the value of 14, and otherwise has the value of 13.
With regard to PDSCH mapping type A, if the last symbol of the PDSCH is the i^{th} symbol in the slot in which the PDSCH is transmitted, and if i<7, d_{1,1} is then 7-i, and d_{1,1} is otherwise 0.
d₂: if a PUCCH having a high priority index temporally overlaps another PUCCH or a PUSCH having a low priority index, d₂ of the PUCCH having a high priority index may be configured as a value reported from the UE. Otherwise, d₂ is 0.
If PDSCH mapping type B is used with regard to UE processing capability 1, the d_{1,1} value may be determined by the number (L) of symbols of a scheduled PDSCH and the number of overlapping symbols between the PDCCH that schedules the PDSCH and the scheduled PDSCH, as follows.
If L≥7, then d_{1,1}=0.
If −L≥4 and L≤6, then d_{1,1}=7−L.
If L=3, then d_{1,1}=min (d, 1).
If L=2, then d_{1,1}=3+d.
If PDSCH mapping type B is used with regard to UE processing capability 2, the d_{1,1} value may be determined by the number (L) of symbols of a scheduled PDSCH and the number of overlapping symbols between the PDCCH that schedules the PDSCH and the scheduled PDSCH, as follows.
If L≥7, then d_{1,1}=0.
If −L≥4 and L≤6, then d_{1,1}=7−L.
If L=2,
If the scheduling PDCCH exists inside a CORESET including three symbols, and if the CORESET and the scheduled PDSCH have the same start symbol, then d_{1,1}=3.
Otherwise, d_{1,1}=d.
In the case of a UE supporting capability 2 inside a given serving cell, the PDSCH processing time based on UE processing capability 2 may be applied by the UE if processingType2Enabled (upper layer signaling) is configured as “enable” with regard to the corresponding cell.

If the location of the first uplink transmission symbol of a PUCCH including HARQ-ACK information (in connection with the corresponding location. K1 defined as the HARQ-ACK transmission time point, a PUCCH resource used to transmit the HARQ-ACK, and the timing advance effect may be considered) does not start earlier than the first uplink transmission symbol that comes after the last symbol of the PDSCH over a time of Tproc,1, the UE needs to transmit a valid HARQ-ACK message. That is, the UE needs to transmit a PUCCH including a HARQ-ACK only if the PDSCH processing time is sufficient. The UE cannot otherwise provide the base station with valid HARQ-ACK information corresponding to the scheduled PDSCH. The T_{proc,1} may be used in the case of both a normal and an extended CP. In the case of a PDSCH having two PDSCH transmission locations configured inside one slot, d1,1 is calculated with reference to the first PDSCH transmission location inside the corresponding slot.

### [PDSCH: Reception Preparation Time During Cross-Carrier Scheduling]

Next, in the case of cross-carrier scheduling in which the numerology (μ_{PDCCH}) by which a scheduling PDCCH is transmitted and the numerology (μ_{PDSCH}) by which a PDSCH scheduled by the corresponding PDCCH is transmitted are different from each other, the PDSCH reception reparation time (N_{pdsch}) of the UE defined with regard to the time interval between the PDCCH and PDSCH will be described.

If μ_{PDCCH}<μ_{PDSCH}, the scheduled PDSCH cannot be transmitted before the first symbol of the slot coming after N_{pdsch} symbols from the last symbol of the PDCCH that scheduled the corresponding PDSCH. The transmission symbol of the corresponding PDSCH may include a DMRS.

If μ_{PDCCH}>μ_{PDSCH}, the scheduled PDSCH may be transmitted after N_{pdsch} symbols from the last symbol of the PDCCH that scheduled the corresponding PDSCH. The transmission symbol of the corresponding PDSCH may include a DMRS.

Table 26 shows N_{pdsch} according to the scheduled PDCCH subcarrier spacing

TABLE 26

| μ_{PDCCH} | N_{pdsch} [symbols] |
|---|---|
| 0 | 4 |
| 1 | 5 |
| 2 | 10 |
| 3 | 14 |

[Regarding SRS] Next, an uplink channel estimation method using sounding reference signal (SRS) transmission of a UE will be described. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange upper signaling information as follows, in order to transfer information regarding the SRS resource set.
srs-ResourceSetId: an SRS resource set index
srs-ResourceIdList: a set of SRS resource indices referred to by SRS resource sets
resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. In addition, the individual configuration information regarding SRS resources may include time domain transmission configuration of SRS resources, and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicityAndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource follows resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in consideration of the place of use of the SRS resource set including the transmitted SRS resource, the minimum time interval may be determined as N2 symbols, and if the place of use of the SRS resource set is configured as “nonCodebook” or “beamManagement”, the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

Table 27 below shows configuration information spatialRelationInfo.

TABLE 27

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

quenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| | |
|---|---|
| sequenceId | INTEGER (0..1023), |
| spatialRelationInfo | SRS-SpatialRelationInfo |

```
  OPTIONAL, -- Need R
    ...
}
```

Configuration information spatialRelationInfo in Table 27 above may be applied, with reference to one reference signal, to a beam used for SRS transmission corresponding to beam information of the corresponding reference signal. For example, configuration of spatialRelationInfo may include information as in Table 28 below.

TABLE 28

| | |
|---|---|
| SRS-SpatialRelationInfo ::= | SEQUENCE { |
| servingCellId | ServCellIndex OPTIONAL, -- |

Need S

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
      }
    }
  }
```

Referring to the spatialRelationInfo configuration, an SS/PBCH block index, CSI-RS index, or SRS index may be configured as the index of a reference signal to be referred to in order to use beam information of a specific reference signal. Upper signaling referenceSignal corresponds to configuration information indicating which reference signal's beam information is to be referred to for corresponding SRS transmission, ssb-Index may refer to the index of an SS/PBCH block, csi-RS-Index may refer to the index of a CSI-RS, and srs may refer to the index of an SRS. If upper signaling referenceSignal has a configured value of “ssb-Index”, the UE may apply the reception beam which was used to receive the SS/PBCH block corresponding to ssb-Index as the transmission beam for the corresponding SRS transmission. If upper signaling referenceSignal has a configured value of “‘csi-RS-Index”, the UE may apply the reception beam which was used to receive the CSI-RS corresponding to csi-RS-Index as the transmission beam for the corresponding SRS transmission. If upper signaling referenceSignal has a configured value of “‘srs”, the UE may apply the reception beam which was used to transmit the SRS corresponding to srs as the transmission beam for the corresponding SRS transmission.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 15 through higher signaling, without receiving a UL grant inside DCI. Configured grant Type 2PUSCH transmission may be scheduled semi-persistently by a UL grant inside DCIafter receiving configuredGrantConfig not including rrc-ConfiguredUplinkGrant in Table 25 through upper signaling. If PUSCH transmission is operated by a configured grant, parameters applied to the PUSCH transmission are applied through configuredGrantConfig (upper signaling) in Table 29 except for dataScramblingIdentityPUSCH, txConfig, codebookSubset, maxRank, and scaling of UCI-OnPUSCH, which are provided by pusch-Config (upper signaling) in Table 30. If provided with transformPrecoder inside configuredGrantConfig (upper signaling) in Table 29, the UE applies tp-pi2BPSK inside pusch-Config in Table 30 to PUSCH transmission operated by a configured grant.

TABLE 29

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTINAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, |

sym4x14, sym5x14, sym8x14, sym10x14, sym16x14, sym20x14,

sym32x14, sym40x14, sym64x14,

sym80x14, sym128x14, sym160x14, sym256x14, sym320x14, sym512x14,

sym640x14, sym 1024x14, sym1280x14,

sym2560x14, sym5120x14,

sym6, sym1x12, sym2x12, sym4x12,

sym5x12, sym8x12, sym10x12, sym16x12, sym20x12, sym32x12,

sym40x12, sym64x12, sym80x12,

sym128x12, sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0.31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

```
PathlossReferenceRSs-1),
    ...
  }
OPTIONAL, -- Need R
  ...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 30, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource corresponding to the minimum ID inside an activated uplink BWP inside a serving cell, and the PUSCH transmission may be based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 30, the UE does not expect scheduling through DCI format 0_1.

TABLE 30

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | OPTIONAL, -- Need M |
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF |

INTEGER (1..maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, |
| qam64LowSE} | OPTIONAL, -- Need S |
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) OPTIONAL, -- |

Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Hereinafter, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers). The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “nonCoherent”, based on UE capability reported by the UE to the base station. If the UE reported “partialAndNonCoherent’” as UE capability, the UE does not expect that the value of codebookSubset (upper signaling) will be configured as “fully AndPartialAndNonCoherent”. In addition, if the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is located in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### [PUSCH: Preparation Procedure Time]

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow the equation given below.

$${T}_{proc , 2} = max ( ( {N}_{2} + {d}_{2 , 1} + {d}_{2} ) ( 2048 + 144 ) {κ2}^{- μ} {T}_{c} + {T}_{ext} + {T}_{s w i t c h} , {d}_{2 , 2} ) \qquad [ Equation 3 ]$$

Each parameter in T_{proc,2} described above in Equation 3 may have the following meaning.
N₂: the number of symbols determined according to UE processing capability 1 or 2, based on the UE's capability, and numerology μ. N₂ may have a value in Table 31 if UE processing capability 1 is reported according to the UE's capability report, and may have a value in Table 32 if UE processing capability 2 is reported, and if availability of UE processing capability 2 is configured through upper layer signaling.

TABLE 31

| μ | PUSCH preparation time N₂ [symbols] |
|---|---|
| 0 | 10 |
| 1 | 12 |
| 2 | 23 |
| 3 | 36 |

TABLE 32

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.
T_{c}: has 1/(Δfₘₐₓ·N_{f}), Δfₘₐₓ=480·10³ Hz, N_{f}=4096.
d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, T_{switch} is assumed to be 0.

The base station and the UE may determine that the PUSCH preparation procedure time is insufficient if the first symbol of a PUSCH starts earlier than the first uplink symbol in which a CP starts after T_{proc,2} from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repetition Transmission]

Hereinafter, repetition transmission of an uplink data channel in a 5G system will be described in detail. A 5G system supports two types of uplink data channel repetition transmission methods, PUSCH repetition type A transmission and PUSCH repetition type B transmission. One of PUSCH repetition type A transmission and PUSCH repetition type B transmission may be configured for a UE through upper layer signaling.

### PUSCH Repetition Type A Transmission

As described above, the symbol length of an uplink data channel and the location of the start symbol may be determined by a time domain resource allocation method in one slot, and a base station may notify a UE of the number of repetition transmissions through upper layer signaling (for example, RRC signaling) or L1 signaling (for example, DCI).
Based on the number of repetition transmissions received from the base station, the UE may repetitively transmit an uplink data channel having the same length and start symbol as the configured uplink data channel, in consecutive slots. If the base station configured a slot as a downlink for the UE, or if at least one of symbols of the uplink data channel configured for the UE is configured as a downlink, the UE omits uplink data channel transmission, but counts the number of repetition transmissions of the uplink data channel.

### PUSCH Repetition Type B Transmission

As described above, the symbol length of an uplink data channel and the location of the start symbol may be determined by a time domain resource allocation method in one slot, and a base station may notify a UE of the number of repetition transmissions (numberofrepetitions) through upper layer signaling (for example, RRC signaling) or L1 signaling (for example, DCI).
The nominal repetition of the uplink data channel is determined as follows, based on the previously configured start symbol and length of the uplink data channel. The slot in which the n^{th} nominal repetition starts is given by

$${K}_{S} + ⌊ \frac{S + n \cdot L}{{N}_{symb}^{slot}} ⌋ ,$$

and the symbol starting in that slot is given by

$$mod ( S + n \cdot L , {N}_{symb}^{slot} ) .$$

The slot in which the n^{th} nominal repetition ends is given by

$${K}_{S} + ⌊ \frac{S + ( n + 1 ) \cdot L - 1}{{N}_{symb}^{slot}} ⌋ ,$$

and the symbol ending in that slot is given by

$$mod [ S + ( n + 1 ) \cdot L - 1 , {N}_{symb}^{slot} ) .$$

In this regard, n=0, . . . ,
numberofrepetitions−1, S refers to the start symbol of the configured uplink data channel, and L refers to the symbol length of the configured uplink data channel. Kₛ refers to the slot in which PUSCH transmission starts, and

$${N}_{symb}^{slot}$$

refers to the number of symbols per slot.

The UE determines an invalid symbol for PUSCH repetition type B transmission. A symbol configured as a downlink by tdd-UL-DL-ConfigurationCommon or tdd-UL-DL-ConfigurationDedicated is determined as the invalid symbol for PUSCH repetition type B transmission. Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 represents the invalid symbol. Additionally, the periodicity and pattern of the bitmap may be configured through the upper layer parameter (for example. InvalidSymbolPattern). If an upper layer parameter (for example. InvalidSymbolPattern) is configured, and if parameter InvalidSvmbolPatternindicator-ForDCIFormat0_1 or InvalidSymbolPatternIndicator-ForDCIFormat0_2 indicates 1, the UE applies an invalid symbol pattern, and if the above parameter indicates 0, the UE does not apply the invalid symbol pattern. If an upper layer parameter (for example, InvalidSymbolPattern) is configured, and if parameter InvalidSvmbolPatternindicator-ForDCIFormat0_1 or InvalidSymbolPatternIndicator-ForDCIFormat0_2 is not configured, the UE applies the invalid symbol pattern.

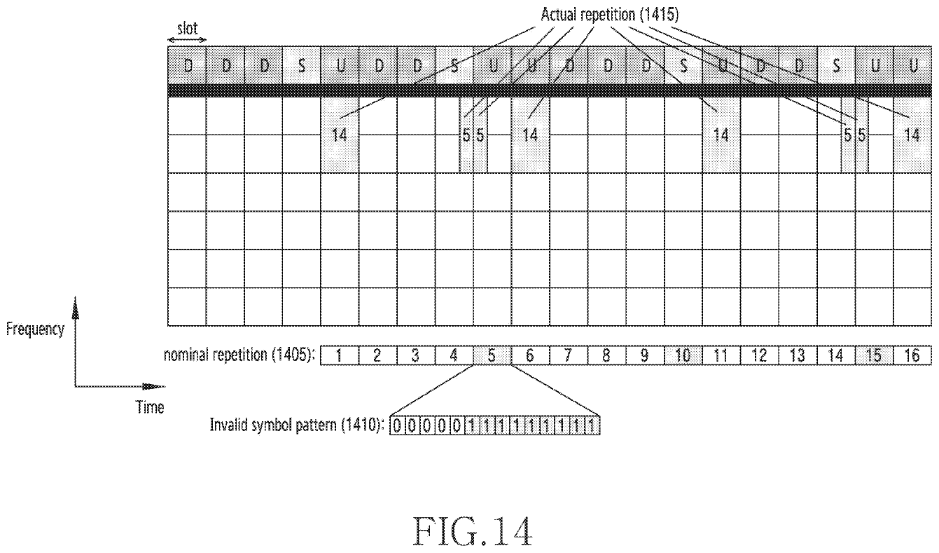

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot. For reference, FIG. 14 illustrates an example of PUSCH repetition type B transmission in a wireless communication system according to an embodiment of the disclosure.

### [PUSCH: Frequency Hopping Process]

Hereinafter, frequency hopping of a physical uplink shared channel (PUSCH) in a 5G system will be described in detail.

5G may support two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported.

The intra-slot frequency hopping method supported in PUSCH repetition type A transmission may include a method in which a UE transmits allocated resources in the frequency domain, after changing the same by a configured frequency offset, by two hops in one slot. The start RB of each hop in connection with intra-slot frequency hopping may be expressed by Equation 4 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad [ Equation 4 ]$$

In Equation 4, i=0 and i=1 may denote the first and second hops, respectively, and Run may denote the start RB in a UL BWP and may be calculated from a frequency resource allocation method. RB_{offset} denotes a frequency offset between two hops through an upper layer parameter. The number of symbols of the first hop may be represented by

$$⌊ {N}_{symb}^{PUSCH , s} / 2 ⌋ ,$$

and number of symbols of the second hop may be represented by

$${N}_{symb}^{PUSCH , s} - ⌊ {N}_{symb}^{PUSCH , s} / 2 ⌋ . {N}_{symb}^{PUSCH , s}$$

is the length of PUSCH transmission in one slot and is expressed by the number of OFDM symbols.

Next, the inter-slot frequency hopping method supported in PUSCH repetition type A and type B transmissions is a method in which the UE transmits allocated resources in the frequency domain, after changing the same by a configured frequency offset, in each slot. The start RB during a slot in connection with inter-slot frequency hopping may be expressed by Equation 5 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad [ Equation 5 ]$$

In Equation 5,

$${n}_{s}^{μ}$$

denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an upper layer parameter.

Next, the inter-repetition frequency hopping method supported in PUSCH repetition type B transmission is a method in which resources allocated in the frequency domain regarding one or multiple actual repetitions in each nominal repetition are moved by a configured frequency offset and then transmitted. The index RBₛₜₐᵣₜ₍ₙ₎ of the start RB in the frequency domain regarding one or multiple actual repetitions in the nth nominal repetition may follow Equation 6 given below.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad [ Equation 6 ]$$

In Equation 6, n denotes the index of nominal repetition, and RB_{offset} denotes an RB offset between two hops through an upper layer parameter.

### [PUSCH: Multiplexing Rules During AP/SP CSI Reporting]

Hereinafter, a method of measuring and reporting a channel state in the 5G communication system will be described in detail. Channel state information (CSI) may include a channel quality indicator (channel quality information (CQI)), a precoding matrix index (precoding matrix indicator (PMI)), a CSI-RS resource indicator (CRI), an SS/PBCH block resource indicator (SSBRI), a layer indicator (LI), a rank indicator (RI), a reference signal received power (L1-RSRP), and/or the like. A base station may control time and frequency resources for the aforementioned CSI measurement and report of a UE.

For the aforementioned CSI measurement and report, the UE may be configured, via higher-layer signaling, with setting information for N (N≥1) CSI reports (CSI-ReportConfig), setting information for M (M≥1) RS transmission resources (CSI-ResourceConfig), and list information of one or two trigger states (CSI-AperiodicTriggerStateList, CSI-SemiPersistentOnPUSCH-TriggerStateList). The configuration information for CSI measurement and reporting described above may be, more specifically, as described in Table 33 to Table 39 below.

TABLE 33
The IE CSI-ReportConfig is used to configure a periodic or semi-persistent report sent
on PUCCH on the cell in which the CSI-ReportConfig is included, or to configure a semi-
persistent or aperiodic report sent on PUSCH triggered by DCI received on the cell in
which the CSI-ReportConfig is included (in this case, the cell on which the report
is sent is determined by the received DCI). See TS 38.214 [19], clause 5.2.1.

CSI-ReportConfig information element

```
  -- ASN1START
  -- TAG-CSI-REPORTCONFIG-START
```

| | |
|---|---|
| CSI-ReportConfig ::= | SEQUENCE { |
| reportConfigId | CSI-ReportConfigId, |
| carrier | ServCellIndex |

```
OPTIONAL, -- Need S
    resourcesForChannelMeasurement CSI-ResourceConfigId,
    csi-IM-ResourcesForInterference CSI-ResourceConfigid
OPTIONAL, -- Need R
    nzp-CSI-RS-ResourcesForInterference CSI-ResourceConfigId
OPTIONAL, -- Need R
```

| | |
|---|---|
| reportConfigType | CHOICE { |
| periodic | SEQUENCE { |
| reportSlotConfig | CSI-ReportPeriodicityAndOffset, |

```
        pucch-CSI-ResourceList SEQUENCE (SIZE
(1..maxNrofBWPs)) OF PUCCH-CSI-Resource
      },
```

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE |

(1..maxNrofBWPs)) OF PUCCH-CSI-Resource

| | |
|---|---|
| }, | |
| semiPersistentOnPUSCH | SEQUENCE { |
| reportSlotConfig | ENUMERATED {sl5, sl10, sl20, |

sl40, sl80, sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

```
Allocations)) OF INTEGER(0..32)
      }
    },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, |

subbandCQI } OPTIONAL, -- Need R

| | |
|---|---|
| pmi-FormatIndicator | ENUMERATED { widebandPMI, |

subbandPMI } OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

```
      } OPTIONAL -- Need S
    }
OPTIONAL, -- Need R
    timeRestrictionForChannelMeasurements ENUMERATED {configured,
notConfigured},
    timeRestrictionForInterferenceMeasurements ENUMERATED {configured,
notConfigured},
```

| | |
|---|---|
| codebookConfig | CodebookConfig |

OPTIONAL, -- Need R

| | |
|---|---|
| dummy | ENUMERATED {n1, n2} |

OPTIONAL, -- Need R

| | |
|---|---|
| groupBasedBeamReporting | CHOICE { |
| enabled | NULL, |
| disabled | SEQUENCE { |
| nrofReportedRS | ENUMERATED {n1, n2, n3, n4} |

```
OPTIONAL -- Need S
      }
    },
    cqi-Table ENUMERATED {table1, table2, table3, spare1}
OPTIONAL, -- Need R
```

| | |
|---|---|
| subbandSize | ENUMERATED {value1, value2}, |
| non-PMI-PortIndication | SEQUENCE (SIZE (1..maxNrofNZP-CSI-RS- |

```
ResourcesPerConfig) OF PortIndexFor8Ranks OPTIONAL, -- Need R
    ...,
    [[
    semiPersistentOnPUSCH-v1530 SEQUENCE {
      reportSlotConfig-v1530 ENUMERATED {sl4, sl8, sl16}
    }
OPTIONAL -- Need R
    ]],
    [[
    semiPersistentOnPUSCH-v1610 SEQUENCE {
      reportSlotOffsetListDCI-0-2-r16 SEQUENCE (SIZE (1..maxNrofUL-
Allocations-r16)) OF INTEGER(0..32) OPTIONAL, -- Need R
      reportSlotOffsetListDCI-0-1-r16 SEQUENCE (SIZE (1..maxNrofUL-
Allocations-r16)) OF INTEGER(0..32) OPTIONAL -- Need R
    }
OPTIONAL, -- Need R
```

| | |
|---|---|
| aperiodic-v1610 | SEQUENCE { |

```
      reportSlotOffsetListDCI-0-2-r16 SEQUENCE (SIZE (1..maxNrofUL-
Allocations-r16)) OF INTEGER(0..32) OPTIONAL, -- Need R
      reportSlotOffsetListDCI-0-1-r16 SEQUENCE (SIZE (1..maxNrofUL-
Allocations-r16)) OF INTEGER(0..32) OPTIONAL -- Need R
    }
OPTIONAL, -- Need R
```

| | |
|---|---|
| reportQuantity-r16 | CHOICE { |
| cri-SINR-r16 | NULL, |
| ssb-Index-SINR-r16 | NULL |

}
OPTIONAL, -- Need R

| | |
|---|---|
| codebookConfig-r16 | CodebookConfig-r16 |

```
OPTIONAL -- Need R
    ]]
  }
  CSI-ReportPeriodicityAndOffset ::= CHOICE {
```

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| | |
|---|---|
| PortIndexFor8Ranks ::= | CHOICE { |
| portIndex8 | SEQUENCE{ |
| rank1-8 | PortIndex8 |

OPTIONAL, -- Need R

| | |
|---|---|
| rank2-8 | SEQUENCE(SIZE(2)) OF PortIndex8 |

OPTIONAL, -- Need R

| | |
|---|---|
| rank3-8 | SEQUENCE(SIZE(3)) OF PortIndex8 |

OPTIONAL, -- Need R

| | |
|---|---|
| rank4-8 | SEQUENCE(SIZE(4)) OF PortIndex8 |

OPTIONAL, -- Need R

| | |
|---|---|
| rank5-8 | SEQUENCE(SIZE(5)) OF PortIndex8 |

OPTIONAL, -- Need R

| | |
|---|---|
| rank6-8 | SEQUENCE(SIZE(6)) OF PortIndex8 |

OPTIONAL, -- Need R

| | |
|---|---|
| rank7-8 | SEQUENCE(SIZE(7)) OF PortIndex8 |

OPTIONAL, -- Need R

| | |
|---|---|
| rank8-8 | SEQUENCE(SIZE(8)) OF PortIndex8 |

OPTIONAL -- Need R
},

| | |
|---|---|
| portIndex4 | SEQUENCE{ |
| rank1-4 | PortIndex4 |

OPTIONAL, -- Need R

| | |
|---|---|
| rank2-4 | SEQUENCE(SIZE(2)) OF PortIndex4 |

OPTIONAL, -- Need R

| | |
|---|---|
| rank3-4 | SEQUENCE(SIZE(3)) OF PortIndex4 |

OPTIONAL, -- Need R

| | |
|---|---|
| rank4-4 | SEQUENCE(SIZE(4)) OF PortIndex4 |

OPTIONAL -- Need R
},

| | |
|---|---|
| portIndex2 | SEQUENCE{ |
| rank1-2 | PortIndex2 |

OPTIONAL, -- Need R

| | |
|---|---|
| rank2-2 | SEQUENCE(SIZE(2)) OF PortIndex2 |

OPTIONAL -- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

```
  -- TAG-CSI-REPORTCONFIG-STOP
  -- ASN1STOP
```

CSI-ReportConfig field descriptions

```
  carrier
  Indicates in which serving cell the CSI-ResourceConfig indicated below are to be found. If
the field is absent, the resources are on the same serving cell as this report configuration.
  codebookConfig
  Codebook configuration for Type-1 or Type-2 including codebook subset restriction.
Network does not configure codebookConfig and codebookConfig-r16 simultaneously to a UE
  cqi-FormatIndicator
  Indicates whether the UE shall report a single (wideband) or multiple (subband) CQI. (see
TS 38.214 [19], clause 5.2.1.4).
  cqi-Table
  Which CQI table to use for CQI calculation (see TS 38.214 [19], clause 5.2.2.1).
  csi-IM-ResourcesForInterference
  CSI IM resources for interference measurement. csi-ResourceConfigId of a CSI-
ResourceConfig included in the configuration of the serving cell indicated with the field “carrier”
above. The CSI-ResourceConfig indicated here contains only CSI-IM resources. The bwp-Id in that
CSI-ResourceConfig is the same value as the bwp-Id in the CSI-ResourceConfig indicated by
resourcesForChannelMeasurement.
  csi-ReportingBand
  Indicates a contiguous or non-contiguous subset of subbands in the bandwidth part which
CSI shall be reported for. Each bit in the bit-string represents one subband. The right-most bit in the
bit string represents the lowest subband in the BWP. The choice determines the number of subbands
(subbands3 for 3 subbands, subbands4 for 4 subbands, and so on) (see TS 38.214 [19], clause
5.2.1.4). This field is absent if there are less than 24 PRBs (no sub band) and present otherwise, the
number of sub bands can be from 3 (24 PRBs, sub band size 8) to 18 (72 PRBs, sub band size 4).
  dummy
  This field is not used in the specification. If received it shall be ignored by the UE.
  groupBasedBeamReporting
  Turning on/off group beam based reporting (see TS 38.214 [19], clause 5.2.1.4).
  non-PMI-PortIndication
  Port indication for RI/CQI calculation. For each CSI-RS resource in the linked
ResourceConfig for channel measurement, a port indication for each rank R, indicating which R
ports to use. Applicable only for non-PMI feedback (see TS 38.214 [19], clause 5.2.1.4.2).
  The first entry in non-PMI-Portindication corresponds to the NZP-CSI-RS-Resource
indicated by the first entry in nzp-CSI-RS-Resources in the NZP-CSI-RS-ResourceSet indicated in
the first entry of nzp-CSI-RS-ResourceSetList of the CSI-ResourceConfig whose CSI-
ResourceConfigId is indicated in a CSI-MeasId together with the above CSI-ReportConfigId; the
second entry in non-PMI-PortIndication corresponds to the NZP-CSI-RS-Resource indicated by the
second entry in nzp-CSI-RS-Resources in the NZP-CSI-RS-ResourceSet indicated in the first entry
of nzp-CSI-RS-ResourceSetList of the same CSI-ResourceConfig, and so on until the NZP-CSI-RS-
Resource indicated by the last entry in nzp-CSI-RS-Resources in the in the NZP-CSI-RS-ResourceSet
indicated in the first entry of nzp-CSI-RS-ResourceSetList of the same CSI-ResourceConfig. Then
the next entry corresponds to the NZP-CSI-RS-Resource indicated by the first entry in nzp-CSI-RS-
Resources in the NZP-CSI-RS-ResourceSet indicated in the second entry of nzp-CSI-RS-
ResourceSetList of the same CSI-ResourceConfig and so on.
  nrofReportedRS
  The number (N) of measured RS resources to be reported per report setting in a non-group-
based report. N <= N_max, where N_max is either 2 or 4 depending on UE capability.
  (see TS 38.214 [19], clause 5.2.1.4) When the field is absent the UE applies the value 1.
  nzp-CSI-RS-ResourcesForInterference
  NZP CSI RS resources for interference measurement. csi-ResourceConfigId of a CSI-
ResourceConfig included in the configuration of the serving cell indicated with the field “carrier”
above. The CSI-ResourceConfig indicated here contains only NZP-CSI-RS resources. The bwp-Id
in that CSI-ResourceConfig is the same value as the bwp-Id in the CSI-ResourceConfig indicated by
resourcesForChannelMeasurement.
  p0alpha
  Index of the p0-alpha set determining the power control for this CSI report transmission
(see TS 38.214 [19], clause 6.2.1.2).
  pdsch-BundleSizeForCSI
  PRB bundling size to assume for CQI calculation when reportQuantity is CRI/RI/i1/CQI.
If the field is absent, the UE assumes that no PRB bundling is applied (see TS 38.214 [19], clause
5.2.1.4.2).
  pmi-FormatIndicator
  Indicates whether the UE shall report a single (wideband) or multiple (subband) PMI. (see
TS 38.214 [19], clause 5.2.1.4).
  pucch-CSI-ResourceList
  Indicates which PUCCH resource to use for reporting on PUCCH.
  reportConfigType
  Time domain behavior of reporting configuration.
  reportFreqConfiguration
  Reporting configuration in the frequency domain. (see TS 38.214 [19], clause 5.2.1.4).
  reportQuantity
  The CSI related quantities to report. see TS 38.214 [19], clause 5.2.1. If the field
reportQuantity-r16 is present, UE shall ignore reportQuantity (without suffix).
  reportSlotConfig
  Periodicity and slot offset (see TS 38.214 [19], clause 5.2.1.4). If the field reportSlotConfig-
v1530 is present, the UE shall ignore the value provided in reportSlotConfig (without suffix).
  reportSlotOffsetList, reportSlotOffsetListDCI-0-1, reportSlotOffsetListDCI-0-2
  Timing offset Y for semi persistent reporting using PUSCH. This field lists the allowed
offset values. This list must have the same number of entries as the pusch-
TimeDomainAllocationList in PUSCH-Config. A particular value is indicated in DCI. The network
indicates in the DCI field of the UL grant, which of the configured report slot offsets the UE shall
apply. The DCI value 0 corresponds to the first report slot offset in this list, the DCI value 1
corresponds to the second report slot offset in this list, and so on. The first report is transmitted in
slot n+Y, second report in n+Y+P, where P is the configured periodicity.
  Timing offset Y for aperiodic reporting using PUSCH. This field lists the allowed offset
values. This list must have the same number of entries as the pusch-TimeDomainAllocationList in
PUSCH-Config. A particular value is indicated in DCI. The network indicates in the DCI field of
the UL grant, which of the configured report slot offsets the UE shall apply. The DCI value 0
corresponds to the first report slot offset in this list, the DCI value 1 corresponds to the second report
slot offset in this list, and so on (see TS 38.214 [19], clause 6.1.2.1). The field reportSlotOffsetList
applies to DCI format 0_0, the field reportSlotOffsetListDCI-0-1 applies to DCI format 0_1 and the
field reportSlotOffsetListDCI-0-2 applies to DCI format 0_2 (see TS 38.214 [19], clause 6.1.2.1).
  resourcesForChannelMeasurement
  Resources for channel measurement. csi-ResourceConfigId of a CSI-ResourceConfig
included in the configuration of the serving cell indicated with the field “carrier” above. The CSI-
ResourceConfig indicated here contains only NZP-CSI-RS resources and/or SSB resources. This
CSI-ReportConfig is associated with the DL BWP indicated by bwp-Id in that CSI-ResourceConfig.
  subbandSize
  Indicates one out of two possible BWP-dependent values for the subband size as indicated
in TS 38.214 [19], table 5.2.1.4-2 . If csi-ReportingBand is absent, the UE shall ignore this field.
  timeRestrictionForChannelMeasurements
  Time domain measurement restriction for the channel (signal) measurements (see TS
38.214 [19], clause 5.2.1.1).
  timeRestrictionForInterferenceMeasurements
  Time domain measurement restriction for interference measurements (see TS 38.214 [19],
clause 5.2.1.1).
```

TABLE 34
The IE CSI-ResourceConfig defines a group of one or more NZP-CSI-
RS-ResourceSet, CSI-IM-ResourceSet and/or CSI-SSB-ResourceSet.
CSI-ResourceConfig information element

```
  -- ASN1START
  -- TAG-CSI-RESOURCECONFIG-START
```

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

```
        nzp-CSI-RS-ResourceSetList SEQUENCE (SIZE (1..maxNrofNZP-CSI-RS-
ResourceSetsPerConfig)) OF NZP-CSI-RS-ResourceSetId
OPTIONAL, -- Need R
        csi-SSB-ResourceSetList SEQUENCE (SIZE (1..maxNrofCSI-SSB-
ResourceSetsPerConfig)) OF CSI-SSB-ResourceSetId OPTIONAL -- Need R
      },
      csi-IM-ResourceSetList SEQUENCE (SIZE (1..maxNrofCSI-IM-
ResourceSetsPerConfig)) OF CSI-IM-ResourceSetId
    },
```

| | |
|---|---|
| bwp-Id | BWP-Id, |
| resourceType | ENUMERATED { aperiodic, semiPersistent, periodic }, |

```
    ...
  }
  -- TAG-CSI-RESOURCECONFIG-STOP
  -- ASN1STOP
```

CSI-ResourceConfig field descriptions

```
  bwp-Id
  The DL BWP which the CSI-RS associated with this CSI-ResourceConfig are located in
(see TS 38.214 [19], clause 5.2.1.2.
  csi-IM-ResourceSetList
  List of references to CSI-IM resources used for beam measurement and reporting in a
CSI-RS resource set. Contains up to maxNrofCSI-IM-ResourceSetsPerConfig resource sets if
resourceType is ‘aperiodic’ and 1 otherwise (see TS 38.214 [19], clause 5.2.1.2).
  csi-ResourceConfigId
  Used in CSI-ReportConfig to refer to an instance of CSI-ResourceConfig.
  csi-SSB-ResourceSetList
  List of references to SSB resources used for beam measurement and reporting in a CSI-
RS resource set (see TS 38.214 [19], clause 5.2.1.2).
  nzp-CSI-RS-ResourceSetList
  List of references to NZP CSI-RS resources used for beam measurement and reporting in
a CSI-RS resource set. Contains up to maxNrofNZP-CSI-RS-ResourceSetsPerConfig resource sets
if resourceType is ‘aperiodic’ and 1 otherwise (see TS 38.214 [19], clause 5.2.1.2).
  resourceType
  Time domain behavior of resource configuration (see TS 38.214 [19], clause 5.2.1.2). It
does not apply to resources provided in the csi-SSB-ResourceSetList.
```

TABLE 35
The IE NZP-CSI-RS-ResourceSet is a set of Non-Zero-Power (NZP)
CSI-RS resources (their IDs) and set-specific parameters.
NZP-CSI-RS-ResourceSet information element

```
  -- ASN1START
  -- TAG-NZP-CSI-RS-RESOURCESET-START
```

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI- |

RS-ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

```
OPTIONAL, -- Need R
    ...,
    [[
```

| | |
|---|---|
| aperiodicTriggeringOffset-r16 | INTEGER(0..31) |

```
OPTIONAL -- Need S
    ]]
  }
  -- TAG-NZP-CSI-RS-RESOURCESET-STOP
  -- ASN1STOP
```

NZP-CSI-RS-ResourceSet field descriptions

```
  aperiodicTriggeringOffset, aperiodicTriggeringOffset-r16
  Offset X between the slot containing the DCI that triggers a set of aperiodic NZP CSI-
RS resources and the slot in which the CSI-RS resource set is transmitted. For
aperiodicTriggeringOffset, the value 0 corresponds to 0 slots, value 1 corresponds to 1 slot, value
2 corresponds to 2 slots, value 3 corresponds to 3 slots, value 4 corresponds to 4 slots, value 5
corresponds to 16 slots, value 6 corresponds to 24 slots. For aperiodicTriggeringOffset-r16, the
value indicates the number of slots. The network configures only one of the fields. When neither
field is included, the UE applies the value 0.
  nzp-CSI-RS-Resources
  NZP-CSI-RS-Resources associated with this NZP-CSI-RS resource set (see TS 38.214
[19], clause 5.2). For CSI, there are at most 8 NZP CSI RS resources per resource set.
  repetition
  Indicates whether repetition is on/off. If the field is set to off or if the field is absent, the
UE may not assume that the NZP-CSI-RS resources within the resource set are transmitted with
the same downlink spatial domain transmission filter (see TS 38.214 [19], clauses 5.2.2.3.1 and
5.1.6.1.2). It can only be configured for CSI-RS resource sets which are associated with CSI-
ReportConfig with report of L1 RSRP or “no report”.
  trs-Info
  Indicates that the antenna port for all NZP-CSI-RS resources in the CSI-RS resource set
is same. If the field is absent or released the UE applies the value false (see TS 38.214 [19],
clause 5.2.2.3.1).
```

TABLE 36
The IE CSI-SSB-ResourceSet is used to configure
one SS/PBCH block resource set which refers to
SS/PBCH as indicated in ServingCellConfigCommon.
CSI-SSB-ResourceSet information element

```
  -- ASN1START
  -- TAG-CSI-SSB-RESOURCESET-START
```

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |

```
ResourcePerSet)) OF SSB-Index,
    ...
  }
  -- TAG-CSI-SSB-RESOURCESET-STOP
  -- ASN1STOP
```

TABLE 37
The IE CSI-IM-ResourceSet is used to configure a set
of one or more CSI Interference Management (IM) resources
(their IDs) and set-specific parameters.
CSI-IM-ResourceSet information element

```
  -- ASN1START
  -- TAG-CSI-IM-RESOURCESET-START
```

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM- |

```
ResourcesPerSet)) OF CSI-IM-ResourceId,
    ...
  }
  -- TAG-CSI-IM-RESOURCESET-STOP
  -- ASN1STOP
```

CSI-IM-ResourceSet field descriptions

```
  csi-IM-Resources
  CSI-IM-Resources associated with this CSI-IM-ResourceSet (see TS
38.214 [19], clause 5.2)
```

TABLE 38
The CSI-AperiodicTriggerStateList IE is used to configure the UE with a list of aperiodic
trigger states. Each codepoint of the DCI field “CSI request” is associated
with one trigger state. Upon reception of the value associated with a trigger state,
the UE will perform measurement of CSI-RS (reference signals) and aperiodic reporting
on L1 according to all entries in the associatedReportConfigInfoList for that trigger state.
CSI-AperiodicTriggerStateList information element

```
  -- ASN1START
  -- TAG-CSI-APERIODICTRIGGERSTATELIST-START
```

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

```
(SIZE(1..maxNrofReportConfigPerAperiodicTrigger)) OF CSI-AssociatedReportConfigInfo,
    ...
  }
```

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI- |

RS-ResourcesPerSet)) OF TCI-StateId OPTIONAL -- Cond Aperiodic
},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |

```
ResourceSetsPerConfig) OPTIONAL, -- Cond CSI-IM-ForInterference
    nzp-CSI-RS-ResourcesForInterference INTEGER (1..maxNrofNZP-CSI-RS-
ResourceSetsPerConfig) OPTIONAL, -- Cond NZP-CSI-RS-ForInterference
    ...
  }
  -- TAG-CSI-APERIODICTRIGGERSTATELIST-STOP
    -- ASN1STOP
```

CSI-AssociatedReportConfigInfo field descriptions

```
  csi-IM-ResourcesForInterference
  CSI-IM-ResourceSet for interference measurement. Entry number in csi-IM-
ResourceSetList in the CSI-ResourceConfig indicated by csi-IM-ResourcesForInterference in the
CSI-ReportConfig indicated by reportConfigId above (1 corresponds to the first entry, 2 to the
second entry, and so on). The indicated CSI-IM-ResourceSet should have exactly the same
number of resources like the NZP-CSI-RS-ResourceSet indicated in nzp-CSI-RS-
ResourcesforChannel.
  csi-SSB-ResourceSet
  CSI-SSB-ResourceSet for channel measurements. Entry number in csi-SSB-
ResourceSetList in the CSI-ResourceConfig indicated by resourcesForChannelMeasurement in
the CSI-ReportConfig indicated by reportConfigId above (1 corresponds to the first entry, 2 to
the second entry, and so on).
  nzp-CSI-RS-ResourcesForInterference
  NZP-CSI-RS-ResourceSet for interference measurement. Entry number in nzp-CSI-RS-
ResourceSetList in the CSI-ResourceConfig indicated by nzp-CSI-RS-ResourcesForInterference
in the CSI-ReportConfig indicated by reportConfigId above (1 corresponds to the first entry, 2 to
the second entry, and so on).
  qcl-info
  List of references to TCI-States for providing the QCL source and QCL type for each
NZP-CSI-RS-Resource listed in nzp-CSI-RS-Resources of the NZP-CSI-RS-ResourceSet
indicated by nzp-CSI-RS-ResourcesforChannel. Each TCI-StateId refers to the TCI-State which
has this value for tci-StateId and is defined in tci-StatesToAddModList in the PDSCH-Config
included in the BWP-Downlink corresponding to the serving cell and to the DL BWP to which the
resourcesForChannelMeasurement (in the CSI-ReportConfig indicated by reportConfigId above)
belong to. First entry in qcl-info-forChannel corresponds to first entry in nzp-CSI-RS-Resources
of that NZP-CSI-RS-ResourceSet, second entry in qcl-info-forChannel corresponds to second
entry in nzp-CSI-RS-Resources, and so on (see TS 38.214 [19], clause 5.2.1.5.1)
  reportConfigId
  The reportConfigId of one of the CSI-ReportConfigToAddMod configured in CSI-
MeasConfig
  resourceSet
  NZP-CSI-RS-ResourceSet for channel measurements. Entry number in nzp-CSI-RS-
ResourceSetList in the CSI-ResourceConfig indicated by resourcesForChannelMeasurement in
the CSI-ReportConfig indicated by reportConfigId above (1 corresponds to the first entry, 2 to
thesecond entry, and so on).
```

| Conditional Presence | Explanation |
|---|---|
| Aperiodic | The field is mandatory present if the NZP-CSI- |
| | RS-Resources in the associated resourceSet have the |
| | resourceType aperiodic. The field is absent otherwise. |
| CSI-IM-ForInterference | This field is optional need M if the CSI- |
| | ReportConfig identified by reportConfigId is configured |
| | with csi-IM-ResourcesForInterference; otherwise it is |
| | absent. |
| NZP-CSI-RS- | This field is optional need M if the CSI- |
| ForInterference | ReportConfig identified by reportConfigId is configured |
| | with nzp-CSI-RS-ResourcesForInterference; otherwise it |
| | is absent. |

TABLE 39
The CSI-SemiPersistentOnPUSCH-TriggerStateList IE is used to configure
the UE with list of trigger states for semi-persistent reporting of
channel state information on L1. See also TS 38.214 [19], clause 5.2.
CSI-SemiPersistentOnPUSCH-TriggerStateList information element

```
  -- ASN1START
  -- TAG-CSI-SEMIPERSISTENTONPUSCHTRIGGERSTATELIST-START
```

| | |
|---|---|
| CSI-SemiPersistentOnPUSCH-TriggerStateList ::= | SEQUENCE(SIZE |

(1..maxNrOfSemiPersistentPUSCH-Triggers)) OF CSI-SemiPersistentOnPUSCH-TriggerState

| | |
|---|---|
| CSI-SemiPersistentOnPUSCH-TriggerState ::= | SEQUENCE { |
| associatedReportConfigInfo | CSI-ReportConfigId, |

```
    ...
  }
  -- TAG-CSI-SEMIPERSISTENTONPUSCHTRIGGERSTATELIST-STOP
  -- ASN1STOP
```

With regard to the aforementioned CSI report settings (CSI-ReportConfig), each report setting CSI-ReportConfig may be associated with one downlink (DL) bandwidth part identified by a higher-layer parameter bandwidth part identifier (bwp-id) given by CSI resource setting CSI-ResourceConfig associated with the corresponding report setting. As time domain reporting for each report setting CSI-ReportConfig, “aperiodic”, “semi-persistent”, and “periodic” schemes may be supported, and these schemes may be configured for the UE by the base station via a reportConfigType parameter configured from a higher layer. A semi-persistent CSI report method may support a “PUCCH-based semi-persistent (semi-PersistentOnPUCCH)” method and a “PUSCH-based semi-persistent (semi-PersistentOnPUSCH)” method. In the case of the periodic or semi-persistent CSI report method, a PUCCH or PUSCH resource in which CSI is to be transmitted may be configured for the UE by the base station via higher-layer signaling. A periodicity and a slot offset of the PUCCH or PUSCH resource in which CSI is to be transmitted may be given by a numerology of an uplink (UL) bandwidth part configured for CSI report transmission. In the case of the aperiodic CSI report method, a PUSCH resource in which CSI is to be transmitted may be scheduled for the UE by the base station via L1 signaling (aforementioned DCI format 0_1). With regard to the aforementioned CSI resource settings (CSI-ResourceConfig), each CSI resource setting CSI-ReportConfig may include S(≥1) CSI resource sets (e.g., given via a higher-layer parameter of csi-RS-ResourceSetList). A CSI resource set list may include a non-zero power (NZP) CSI-RS resource set and an SS/PBCH block set or may include a CSI-interference measurement (CSI-IM) resource set. Each CSI resource setting may be positioned in a downlink (DL) bandwidth part identified by higher-layer parameter bwp-id and may be connected to CSI report setting in the same downlink bandwidth part. A time domain operation of a CSI-RS resource in CSI resource setting may be configured to be one of “aperiodic”, “periodic”, or “semi-persistent” from the higher-layer parameter resourceType. With regard to the periodic or semi-persistent CSI resource setting, the number of CSI-RS resource sets may be limited to S (S=1), and the configured periodicity and slot offset may be given based on numerology of the downlink bandwidth part identified by bwp-id. One or more CSI resource settings for channel or interference measurement may be configured for the UE by the base station via higher-layer signaling, and may include, for example, the following CSI resources.
CSI-IM resource for interference measurement
NZP CSI-RS resource for interference measurement
NZP CSI-RS resource for channel measurement

With regard to CSI-RS resource sets associated with a resource setting in which the higher-layer parameter of resourceType is configured to be “aperiodic”, “periodic”, or “semi-persistent”, a trigger state of CSI report setting having reportType configured to be “aperiodic”, and a resource setting for channel or interference measurement on one or multiple component cells (CCs) may be configured via the higher-layer parameter of CSI-AperiodicTriggerStateList.

Aperiodic CSI reporting of the UE may be performed using a PUSCH, periodic CSI reporting may be performed using a PUCCH, and semi-persistent CSI reporting may be performed using a PUSCH when triggered or activated via DCI, and may be performed using a PUCCH after activated via a MAC control element (MAC CE). As described above, CSI resource setting may also be configured to be aperiodic, periodic, or semi-persistent. A combination of CSI reporting setting and CSI resource setting may be supported based on Table 40 below.

TABLE 40

| CSI-RS | | Semi-Persistent CSI | Aperiodic CSI |
|---|---|---|---|
| Configuration | Periodic CSI Reporting | Reporting | Reporting |
| Periodic CSI-RS | No dynamic | For reporting on | Triggered by DCI; |
| | triggering/activation | PUCCH, the UE | additionally, |
| | | receives an activation | activation command |
| | | command [10, TS | [10, TS 38.321] |
| | | 38.321]; for reporting | possible as defined in |
| | | on PUSCH, the UE | Subclause 5.2.1.5.1. |
| | | receives triggering | |
| | | on DCI | |
| Semi-Persistent CSI- | Not Supported | For reporting on | Triggered by DCI; |
| RS | | PUCCH, the UE | additionally, |
| | | receives an activation | activation command |
| | | command [10, TS | [10, TS 38.321] |
| | | 38.321]; for reporting | possible as defined in |
| | | on PUSCH, the UE | Subclause 5.2.1.5.1. |
| | | receives triggering | |
| | | on DCI | |
| Aperiodic CSI-RS | Not Supported | Not Supported | Triggered by DCI; |
| | | | additionally, |
| | | | activation command |
| | | | [10, TS 38.321] |
| | | | possible as defined in |
| | | | Subclause 5.2.1.5.1. |

Aperiodic CSI reporting may be triggered by a “CSI request” field in DCI format 0_1 described above, which corresponds to scheduling DCI for a PUSCH. The UE may monitor a PDCCH, may acquire DCI format 0_1, and may acquire scheduling information of a PUSCH and a CSI request indicator. The CSI request indicator may be configured to have NTS (=0, 1, 2, 3, 4, 5, or 6) bits, and may be determined by higher-layer signaling (reportTriggerSize). One trigger state among one or multiple aperiodic CSI report trigger states which may be configured via higher-layer signaling (CSI-AperiodicTriggerStateList) may be triggered by the CSI request indicator.

If all bits in the CSI request field are 0, this may indicate that CSI reporting is not requested.

If the number M of configured CSI trigger states in CSI-AperiodicTriggerStateLite is greater than 2NTs−1, M CSI trigger states may be mapped to 2NTs−1 trigger states according to a predefined mapping relation, and one trigger state among the 2NTs−1 trigger states may be indicated by the CSI request field.

If the number M of configured CSI trigger states in CSI-AperiodicTriggerStateLite is less than or equal to 2NTs−1, one of the M CSI trigger states may be indicated by the CSI request field.

Table 41 below shows an example of a relationship between a CSI request indicator and a CSI trigger state that may be indicated by a corresponding indicator.

TABLE 41

| CSI | CSI | CSI- | CSI- |
|---|---|---|---|
| request field | trigger state | ReportConfigId | ResourceConfigId |
| 00 | no CSI request | N/A | N/A |
| 01 | CSI trigger | CSI report#1 | CSI resource#1, |
| | state#1 | CSI report#2 | CSI resource#2 |
| 10 | CSI trigger | CSI report#3 | CSI resource#3 |
| | state#2 | | |
| 11 | CSI trigger | CSI report#4 | CSI resource#4 |
| | state#3 | | |

The UE may measure a CSI resource in a CSI trigger state triggered via the CSI request field, and then generate CSI (including, for example, at least one of the CQI, PMI, CRI, SSBRI, LI, RI, or L1-RSRP described above) based on the measurement. The UE may transmit the acquired CSI by using the PUSCH scheduled via corresponding DCI format 0_1. If one bit corresponding to an uplink data indicator (UL-SCH indicator) in DCI format 0_1 indicates “1”, the UE may multiplex uplink data (UL-SCH) and the acquired CSI on the PUSCH resource scheduled by DCI format 0_1 so as to transmit the same. If one bit corresponding to the uplink data indicator (UL-SCH indicator) in DCI format 0_1 indicates “0”, the UE may map only CSI, without uplink data (UL-SCH), to the PUSCH resource scheduled by DCI format 0_1 so as to transmit the same.

FIG. 12 illustrates an example of a method in which, upon receiving a downlink control channel, a UE selects a receivable control resource set in consideration of priority in a wireless communication system according to an embodiment of the disclosure. In FIG. 12, details related to the aforementioned [PDCCH QCL prioritization rule] will be described.

Referring to FIG. 12, the UE may be configured to receive multiple control resource sets overlapping temporally in a specific PDCCH monitoring occasion 1210, and such multiple control resource sets may be connected to a common search space or a UE-specific search space with regard to multiple cells. In the corresponding PDCCH monitoring occasion, control resource set no. 1 1200 connected to common search space no. 1 may exist in bandwidth part no. 1 1215 of cell no. 1, and control resource set no. 1 1205 connected to common search space no. 1 and control resource set no. 2 1220 connected to UE-specific search space no. 2 may exist in bandwidth part no. 1 1225 of cell no. 2. The control resource sets 1215 and 1220 may have a relation of QCL-TypeD with CSI-RS resource no. 1 configured in bandwidth part no. 1 of cell no. 1, and the control resource set 1225 may have a relation of QCL-TypeD with CSI-RS resource no. 1 configured in bandwidth part no. 1 of cell no. 2. If criterion 1 is applied to the corresponding PDCCH monitoring occasion 1210, all other control resource sets having the same reference signal of QCL-TypeD as control resource set no. 1 1215 may be received. Therefore, the UE may receive the control resource sets 1210 and 1215 in the corresponding PDCCH monitoring occasion 1220. As another example, the UE may be configured to receive multiple control resource sets overlapping temporally in a specific PDCCH monitoring occasion 1240, and such multiple control resource sets may be connected to a common search space or a UE-specific search space with regard to multiple cells. In the corresponding PDCCH monitoring occasion, control resource set no. 1 1230 connected to UE-specific search space no. 1 and control resource set no. 2 1245 connected to UE-specific search space no. 2 may exist in bandwidth part no. 1 1250 of cell no. 1, and control resource set no. 1 1235 connected to UE-specific search space no. 1 and control resource set no. 2 1255 connected to UE-specific search space no. 3 may exist in bandwidth part no. 1 1260 of cell no. 2. The control resource sets 1245 and 1250 may have a relation of QCL-TypeD with CSI-RS resource no. 1 configured in bandwidth part no. 1 of cell no. 1, the control resource set 1255 may have a relation of QCL-TypeD with CSI-RS resource no. 1 configured in bandwidth part no. 1 of cell no. 2, and the control resource set 1260 may have a relation of QCL-TypeD with CSI-RS resource no. 2 configured in bandwidth part no. 1 of cell no. 2. If criterion 1 is applied to the corresponding PDCCH monitoring occasion 1240, there is no common search space, and the next criterion, that is, criterion 2, may thus be applied. If criterion 2 is applied to the corresponding PDCCH monitoring occasion 1240, all other control resource sets having the same reference signal of QCL-TypeD as control resource set no. 1 1245 may be received. Therefore, the UE may receive the control resource sets 1240 and 1245 in the corresponding PDCCH monitoring occasion 1250.

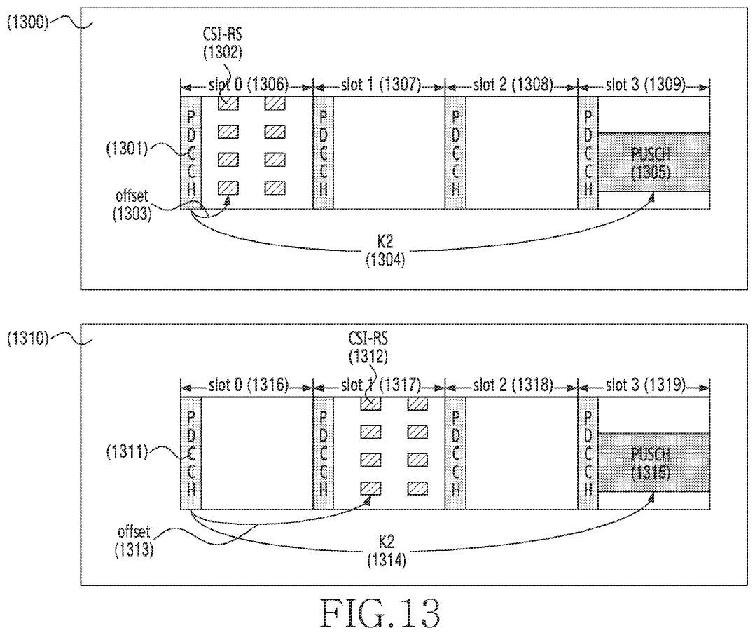

FIG. 13 illustrates an example of an aperiodic CSI reporting method according to an embodiment of the disclosure.

In an example 1300 of FIG. 13, a UE may acquire DCI format 0_1 by monitoring a PDCCH 1301, and may acquire scheduling information and CSI request information for a PUSCH 1305 therefrom. The UE may acquire resource information of a CSI-RS 1302 to be measured, from a received CSI request indicator. The UE may determine a time point at which the UE needs to measure a resource of the CSI-RS 1302, based on a time point at which DCI format 0_1 is received, and a parameter for an offset (e.g., aforementioned aperiodicTriggeringOffset) in a CSI resource set configuration (e.g., an NZP CSI-RS resource set configuration (NZP-CSI-RS-ResourceSet)). More specifically, the UE may be configured with an offset value X of the parameter, aperiodicTriggeringOffset, in the NZP-CSI-RS resource set configuration from a base station via higher-layer signaling, and the configured offset value X may refer to an offset between a slot in which DCI triggering aperiodic CSI reporting is received, and a slot in which the CSI-RS resource is transmitted. For example, aperiodicTriggeringOffset parameter values and offset values X may have mapping relationships as shown in Table 42 below.

TABLE 42

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

A first example 1300 of FIG. 13 shows an example in which aforementioned offset value X is configured to be 0 (X=0). In this case, the UE may receive the CSI-RS 1302 in a slot (corresponding to slot 0 1306 of FIG. 13) in which DCI format 0_1 triggering aperiodic CSI reporting is received, and may report CSI information, which is measured based on the received CSI-RS, to the base station via the PUSCH 1305. The UE may acquire, from DCI format 0_1, scheduling information (information corresponding to each field of DCI format 0_1 described above) on the PUSCH 1305 for CSI reporting. For example, in DCI format 0_1, the UE may acquire information on a slot in which the PUSCH 1305 is to be transmitted, from time domain resource allocation information for the PUSCH 1305 described above. In the first example 1300 of FIG. 13, the UE acquires 3 as a K2 value corresponding to a slot offset value for PDCCH-to-PUSCH, and accordingly, the PUSCH 1305 may be transmitted in slot 3 1309, which is spaced 3 slots apart from slot 0 1306, i.e., a time point at which the PDCCH 1301 has been received. In a second example 1310 of FIG. 13, the UE may acquire DCI format 0_1 by monitoring a PDCCH 1311, and may acquire scheduling information and CSI request information for a PUSCH 1315 therefrom. The UE may acquire resource information of a CSI-RS 1312 to be measured, from a received CSI request indicator. The second example 1310 of FIG. 13 shows an example in which the offset value X for CSI-RS described above is configured to be 1 (X=1). In this case, the UE may receive the CSI-RS 1312 in a slot (corresponding to slot 0 1316 of FIG. 13) in which DCI format 0_1 triggering aperiodic CSI reporting is received, and may report CSI information, which is measured based on the received CSI-RS, to the base station via the PUSCH 1315.

The aperiodic CSI report may include at least one of or both CSI part 1 and CSI part 2, and when the aperiodic CSI report is transmitted via the PUSCH, the aperiodic CSI report may be multiplexed on a transport block. After a CRC is inserted into an input bit of aperiodic CSI for multiplexing, encoding and rate matching may be performed, and then transmission may be performed by mapping to resource elements within the PUSCH in a specific pattern. The CRC insertion may be omitted depending on a coding method or a length of the input bit. The number of modulation symbols, which is calculated for rate matching during multiplexing of CSI part 1 or CSI part 2 included in the aperiodic CSI report, may be calculated as shown in Table 43.

```
TABLE 43
    For CSI part 1 transmission on PUSCH not using repetition type B with UL-
SCH, the number of coded modulation symbols per layer for CSI part 1 transmission,
$denoted as {Q}_{CSI - part 1}^{′} , is determined as follows :$
    ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot$
${\sum }_{l = 0}^{{N}_{symb , all}^{PUSCH} - 1} {M}_{sc}^{UCI} ( l ) ⌉ - {Q}_{ACK / CG - UCI}^{′} \}$
    . . .
    For CSI part 1 transmission on an actual repetition of a PUSCH with repetition
Type B with UL-SCH, the number of coded modulation symbols per layer for CSI part 1
$transmission , denoted as {Q}_{CSI - part 1}^{′} , is determined as follows :$
  ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot$
${\sum }_{l = 0}^{{N}_{symb , nominal}^{PUSCH} - 1} {M}_{sc , nominal}^{UCI} ( l ) ⌉ - {Q}_{ACK / CG - UCI}^{′} ,$
${\sum }_{l = 0}^{{N}_{symb , actual}^{PUSCH} - 1} {M}_{sc , actual}^{UCI} ( l ) - {Q}_{ACK / CG - UCI}^{′} \}$
    . . .
    For CSI part 1 transmission on PUSCH without UL-SCH, the number of coded
$modulation symbols per layer for CSI part 1 transmission , denoted as {Q}_{CSI - part 1}^{′} , is$
determined as follows:
    if there is CSI part 2 to be transmitted on the PUSCH,
    ${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$
    else
    ${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
    end if
    . . .
  For CSI part 2 transmission on PUSCH not using repetition type B with UL-
SCH, the number of coded modulation symbols per layer for CSI part 2 transmission,
$denoted as {Q}_{CSI - part 2}^{′} , is determined as follows :$
    ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot$
${\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$
    For CSI part 2 transmission on an actual repetition of a PUSCH with repetition
Type B with UL-SCH, the number of coded modulation symbols per layer for CSI part 2
$transmission , denoted as {Q}_{CSI - part 2}^{′} , is determined as follows :$
  ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot$
${\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} ,$
${\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$
    . . .
    For CSI part 2 transmission on PUSCH without UL-SCH, the number of coded
$modulation symbols per layer for CSI part 2 transmission , denoted as {Q}_{CSI - part 2}^{′} , is$
determined as follows:
    ${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$
```

Specifically, for repeated PUSCH transmission schemes A and B, the UE may multiplex the aperiodic CSI report only on the first repetition transmission among PUSCH repetition transmissions, so as to transmit the same. This is because aperiodic CST report information to be multiplexed is encoded in a polar code scheme, and at this time, each PUSCH repetition needs to have the same frequency and time resource allocation in order to multiplex the aperiodic CSI report information on multiple PUSCH repetitions. Particularly, in the case of PUSCH repetition type B transmission, since each actual repetition may have different OFDM symbol durations, the aperiodic CSI report may be multiplexed only on the first repetition and then transmitted. In addition, for repeated PUSCH transmission scheme B, when the UE receives DCI for activation of semi-persistent CSI reporting or scheduling of aperiodic CST reporting without scheduling for a transport block, the UE may assume that a value of nominal repetition is 1 even if the number of repeated PUSCH transmissions, which is configured via higher-layer signaling, is greater than 1. In addition, when the aperiodic or semi-persistent CSI reporting is scheduled or activated without scheduling for a transport block, based on repeated PUSCH transmission scheme B, the UE may expect that a first nominal repetition is identical to a first actual repetition. With regard to the PUSCH transmitted while including semi-persistent CSI, based on repeated PUSCH transmission scheme B, without scheduling for DCI after the semi-persistent CSI reporting has been activated via the DCI, if the first nominal repetition is different from the first actual repetition, transmission for the first nominal repetition may be ignored.

### [Regarding UE Capability Report]

*LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE may configure UE capability according to band information and RAT type requested by the base station. The method in which the UE configures UE capability in an NR system is summarized below. However, the disclosure is not limited thereto.
1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. In addition, bands may have priority in the order described in FreqBandList.
2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.
3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well, that is, LTE bands are also applied. BCs remaining after the above step constitute the final “candidate BC list”.
4. The UE selects BCs appropriate for the requested RAT type from the final “candidate BC list” and configures BCs to report. In this step, the UE configures supportedBandCombinationList in a determined order. That is, the UE configures BCs and UE capability to report according to a preconfigured rat-Type order. (NR→eutra-NR→eutra). In addition, the UE configures featureSetCombination regarding the configured supportedBandCombinationList and configures a list of “candidate feature set combinations” from a candidate BC list from which a list regarding fallback BCs (including capability of the same or lower level) is removed. The “candidate feature set combinations” may include all feature set combinations regarding NR and EUTRA-NR BCs, and may be obtained from feature set combinations of containers of UE-NR-Capabilities and UE-MRDC-Capabilities.
5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE may transfer a UE capability information message including the UE capability to the base station. The base station may perform scheduling and transmission/reception management appropriate for the UE, based on the UE capability received from the UE.

FIG. 14 illustrates an example of PUSCH repetition type B transmission in a wireless communication system according to an embodiment of the disclosure. The UE may receive the following configurations: the start symbol S of an uplink data channel is 0, the length L of the uplink data channel is 14, and the number of repetition transmissions is 16. In this case, nominal repetitions may appear in 16 consecutive slots (% n). Thereafter, the UE may determine that the symbol configured as a downlink symbol in each nominal repetition % n is an invalid symbol. The UE may determine that symbols configured as 1 in the invalid symbol pattern 1410 are invalid symbols. If valid symbols other than invalid symbols in respective nominal repetitions constitute one or more consecutive symbols in one slot, they are configured and transmitted as actual repetitions (1415).

In addition, with regard to PUSCH repeated transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repetition transmissions are scheduled inside one slot or across the boundary of consecutive slots. In connection with method 1, time domain resource allocation information inside DCI indicates resources of the first repetition transmission. In addition, time domain resource information of remaining repetition transmissions may be determined according to time domain resource information of the first repetition transmission, and the uplink or downlink direction determined with regard to each symbol of each slot. Each repetition transmission occupies consecutive symbols.
Method 2 (multi-segment transmission): through one UL grant, two or more PUSCH repetition transmissions are scheduled in consecutive slots. Transmission no. 1 is designated for each slot, and the start point or repetition length differs between respective transmissions. In method 2, time domain resource allocation information inside DCI indicates the start point and repetition length of all repetition transmissions. In the case of performing repetition transmissions inside a single slot through method 2, if there are multiple bundles of consecutive uplink symbols in the corresponding slot, respective repetition transmissions may be performed with regard to respective uplink symbol bundles. If there is a single bundle of consecutive uplink symbols in the corresponding slot, PUSCH repetition transmission is performed once according to the method of NR Release 15.
Method 3: two or more PUSCH repetition transmissions are scheduled in consecutive slots through two or more UL grants. Transmission no. 1 may be designated with regard to each slot, and the nth UL grant may be received before PUSCH transmission scheduled by the (n−1)th UL grant is over.
Method 4: through one UL grant or one configured grant, one or multiple PUSCH repetition transmissions inside a single slot, or two or more PUSCH repetition transmissions across the boundary of consecutive slots may be supported. The number of repetitions indicated to the UE by the base station is only a nominal value, and the UE may actually perform a larger number of PUSCH repetition transmissions than the nominal number of repetitions. Time domain resource allocation information inside DCI or configured grant refers to resources of the first repetition transmission indicated by the base station. Time domain resource information of remaining repetition transmissions may be determined with reference to resource information of the first repetition transmission and the uplink or downlink direction of symbols. If time domain resource information of repetition transmission indicated by the base station spans a slot boundary or includes an uplink/downlink switching point, the corresponding repetition transmission may be divided into multiple repeated transmissions. One repetition transmission may be included in one slot with regard to each uplink period.

### [Regarding CA/DC]

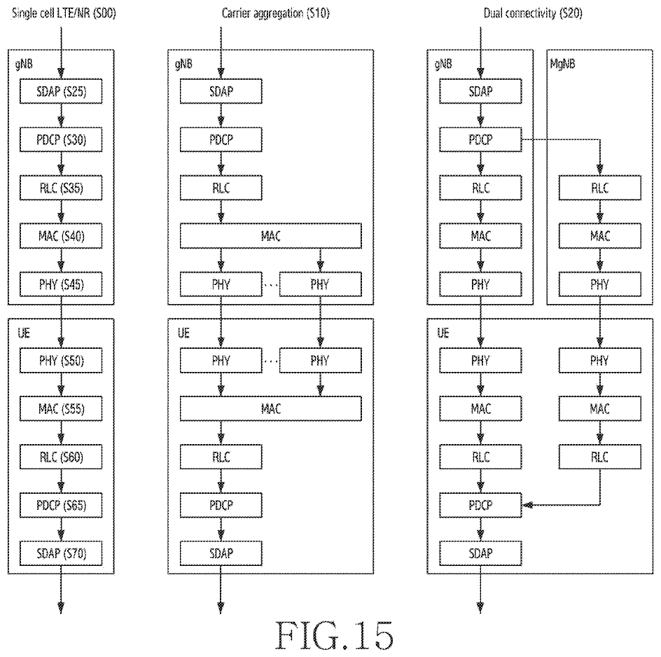

FIG. 15 illustrates radio protocol structures of a base station and a UE in single cell, carrier aggregation, and dual connectivity situations in a wireless communication system according to an embodiment of the disclosure.

Referring to FIG. 15, a radio protocol of a mobile communication system includes an NR service data adaptation protocol (SDAP) S25 or S70, an NR packet data convergence protocol (PDCP) S30 or S65, an NR radio link control (RLC) S35 or S60, and an NR medium access controls (MAC) S40 or S55, on each of UE and NR base station sides.

The main functions of the NR SDAP S25 or S70 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP S30 or S65 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC S35 or S60 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device may refer to a function of successively delivering RLC SDUs received from the lower layer to the upper layer. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all RLC SDUs received until now to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of immediately transferring RLC SDUs received from a lower layer, to an upper layer regardless of the sequence thereof, and may include a function of, if one original RLC SDU is divided into several RLC SDUs and then the RLC SDUs are received, reassembling the several RLC SDUs and transferring the reassembled RLC SDUs. The out-of-sequence delivery function of the NR RLC device may include a function of storing RLC SNs or PDCP SNs of received RLC PDUs and arranging the order to record lost RLC PDUs.

The NR MAC S40 or S55 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer S45 or S50 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. As an example, in case that the base station transmits data to the UE, based on a single carrier (or cell), the base station and the UE may use a protocol structure having a single structure with regard to each layer, such as S00. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as S10. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as S20.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may improve the PDCCH reception reliability of a UE by providing a PDCCH repetitive transmission method through multiple transmission points (TRPs). Specific methods thereof will be described hereinafter through the embodiments below.

Hereinafter, embodiments of the disclosure will be described in detail in conjunction with the accompanying drawings. The contents of the disclosure may be applied to FDD and TDD systems. As used herein, upper signaling (or upper layer signaling) is a method for transferring signals from a base station to a UE by using a downlink data channel of a physical layer, or from the UE to the base station by using an uplink data channel of the physical layer, and may also be referred to as “RRC signaling”, “PDCP signaling”, or “medium access control (MAC) control element (MAC CE)”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

### [Regarding NC-JT]

According to an embodiment of the disclosure, non-coherent joint transmission (NC-JT) may be used for the UE to receive PDSCHs from multiple TRPs.

Unlike the conventional system, the 5G wireless communication system may support all of the service having very short transmission latency and the service requiring a high connectivity density, as well as the service requiring a high transmission rate. In a wireless communication network including multiple cells, transmission and reception points (TRPs), or beams, cooperative communication (coordinated transmission) between the respective cells, TRPs, or/and beams may satisfy various service requirements by enhancing the strength of a signal received by a UE or efficiently performing interference control between the respective cells. TRPs, or/and beams.

Joint transmission (JT) is a representative transmission scheme for the aforementioned cooperative communication, and is a scheme for increasing the strength or throughput of a signal received by a UE, by transmitting the signal to one UE via multiple different cells, TRPs, and/or beams. Here, a channel between respective cells, TRPs, and/or beam and the UE may have different characteristics, and particularly, non-coherent joint transmission (NC-JT) supporting non-coherent precoding between respective cells, TRPs, and/or beams may need individual precoding, MCS, resource allocation, and TCI indication according to the channel characteristics for each link between respective cells, TRPs, and/or beam and the UE.

The aforementioned NC-JT transmission may be applied to at least one channel among a downlink data channel (physical downlink shared channel (PDSCH)), a downlink control channel (physical downlink control channel (PDCCH)), an uplink data channel (physical uplink shared channel (PUSCH)), and an uplink control channel (physical uplink control channel (PUCCH)). During PDSCH transmission, transmission information such as precoding, MCS, resource allocation, and TCI may be indicated through DL DCI, and should be independently indicated for each cell, TRP, and/or beam for the NC-JT. This is a significant factor that increases payload required for DL DCI transmission, which may have a bad influence on reception performance of a PDCCH for transmitting the DCI. Therefore, in order to support JT of a PDSCH, it is necessary to carefully design tradeoff between the amount of DCI information and control information reception performance.

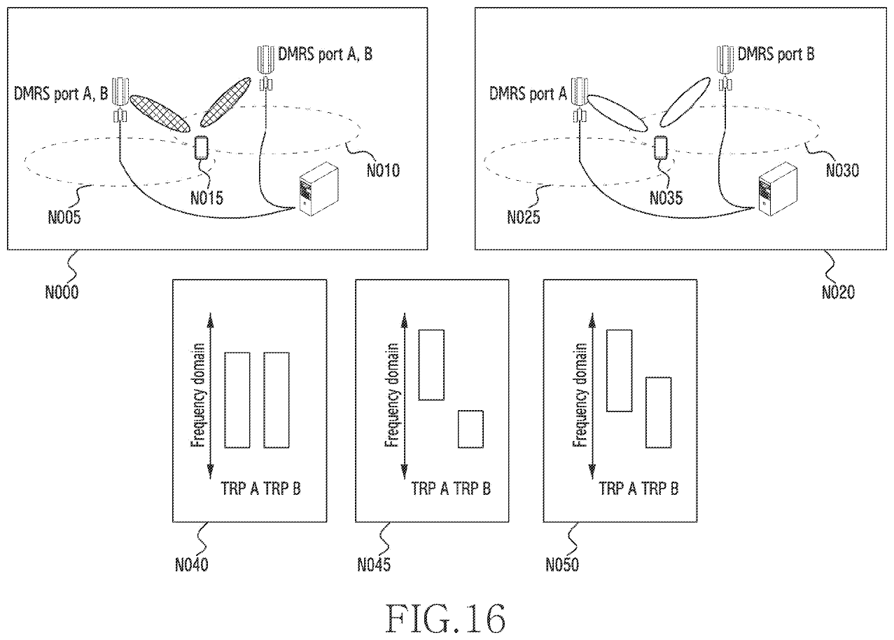

FIG. 16 illustrates an example of an antenna port configuration and resource allocation for cooperative communication in a wireless communication system according to an embodiment of the disclosure. Specifically, FIG. 16 illustrates an example of an antenna port configuration and resource allocation for transmitting a PDSCH using cooperative communication in a wireless communication system.

Referring to FIG. 16, an example for PDSCH transmission is described for each joint transmission (JT) scheme, and examples for radio resource allocation for each TRP are illustrated.

Referring to FIG. 16, an example N000 for coherent joint transmission (C-JT) supporting coherent precoding between respective cells, TRPs, or/and beams is illustrated.

For C-JT, TRP A N005 and TRP B N010 transmit a single piece of data (PDSCH) to a UE N015, and joint precoding may be performed in multiple TRPs. This may indicate that DMRSs are transmitted through identical DMRS ports in order for TRP A N005 and TRP B N010 to transmit the same PDSCH. For example, TRP A N005 and TRP B N010 may transmit DRMSs to the UE through DMRS port A and DMRS port B, respectively. In this case, the UE may receive one piece of DCI information for receiving one PDSCH demodulated based on the DMRSs transmitted through the DMRS port A and the DMRS port B.

FIG. 16 shows an example N020 of non-coherent joint transmission (NC-JT) supporting non-coherent precoding between respective cells, TRPs, and/or beams for PDSCH transmission.

For NC-JT, a PDSCH is transmitted to a UE N035 for each cell, TRP, or/and beam, and individual precoding may be applied to each PDSCH. Respective cells, TRPs, and/or beams may transmit different PDSCHs or different PDSCH layers to the UE, thereby improving throughput compared to single cell, TRP, and/or beam transmission. Furthermore, respective cells, TRPs, and/or beams may repeatedly transmit the same PDSCH to the UE, thereby improving reliability compared to single cell, TRP, and/or beam transmission. For the sake of descriptive convenience, a cell, a TRP, and/or a beam may be collectively referred to as a TRP.

In this case, various radio resource allocations may be considered, such as a case N040 where frequency and time resources used in multiple TRPs for PDSCH transmission are all identical, a case N045 where frequency and time resources used in multiple TRPs do not overlap at all, and a case N050 where some of frequency and time resources used in multiple TRPs overlap.

To support NC-JT, DCI of various types, structures, and relations may be considered to assign multiple PDSCHs simultaneously to a single UE.

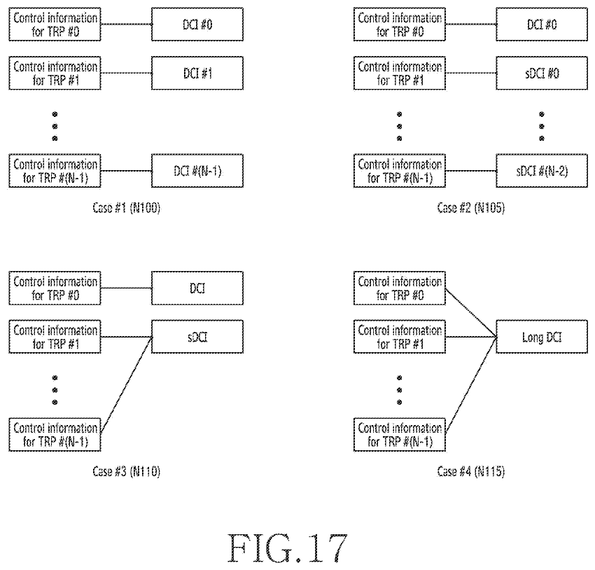

FIG. 17 illustrates an example of a downlink control information (DCI) configuration for cooperative communication in a wireless communication system according to an embodiment of the disclosure, Specifically. FIG. 17 illustrates an example of a DCI configuration for NC-JT in which respective TRPs transmit different PDSCHs or different PDSCH layers to a UE in a wireless communication system.

Referring to FIG. 17, case #1 N100 is an example in which, in a situation where different N−1 PDSCHs are transmitted from N−1 additional TRPs (TRP #1 to TRP #N−1) in addition to a serving TRP (TRP #0) used during single PDSCH transmission, control information for PDSCHs transmitted in the additional N−1 TRPs is transmitted independently of control information for a PDSCH transmitted in the serving TRP. That is, the UE may acquire control information for PDSCHs transmitted from different TRPs (TRP #0 to TRP #(N−1)) through independent pieces of DCI (DCI #0 to DCI #(N−1)). Formats between the independent pieces of DCI may be the same as or different from each other, and payload between the pieces of DCI may also be the same as or different from each other. In case #1 described above, a degree of freedom of PDSCH control or allocation may be completely guaranteed, but when respective pieces of the DCI are transmitted by different TRPs, a difference between DCI coverages may be generated and reception performance may deteriorate.

Case #2 N105 is an example in which pieces of control information (DCI) for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened pieces of DCI (hereinafter, referred to as sDCI) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, the sDCI for transmitting control information of PDSCHs transmitted from cooperative TPRs has smaller payload compared to the normal DCI (nDCI) for transmitting control information related to the PDSCH transmitted from the serving TRP, and thus can include reserved bits compared to the nDCI.

In case #2 described above, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 N110 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DC format 1_0, DCI format 1_1, and DCI format 1_2 may be gathered in one “secondary” DCI (sDCI) and transmitted. For example, the sDCI may include at least one piece of HARQ-related information, such as frequency domain resource assignment, time domain resource assignment, and MCS of cooperative TRPs. In addition, information that is not included in the sDCI such as a bandwidth part (BWP) indicator and a carrier indicator may follow the DCI (DCI #0, normal DCI, or nDCI) of the serving TRP.

In case #3 N110, each PDSCH control or allocation freedom may be restricted according to content of the information element included in the sDCI, but sDCI reception performance may be adjustable, and complexity of DCI blind decoding of the UE may be reduced compared to case #1 N100 or case #2 N105.

Case #4 N115 is an example in which, in a situation where N−1 different PDSCHs are transmitted from N−1 additional TRPs (TRP #1 to TRP #N−1) in addition to a serving TRP (TRP #0) used during single PDSCH transmission, control information for PDSCHs transmitted from the N−1 additional TRPs is transmitted in the same DCI (long DCI) as that for the control information for the PDSCH transmitted from the serving TRP. That is, the UE may acquire control information for PDSCHs transmitted from different TRPs (TRP #0 to TRP #(N−1)) through single DCI. In case #4 N115, complexity of DCI blind decoding of the UE may not increase, but a PDSCH control or allocation freedom may be low, such that the number of cooperative TRPs is limited according to long DCI payload restrictions.

In the following description and embodiments, sDCI may refer to various pieces of supplementary DCI such as shortened DCI, secondary DCI, or normal DCI (DCI formats 1_0 and 1_1 described above) including PDSCH control information transmitted in the cooperative TRP, and unless specific restriction is mentioned, the corresponding description may be similarly applied to the various pieces of supplementary DCI.

In the following descriptions and embodiments, aforementioned cases #1 N100, case #2 N105, and case #3 N110, in which one or more pieces of DCI are used for NC-JT support, may be classified as multiple-PDCCH-based NC-JT, and aforementioned case #4 N115, in which a single piece of DCI (PDCCH) is used for NC-JT support, may be classified as single-PDCCH-based NC-JT. In multiple PDCCH-based PDSCH transmission, a CORESET for scheduling the DCI of the serving TRP (TRP #0) is separated from CORESETs for scheduling the DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. In addition, in the single-PDCCH-based NC-JT, a single piece of DCI is used for scheduling of a single PDSCH having multiple layers, instead of scheduling of multiple PDSCHs, and the aforementioned multiple layers may be transmitted from multiple TRPs. In this case, association between a layer and a TRP transmitting the corresponding layer may be indicated through a transmission configuration indicator (TCI) indication for the layer.

According to embodiments of the disclosure, the “cooperative TRP” may be replaced by various terms such as a “cooperative panel” or a“cooperative beam” when actually applied.

According to embodiments of the disclosure, “the case in which NC-JT is applied” may be variously interpreted as “the case in which the UE simultaneously receives one or more PDSCHs in one BWP”, “the case in which the UE simultaneously receives PDSCHs based on two or more transmission configuration indicator (TCI) indications in one BWP”, and “the case in which the PDSCHs received by the UE are associated with one or more DMRS port groups” according to circumstances, but is used by one expression for convenience of description.

In the disclosure, a radio protocol structure for NC-JT may be used in various ways according to a TRP deployment scenario. For example, if there is no backhaul delay between cooperative TRPs or there is a small backhaul delay, a method (a CA-like method) using a structure based on MAC layer multiplexing can be used. Contrarily, if a backhaul delay between cooperative TRPs is so large that the backhaul delay cannot be ignored (e.g., when a time of 2 ms or longer is required for exchange of information, such as CSI, scheduling, and HARQ-ACK, between the cooperative TRPs), a method (DC-like method) of securing characteristics robust to a delay by using an independent structure for each TRP starting from the RLC layer is possible in a similar manner to the DC protocol structure S20 of FIG. 15.

The UE supporting C-JT/NC-JT may receive a C-JT/NC-JT-related parameter or a setting value from a higher-layer configuration and set an RRC parameter of the UE based on the same. For the higher-layer configuration, the UE may use a UE capability parameter, for example, tci-StatePDSCH. Here, the UE capability parameter, for example, tci-StatePDSCH may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. The maximum value of 128 may refer to a value indicated by maxNumberConfiguredTCI statesPerCC in the parameter of tci-StatePDSCH included in capability signaling of the UE. As described above, a series of configuration processes from the higher-layer configuration to the MAC CE configuration may be applied to a beamforming indication or a beamforming change command for at least one PDSCH in one TRP.

### [Multi-DCI-Based Multi-TRP]

According to an embodiment of the disclosure, a downlink control channel for NC-JT transmission may be configured based on multiple PDCCHs.

In NC-JT based on multiple PDCCHs, there may be a CORESET or a search space separated for each TRP when the DCI for scheduling the PDSCH of each TRP is transmitted. The CORESET or the search space for each TRP can be configured according to at least one of the following configuration cases.
A configuration of a higher-layer index for each CORESET: CORESET configuration information configured by a higher layer may include an index value, and a TRP for transmitting a PDCCH in the corresponding CORESET may be distinguished by the configured index value for each CORESET. That is, in a set of CORESETs having the same higher-layer index value, it may be considered that the same TRP transmits the PDCCH or that the PDCCH for scheduling the PDSCH of the same TRP is transmitted. The index for each CORESET may be named CORESETPoolIndex, and it may be considered that the PDCCH is transmitted from the same TRP in CORESETs in which the same CORESETPoolIndex value is configured. In the CORESET in which the same CORESETPoolIndex value is not configured, it may be considered that a default value of CORESETPoolIndex is configured, and the default value may be 0.
Multiple-PDCCH-Config configuration: Multiple values of PDCCH-Config may be configured in one BWP, and each PDCCH-Config may include a PDCCH configuration for each TRP. That is, a list of CORESETs for each TRP and/or a list of search spaces for each TRP may be included in one PDCCH-Config, and it may be considered that one or more CORESETs and one or more search spaces included in one PDCCH-Config correspond to a specific TRP.
CORESET beam/beam group configuration: A TRP corresponding to a corresponding CORESET may be distinguished via a beam or beam group configured for each CORESET. For example, when the same TCI state is configured in a plurality of CORESETs, it may be considered that the corresponding CORESETs are transmitted through the same TRP or that a PDCCH for scheduling a PDSCH of the same TRP is transmitted in the corresponding CORESET.
Search space beam/beam group configuration: A beam or beam group may be configured for each search space, and a TRP for each search space may be distinguished based on the configured beam or beam group. For example, when the same beam/beam group or TCI state is configured in a plurality of search spaces, the same TRP may transmit the PDCCH in the corresponding search space or a PDCCH for scheduling a PDSCH of the same TRP may be transmitted in the corresponding search space.

As described above, by separating the CORESETs or search spaces for each TRP, it is possible to divide PDSCHs and HARQ-ACK for each TRP and accordingly to generate an independent HARQ-ACK codebook for each TRP and use an independent PUCCH resource.

The above-described CORESET or search space configurations according to TRPs may be independent for each cell or for each BWP. For example, while two different CORESETPoolIndex values may be configured in PCell, no CORESETPoolIndex value may be configured in a specific SCell. In this case. NC-JT may be configured in the PCell, but NC-JT may not be configured in the SCell in which no CORESETPoolIndex value is configured.

### [Single-DCI-Based Multi-TRP]

According to another embodiment of the disclosure, a downlink beam for NC-JT transmission may be configured based on a single PDCCH.

In single-PDCCH-based NC-JT, PDSCHs transmitted by multiple TRPs may be scheduled via one piece of DCI. Here, as a method of indicating the number of TRPs transmitting the corresponding PDSCHs, the number of TCI states may be used. That is, when the number of TCI states indicated by the DCI for scheduling the PDSCHs is 2, single PDCCH-based NC-JT transmission may be considered, and when the number of TCI states is 1, single-TRP transmission may be considered. The TCI states indicated by the DCI may correspond to one or two TCI states among TCI states activated via a MAC-CE. If the TCI states of the DCI correspond to two TCI states activated by the MAC CE, a TCI codepoint indicated by the DCI is associated with the TCI states activated by the MAC CE, and this may correspond to a case in which the number of TCI states activated by the MAC CE, corresponding to the TCI codepoint, is 2.

The above-described downlink beam configuration for NC-JT transmission may be independently configured for each cell or for each BWP. For example, while a maximum number of activated TCI states corresponding to one TCI codepoint is 2 in the PCell, a maximum number of activated TCI states corresponding to one TCI codepoint may be 1 in a specific SCell. In this case, it may be considered that NC-JT may be configured in the PCell but NC-JT may not be configured in the SCell.

### [PHR]

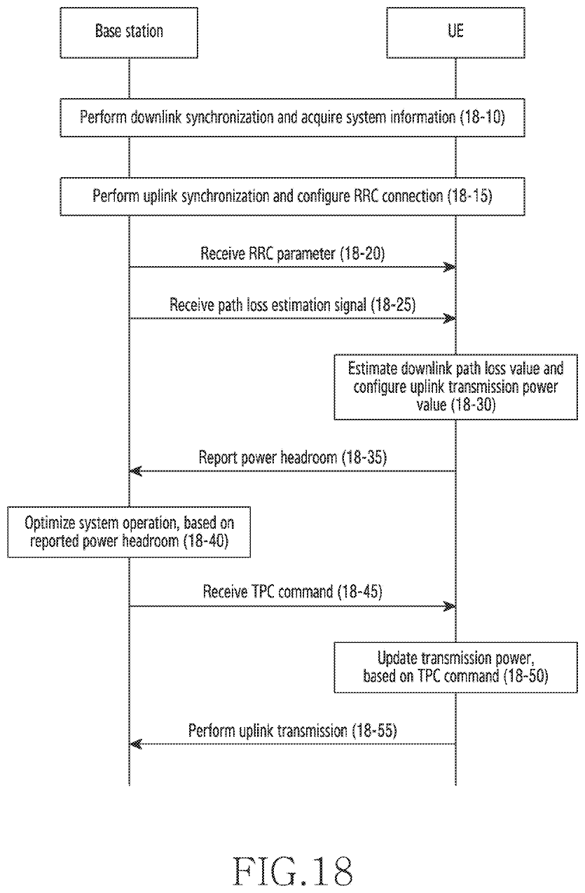

FIG. 18 is a diagram illustrating a procedure in which a base station controls transmission power of a UE in a cellular system according to an embodiment of the disclosure.

Referring to FIG. 18, In operation 18-10, a UE in coverage of a base station may perform downlink synchronization with the base station, and acquire system information. According to an embodiment of the disclosure, downlink synchronization may be performed using a synchronization signal of a primary synchronization signal/secondary synchronization signal (PSS/SSS) received from the base station. UEs having performed downlink synchronization may receive a master information block (MIB) and a system information block (SIB) from the base station, and acquire system information. In operation 18-15, via a random-access procedure, the UE may perform uplink synchronization with the base station and establish a radio resource control (RRC) connection. In the random-access procedure, the UE may transmit a random-access preamble and message3 (msg3) to the base station via an uplink. In this case, when the random-access preamble and message 3 are transmitted, uplink transmission power control may be performed. Specifically, the UE may receive parameters for the uplink transmission power control from the base station via the acquired system information, for example, the SIB, or may perform the uplink transmission power control using a predetermined parameter. In another embodiment of the disclosure, the UE may measure reference signal received power (RSRP) from a path attenuation estimation signal transmitted by the base station, and may estimate a downlink path attenuation value as shown in Equation 7. In addition, based on the estimated path attenuation value, the UE may configure an uplink transmission power value for transmitting the random-access preamble and message 3.

Downlink path attenuation=transmission power of a base station signal−RSRP measured by the UE [Equation 7]

In [Equation 7], the transmission power of the base station signal may refer to transmission power of a downlink path attenuation estimation signal transmitted by the base station. The downlink path attenuation estimation signal transmitted by the base station may be a cell-specific reference signal (CRS) or a synchronization signal block (SSB). If the path attenuation estimation signal is a cell-specific reference signal (CRS), the transmission power of the base station signal may indicate transmission power of the CRS, and may be transmitted to the UE via a referenceSignalPower parameter of the system information. If the path attenuation estimation signal is a synchronization signal block (SSB), the transmission power of the base station signal may indicate transmission power of a secondary synchronization signal (SSS) and of a demodulation reference signal (DMRS) that is transmitted via a PBCH, and may be transmitted to the UE via an ss-PBCH-BlockPower parameter of the system information. In operation 18-20, the UE may receive, from the base station, RRC parameters for the uplink transmission power control via UE-specific RRC or common RRC. In this case, the received transmission power control parameters may be different from each other according to an uplink channel type and a signal type. That is, transmission power control parameters to be applied to transmission of a physical uplink control channel (PUCCH), a physical uplink shared channel (PUSCH), and a sounding reference signal (SRS) may be different from each other. In addition, as described above, a transmission power control parameter received by the UE from the base station via the SIB before RRC connection establishment or transmission power control parameters that the UE has used as predetermined values before the RRC connection establishment may be included in the RRC parameters transmitted from the base station after the RRC connection establishment. The UE may use an RRC parameter value, which is received from the base station after the RRC connection establishment, to control uplink transmission power.

In operation 18-25, the UE may receive a path attenuation estimation signal from the base station. More specifically, after the RRC connection establishment of the UE, the base station may configure a channel state information-reference signal (CSI-RS) as the path attenuation estimation signal for the UE. In this case, the base station may transmit information on transmission power of the CSI-RS to the UE via a powerControlOffsetSS parameter of UE-dedicated RRC information. Here, powerControlOffsetSS may indicate a transmission power difference (offset) between the SSB and the CSI-RS. In operation 18-30, the UE may estimate the downlink path attenuation value and configure the uplink transmission power value. More specifically, the UE may measure a downlink RSRP by using the CSI-RS, and may estimate the downlink path attenuation value via [Equation 7] by using the information on transmission power of the CSI-RS received from the base station. In addition, based on the estimated downlink path attenuation value, the UE may configure the uplink transmission power value for PUCCH, PUSCH, and SRS transmission. In operation 18-35, the UE may perform power headroom reporting (PHR) to the base station. A power headroom may indicate a difference between current transmission power of the UE and maximum output power of the UE. In operation 18-40, the UE may optimize system operation, based on the reported power headroom. For example, if a power headroom value reported to the base station by a specific UE is a positive value, the base station may allocate more resource blocks (RBs) to the UE, thereby increasing a system yield. In operation 18-45, the UE may receive, from the base station, a transmission power control command (TPC). If a power headroom value reported to the base station by a specific UE is a negative value, the base station may allocate fewer resources to the UE or may decrease transmission power of the UE via the TPC. Accordingly, the system throughput may be increased, or unnecessary power consumption of the UE may be decreased. In operation 18-50, the UE may update transmission power, based on the TPC command. In this case, the TPC command may be transmitted to the UE via UE-specific DCI or group common DCI. Therefore, the base station may dynamically control transmission power of the UE via the TPC command. In operation 18-55, the UE may perform uplink transmission based on the updated transmission power.

### [PUSCH Power Control]

PUSCH transmission power may be determined through Equation 8 below.

$${P}_{PUSCH} ( i , j , {q}_{d} , l ) = min \{ \begin{matrix}{P}_{CMAX , f , c} ( i ) , \\ \begin{matrix}{P}_{{0}_{PUSCH} , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] \qquad [ Equation 8 ]$$

In Equation 8, P_{CMAX,f,c}(i) is a maximum transmission power configured for the UE at carrier f of serving cell c in PUSCH transmission occasion i. P₀_{_{PUSCH}}_{,b,f,c}(j) is a reference configuration transmission power configuration value according to activated uplink bandwidth part (BWP) b of carrier f of serving cell c and has different values according to various transmission types j. The value may vary according to whether PUSCH transmission is a message 3 PUSCH for random access, or a PUSCH is a configured grant PUSCH or scheduled PUSCH.

$${M}_{RB , b , f , c}^{PUSCH} ( i )$$

denotes a frequency size to which a PUSCH is allocated. α_{b,f,c}(j) indicates a value of a compensation ratio degree for the path loss of UL BWP b of carrier f of serving cell c, may be configured by a higher signal, and may have different values according to j. PL_{b,f,c}(q_{d}) is a downlink path loss estimation of UL BWP b of carrier f of serving cell c, and is measured through a reference signal in an activated downlink bandwidth part. The reference signal may be an SS/PBCH block or a CSI-RS. As described above in Equation 7, a downlink path loss may be calculated. In another embodiment of the disclosure, PL_{b,f,c}(q_{d}) denotes a downlink path loss value and is a path loss calculated by the UE as shown in Equation 7. The UE may calculate a path loss, based on a reference signal resource associated with an SS/PBCH block or CSI-RS, depending on whether a higher signal is configured. As the reference signal resource, one of multiple sets of reference signal resources may be selected according to a higher signal or L1 signal, and the UE calculates a path loss, based on the reference signal resource. Δ_{TF,b,f,c}(i) is a value determined by a modulation and coding scheme (MCS) value of a PUSCH of PUSCH transmission occasion i of UL BWP b of carrier f of serving cell c. f_{b,f,c}(i,l) is a power control adjustment value and a power value may be dynamically adjusted by a TPC command.

The TPC command is classified into an accumulated mode and an absolute mode, and one of the two modes is determined by a higher signal. In the accumulated mode, the power control adjustment value is determined by accumulating a currently determined power control adjustment value to the value indicated by a TPC command, may increase or decrease according to the TPC command, and has the relationship of f_{b,f,c}(i,l)=f_{b,f,c}(i−i₀,l)+Σδ_{PUSCH,b,f,c}·δ_{PUSCH,b,f,c} is the value indicated by the TPC command. In the absolute mode, the power control adjustment value is determined by the TPC command regardless of the currently determined power control adjustment value, and has the relationship of f_{b,f,c}(i,l)=δ_{PUSCH,b,f,c}. Table 44 below shows values that the TPC command is capable of indicating.

TABLE 44

| | Accumulated | Absolute |
|---|---|---|
| | δ_{PUSCH, b, f, c} | δ_{PUSCH, b, f, c} or |
| TPC Command | or δ_{SRS, b, f, c} | δ_{SRS, b, f, c} |
| Field | [dB] | [dB] |
| 0 | −1 | −4 |
| 1 | 0 | −1 |
| 2 | 1 | 1 |
| 3 | 3 | 4 |

### [PUCCH Power Control]

The following Equation 9 is an equation determining PUCCH transmission power.

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{{0}_{PUCCH} , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{{F}_{PUCCH}} ( i ) + {Δ}_{TF , b , f , c} ( i ) + {f}_{b , f , c} ( i , l )\end{matrix}\end{matrix} \} \qquad [ Equation 9 ]$$

[dBm]

In Equation 9, P₀_{_{PUCCH}}_{,b,f,c}(qᵤ) is a reference configuration transmission power configuration value, has different values according to various transmission types qᵤ, and may be changed by a higher signal, such as RRC or a MAC CE. If the value is changed via a MAC CE, the UE determines that the changed value is applied starting from slot k+k_{offset}, where k is a slot in which a HARQ-ACK is transmitted for a PDSCH through which the MAC CE is received. The value of k_{offset} may vary depending on the subcarrier spacing and may be, for example, 3 ms.

$${M}_{RB , b , f , c}^{PUCCH} ( i )$$

is the size of a frequency resource area to which a PUCCH is allocated. PL_{b,f,c}(q_{d}) is a path loss estimation of the UE, and may be calculated by the UE, based on a specific reference signal among various CSI-RSs or SS/PBCHs according to whether a higher signal is configured and the type thereof, as described above with reference to Equation 7. The same q_{d} is applied to repeatedly transmitted PUCCHs. The same qᵤ may be applied to repeatedly transmitted PUCCHs.

### [NES Time Domain]

Various methods may exist to reduce power consumption at the base station. As a representative method, a method of transmitting and receiving a signal within limited time resources may be considered. By not transmitting or receiving a signal for a particular time, the base station may not use power required for transmission and reception.

Cell DTX, from the perspective of the base station, may be divided into a first period in which a signal is periodically transmitted, and a second period in which a signal is not transmitted. The first period may be referred to as an active period, and the second period may be referred to as a non-active period. During the second period, the UE may be unable to receive any signals or may receive only some critical signals. For example, 1) the UE may not receive any signals during the second period. Alternatively, 2) the UE may receive only a synchronization signal (SSB) during the second period. Alternatively, 3) the UE may receive a synchronization signal (SSB), data that does not require HARQ feedback, and control information indicating corresponding data information during the second period. Alternatively, 4) the UE may receive a synchronization signal (SSB), data that does not require HARQ feedback, control information indicating corresponding data information, and a reference signal during the second period. The reference signal (RS) may be at least one of a DMRS, a CSI-RS, and a PRS. Alternatively, the reference signal may correspond to other reference signals for channel estimation. Alternatively, 5) the UE may receive a synchronization signal (SSB), data that does not require HARQ feedback, control information indicating corresponding data information, a reference signal, a PDCCH existing in a UE-common search space (CSS), and relevant data information during the second period. The reference signal (RS) may be at least one of a DMRS, a CSI-RS, and a PRS. Alternatively, the reference signal may correspond to other reference signals for channel estimation.

Cell DRX, from the perspective of the base station, may be divided into a first period in which a signal is periodically received, and a second period in which a signal is not received. The first period may be referred to as an active period, and the second period may be referred to as a non-active period. During the second period, the UE may be unable to transmit any signals or may transmit only some critical signals. For example, 1) the UE may not transmit any signals during the second period. Alternatively, 2) the UE may transmit only a PRACH and a Msg.3 PUSCH during the second period. Alternatively, 3) the UE may transmit only a PRACH, a PUSCH including Message 3 information, and a reference signal during the second period. The reference signal may correspond to an SRS or other reference signals for uplink channel estimation. Alternatively, 4) the UE may transmit only a PRACH, a PUSCH including Message 3 information, a reference signal, and a periodically transmitted signal during the second period. The reference signal may correspond to an SRS or other reference signals for uplink channel estimation. The periodically transmitted signal may be an SR, CSI, or a configured grant PUSCH.

The base station described above may be applied as a transmission node, and the UE may be applied as a reception node. That is, the UE may be a transmission node and the base station may be a reception node.

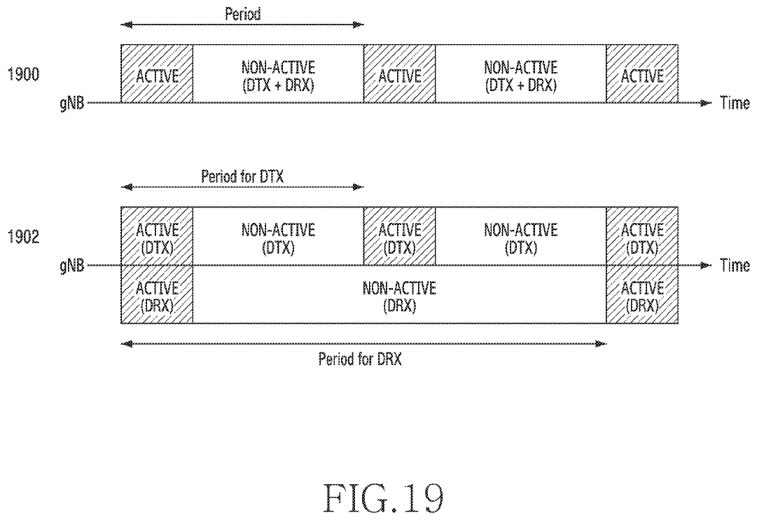

FIG. 19 illustrates a signal transmission/reception period of a base station in a wireless communication system according to an embodiment of the disclosure.

Referring to FIG. 19, cell DTX and cell DRX may have a common periodicity (PERIOD), a common first period (ACTIVE), and a common second period (NON-ACTIVE), as illustrated in a first example 1900. Alternatively, cell DTX and cell DRX may have different periodicities (PERIOD), different first periods (ACTIVE), and different second periods (NON-ACTIVE), as illustrated in a second example 1902. Alternatively, cell DTX and cell DRX may have a common periodicity (PERIOD), but have different first periods (ACTIVE) and different second periods (NON-ACTIVE). Since cell DTX refers to the base station periodically transmitting no signals during the second period (NON-ACTIVE), the UE may define, from the UE's perspective, the period as a period in which no signals are received, similar to UE DRX. Since cell DRX refers to the base station periodically receiving no signals during the second period (NON-ACTIVE), the UE may define, from the UE's perspective, the period as a period in which no signals are transmitted, similar to UE DTX.

Since cell DTX refers to the base station performing no transmission during the second period (NON-ACTIVE), other signals may overlap with the second period from the UE's perspective. If a corresponding signal is a downlink signal and the second period is previously configured by an L2 signal such as RRC, the UE may consider that the signal overlaps with a semi-static UL, and cancel the reception of the signal. If a corresponding signal is a downlink signal and the second period is indicated by an L1 signal such as DCI, the UE considers that a semi-static flexible symbol is indicated to be UL by a dynamic SFI. Then, the UE may consider that the symbol overlaps with the signal, and cancel the reception of the signal. In this case, a processing timeline for canceling the reception may be defined. For example, immediately after the L1 signal is received, during a predetermined period (T1), the UE may cancel or not cancel the reception of the signal, and after the T1 period, may cancel the reception of the signal. If a corresponding signal is an uplink signal and the second period is previously configured by an L2 signal such as RRC, the UE may consider that the signal overlaps with a semi-static DL, and cancel the transmission of the signal. If a corresponding signal is an uplink signal and the second period is indicated by an L1 signal such as DCI, the UE considers that a semi-static flexible symbol is indicated to be DL by a dynamic SFI. Then, the UE may consider that the symbol overlaps with the signal, and cancel the transmission of the signal. In this case, a processing timeline for canceling the transmission may be defined. For example, immediately after the L1 signal is received, during a predetermined period (T2), the UE may cancel or not cancel the transmission of the signal, and after the T2 period, may cancel the transmission of the signal.

Since cell DRX refers to the base station performing no reception during the second period (NON-ACTIVE), other signals may overlap with the second period from the UE's perspective. If a corresponding signal is a downlink signal and the second period is previously configured by an L2 signal such as RRC, the UE may consider that the signal overlaps with a semi-static UL, and cancel the reception of the signal. If a corresponding signal is a downlink signal and the second period is indicated by an L1 signal such as DCI, the UE may consider that a semi-static flexible symbol is indicated to be UL by a dynamic SFI. Then, the UE may consider that the symbol overlaps with the signal, and cancel the reception of the signal. In this case, a processing timeline for canceling the reception may be defined. For example, immediately after the L1 signal is received, during a predetermined period (T1), the UE may cancel or not cancel the reception of the signal, and after the T1 period, may cancel the reception of the signal. If a corresponding signal is an uplink signal and the second period is previously configured by an L2 signal such as RRC, the UE may consider that the signal overlaps with a semi-static DL, and cancel the transmission of the signal. If a corresponding signal is an uplink signal and the second period is indicated by an L1 signal such as DCI, the UE considers that a semi-static flexible symbol is indicated to be DL by a dynamic SFI. Then, the UE may consider that the symbol overlaps with the signal, and cancel the transmission of the signal. In this case, a processing timeline for canceling the transmission may be defined. For example, immediately after the L1 signal is received, during a predetermined period (T2), the UE may cancel or not cancel the transmission of the signal, and after the T2 period, may cancel the transmission of the signal.

Cell DTX and cell DRX are applicable even in an environment where data is transmitted and received through multiple carriers. In such cases, cell DTX and cell DRX may be applied individually for respective carriers. Therefore, configuration information may be provided by each higher signal. Alternatively, common cell DTX and cell DRX may be applied to all carriers. Therefore, corresponding configuration information may be provided by a single higher signal. Alternatively, the UE may determine that configuration information of cell DTX and cell DRX applied to a PCell is applied identically to an SCell.

### [NES Spatial Domain]

As a method for reducing power consumption at the base station, a limited number of transmission/reception antennas installed at the base station may be used. For example, if a base station equipped with 64 transmission/reception antennas transmits and receives a signal by using only 32 transmission/reception antennas under a certain condition, the power consumption required for antenna operation may be reduced by at least half. The base station may notify UEs, via a separate L1 or L2 signal, whether the number of transmission/reception antennas has been adjusted. Specifically, the base station may indicate, to a specific UE or UE groups through the signal, that a limited number of transmission antennas, reception antennas, or transmission/reception antennas has been applied periodically or temporarily during a particular period.

### INTRODUCTION OF EMBODIMENTS

Among the aforementioned methods for reducing power consumption at the base station, an operation method of the UE for performance enhancement in a situation where DTX/DRX is applied in a CA environment is described. In addition, among the aforementioned methods for reducing power consumption at the base station, an operation method of the UE for coverage enhancement in a situation where the number of transmission/reception antennas is adjusted is described.

### First Embodiment: Cell DRX Operation Method 1 in CA Environment

In the first embodiment of the disclosure, in a situation where the UE transmits and receives signals with the base station through multiple cells, a cell DRX or cell DTX period may be configured differently for each cell.

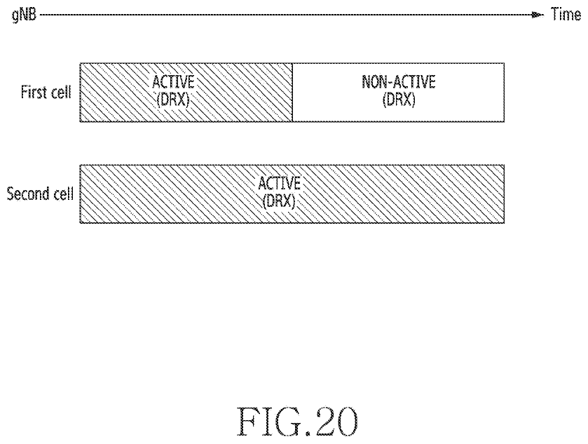

FIG. 20 illustrates an operation of a UE when DTX/DRX is applied in a CA environment in a wireless communication system according to an embodiment of the disclosure. As an example illustrated in FIG. 20, in a situation where a first cell and a second cell are present, during a certain period, while the first cell is in a second period (NON-ACTIVE), the second cell may be in a first period (ACTIVE). An L1 or L2 signal configuring the first period and the second period of cell DRX or cell DTX may separately exist or may simultaneously indicate a different period for each cell. In such a situation, if the first cell is a Pcell, the UE may be unable to transmit a PUCCH transmittable only in the Pcell, during the second period. Therefore, the UE may need to transmit the untransmittable PUCCH through a cell other than the Pcell. Therefore, a specific description is given with reference to the following detailed embodiments.

<(1-1)th Embodiment: Same Subcarrier Spacing and Single Transmission Support>

As a detailed embodiment of the disclosure, in a situation where multiple cells have the same subcarrier spacing and single PUCCH transmission is performed, when a PUCCH to be transmitted in a Pcell overlaps with the second period, the UE may transmit the PUCCH in an Scell rather than the Pcell. The index value of the Scell may be previously separately designated by a higher signal, and one or multiple index values may be possible. If there are multiple Scell index values, the Scell index values are sequenced. If the Pcell and an Scell in the next sequence both overlap with the second period, and an Scell in the subsequent sequence does not overlap with the second period, the UE may perform PUCCH transmission in the Scell. Alternatively, the UE may determine a cell in which a PUCCH is transmitted, based on the ascending order of cell indexes. Alternatively, the UE may determine a set of cells for which the first period is configured in a period of a specific slot or a set of specific slots, and perform PUCCH transmission in a cell having the lowest index or a cell having the highest index in the set. When determining the set of cells for which the first period is configured, the UE may indicate a set of all the configured cells or indicate a set of particular cells configured through a separate higher signal. For reference, the set of cells may always include or not include a Pcell. If the set of cells includes a Pcell, when the Pcell is in the first period, the Pcell may be first selected regardless of the cell index. If the set of cells includes no Pcell, the UE may determine whether the cells included in the set belong to the first period, only when a Pcell is included in the second period. If all the cells in the set including a Pcell belong to the second period, the UE may drop the PUCCH transmission. As a signal used to determine whether each cell is in the first period or the second period, only a higher signal, only an L1 signal, or both signals may be considered. As illustrated in FIG. 20 as an example, if the first cell is a Pcell, the UE may transmit PUCCHs untransmittable in the second period through the first period of the second cell. This may be applied not to all UEs, but only to a UE capable of performing the corresponding operation. Then, the UE reports such a UE capability to the base station. Thereafter, if the second period occurs in the Pcell due to a separate higher signal, the base station may indicate information relating to whether a PUCCH is transmittable through an Scell rather than the Pcell, to the UE having reported the capability.

<(1-2)th Embodiment: Same Subcarrier Spacing, Single Transmission Support, and UE Supporting PUCCH Cell Switching>

As a detailed embodiment of the disclosure, the UE may directly select a cell in which a PUCCH is to be transmitted, through a higher signal or L1 signal instead of periodically selecting a cell in which a PUCCH is to be transmitted, based on first period and second period information, based on cell DRX. For example, through a higher signal-based PUCCH transmission cell selection method, the base station may notify of a set of cells in which the UE is able to transmit a PUCCH during a particular period. For example, a bitmap is configured by 10 bits and indicates the value of 0 or 1. If the bitmap indicates 0, this means a Pcell, and if same indicates 1, this may mean a specific single Scell. Accordingly, if the bitmap indicates 0000011111, it may be noted that the UE is able to transmit a PUCCH through a Pcell in the first five slots during a 10-slot period, and is able to transmit a PUCCH through an Scell in the next five slots. This is called a higher signal-based PUCCH cell switching method. As another example, an L1 signal-based PUCCH transmission cell selection method indicates that the UE directly receives cell index information on a cell in which a PUCCH is to be transmitted, in DCI information received for PUCCH transmission. Therefore, the UE may obtain, through the DCI information, even cell information in addition to a time resource and a frequency resource on which the PUCCH is to be transmitted. This is called an L1 signal-based PUCCH cell switching method. Therefore, if a particular period of the first cell is the second period in the same situation as FIG. 20, the base station may apply a higher signal-based PUCCH cell switching method or an L1 signal-based PUCCH cell switching method to a UE capable of supporting PUCCH cell switching so as to support the UE to transmit a PUCCH resource in the first period of the second cell. However, a signal of cell DRX periodically indicating the first period and the second period and a signal indicating a PUCCH cell switching method may provide conflicting information to the UE. For example, an indication to transmit a PUCCH through the second cell is provided through a PUCCH cell switching method, but a corresponding period may be the second period due to a signal of cell DRX. Alternatively, a PUCCH cell switching method is typically a method in which configuration is performed for each UE, whereas cell DRX may correspond to UE group-specific or cell-common information. Therefore, two signals may provide conflicting information for a particular period for each UE. Since a method of configuring cell DRX is generally classified into a method of indicating using a higher signal and a method of indicating using an L1 signal, and a method of indicating a PUCCH cell switching method is also generally classified into a method of indicating using a higher signal and a method of indicating using an L1 signal, there are the following situations, and a possible UE operation is described.

### Situation A-1: Higher Signal-Based Cell DRX and Higher Signal-Based PUCCH Cell Switching

If information on the first period and the second period of cell DRX is configured for the UE through a higher signal (a first signal), and PUCCH cell switching information is configured through another higher signal (a second signal), the UE may prioritize the first signal. For example, in a situation where PUCCH transmission being performed in a Pcell in a particular period is indicated through PUCCH cell switching information, when the Pcell in the corresponding period is indicated as the second period by a cell DRX configuration, the UE prioritizes the first signal, and thus does not perform the PUCCH transmission in the Pcell in the corresponding period. In addition, since the Pcell corresponds to the second period, the UE may perform the PUCCH transmission in a specific Scell other than the Pcell through a separate UE capability or a separate higher signal configuration.

Alternatively, if information on the first period and the second period of cell DRX is configured for the UE through a higher signal (a first signal), and PUCCH cell switching information is configured through another higher signal (a second signal), the UE may prioritize the second signal. For example, in a situation where PUCCH transmission being performed in a Pcell during a particular period is indicated through PUCCH cell switching information, when the second period is indicated by a cell DRX configuration in the Pcell of the corresponding period, the UE may perform the PUCCH transmission in the Pcell of the corresponding period by prioritizing the second signal.

### Situation A-2: Higher Signal-Based Cell DRX and L1 Signal-Based PUCCH Cell Switching

If information on the first period and the second period of cell DRX is configured for the UE through a higher signal (a first signal), and PUCCH cell switching information is configured through an L1 signal (a second signal), the UE may prioritize the first signal. For example, in a situation where PUCCH transmission being performed in a Pcell during a particular period is indicated through PUCCH cell switching information, when the second period is indicated by a cell DRX configuration in the Pcell of the corresponding period, the UE does not perform the PUCCH transmission in the Pcell of the corresponding period by prioritizing the first signal. In addition, the Pcell is in the second period, and thus the UE may perform the PUCCH transmission in a specific Scell other than the Pcell due to a separate UE capability or a separate higher signal configuration.

Alternatively, if information on the first period and the second period of cell DRX is configured for the UE through a higher signal (a first signal), and PUCCH cell switching information is configured through an L1 signal (a second signal), the UE may prioritize the second signal. For example, in a situation where PUCCH transmission being performed in a Pcell during a particular period is indicated through PUCCH cell switching information, when the second period is indicated by a cell DRX configuration in the Pcell of the corresponding period, the UE may perform the PUCCH transmission in the Pcell of the corresponding period by prioritizing the second signal.

### Situation A-3: L1 Signal-Based Cell DRX and Higher Signal-Based PUCCH Cell Switching

If information on the first period and the second period of cell DRX is configured for the UE through an L1 signal (a first signal), and PUCCH cell switching information is configured through a higher signal (a second signal), the UE may prioritize the first signal. For example, in a situation where PUCCH transmission being performed in a Pcell during a particular period is indicated through PUCCH cell switching information, when the second period is indicated by a cell DRX configuration in the Pcell of the corresponding period, the UE does not perform the PUCCH transmission in the Pcell of the corresponding period by prioritizing the first signal. In addition, the Pcell is in the second period, and thus the UE may perform the PUCCH transmission in a specific Scell other than the Pcell due to a separate UE capability or a separate higher signal configuration.

Alternatively, if information on the first period and the second period of cell DRX is configured for the UE through a higher signal (a first signal), and PUCCH cell switching information is configured through an L1 signal (a second signal), the UE may prioritize the second signal. For example, in a situation where PUCCH transmission being performed in a Pcell during a particular period is indicated through PUCCH cell switching information, w % ben the second period is indicated by a cell DRX configuration in the Pcell of the corresponding period, the UE performs the PUCCH transmission in the Pcell of the corresponding period by prioritizing the second signal.

### Situation A-4: L1 Signal-Based Cell DRX and L1 Signal-Based PUCCH Cell Switching

If information on the first period and the second period of cell DRX is configured for the UE through an L1 signal (a first signal), and PUCCH cell switching information is configured through an L1 signal (a second signal), the UE may prioritize the first signal. For example, in a situation where PUCCH transmission being performed in a Pcell during a particular period is indicated through PUCCH cell switching information, when the second period is indicated by a cell DRX configuration in the Pcell of the corresponding period, the UE does not perform the PUCCH transmission in the Pcell of the corresponding period by prioritizing the first signal. In addition, the Pcell is in the second period, and thus the UE may perform the PUCCH transmission in a specific Scell other than the Pcell due to a separate UE capability or a separate higher signal configuration. Alternatively, if information on the first period and the second period of cell DRX is configured for the UE through a higher signal (a first signal), and PUCCH cell switching information is configured through an L1 signal (a second signal), the UE may prioritize the second signal. For example, in a situation where PUCCH transmission being performed in a Pcell during a particular period is indicated through PUCCH cell switching information, when the second period is indicated by a cell DRX configuration in the Pcell of the corresponding period, the UE performs the PUCCH transmission in the Pcell of the corresponding period by prioritizing the second signal.

<(1-3)th Embodiment: Different Subcarrier Spacings and Single Transmission Support>

In the (1-1)th embodiment, it has been assumed that, when the UE transmits a PUCCH required to be transmitted through a Pcell, through an Scell rather than the Pcell according to a cell DRX configuration, the Pcell and the Scell have the same subcarrier spacing. However, in this embodiment, a UE operation when the Pcell and the Scell have different subcarrier spacings is described.

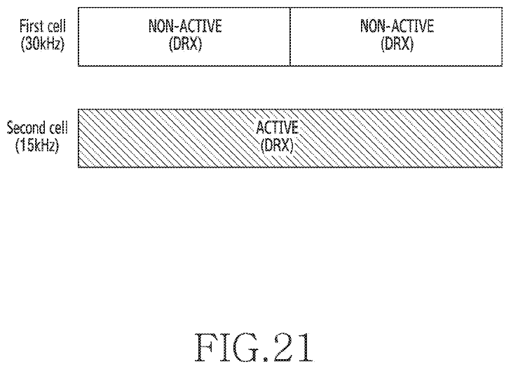

FIG. 21 illustrates an operation of a UE when DTX/DRX is applied in a CA environment in a wireless communication system according to an embodiment of the disclosure. As illustrated in FIG. 21 as an example, when a first cell has a 30 kHz subcarrier spacing and a second cell has a 15 kHz subcarrier spacing, one slot of the second cell may overlap with two slots of the first cell. In this situation, if the first cell is a Pcell and the second period is configured as cell DRX by a higher signal or L1 signal, the UE is unable to perform PUCCH transmission through the Pcell during the period. Therefore, if the first period of the second cell is configured as cell DRX or cell DRX is not configured at all, a method of transmitting a PUCCH through the second cell rather than the first cell that is a Pcell may be considered. However, two slots of the first cell and one slot of the second cell overlap with each other, and thus all PUCCHs existing in respective slots of the first slot being transmitted using the one overlapping slot of the second cell requires a separate multiplexing method. Therefore, as a simple way, only PUCCHs belonging to a particular slot among the two slots in the first cell may be transmitted and received in one overlapping slot of the second cell. In this case, a method of multiplexing PUCCHs scheduled in different slots may be avoided. There may be various criteria determining a particular slot. For example, if a PUCCH is transmitted through an Scell rather than a Pcell and one slot of the Scell overlaps with multiple slots of the Pcell, only a PUCCH scheduled in the frontmost slot among the multiple slots of the Pcell may be transmitted and received in the overlapping slot of the Scell. If there are no PUCCHs scheduled in the slot, the UE does not perform PUCCH transmission in the Scell. As another example, if a PUCCH is transmitted through an Scell rather than a Pcell and one slot of the Scell overlaps with multiple slots of the Pcell, only a PUCCH scheduled in the rearmost slot among the multiple slots of the Pcell may be transmitted and received in the overlapping slot of the Scell. If there are no PUCCHs scheduled in the slot, the UE does not perform PUCCH transmission in the Scell. As another example, if a PUCCH is transmitted through an Scell rather than a Pcell and one slot of the Scell overlaps with multiple slots of the Pcell, only a PUCCH scheduled in a slot configured by a separate higher signal among the multiple slots of the Pcell may be transmitted and received in the overlapping slot of the Scell. If there are no PUCCHs scheduled in the slot, the UE may not perform PUCCH transmission in the Scell. As another example, if a PUCCH is transmitted through an Scell rather than a Pcell and one slot of the Scell overlaps with multiple slots of the Pcell, only a PUCCH scheduled in the frontmost slot of slots in which PUCCHs are scheduled among the multiple slots of the Pcell may be transmitted and received in the overlapping slot of the Scell. As another example, if a PUCCH is transmitted through an Scell rather than a Pcell and one slot of the Scell overlaps with multiple slots of the Pcell, only a PUCCH scheduled in the rearmost slot of slots in which PUCCHs are scheduled among the multiple slots of the Pcell may be transmitted and received in the overlapping slot of the Scell.

The subcarrier spacing of the first cell is assumed and the subcarrier spacing of the second cell are assumed as shown in FIG. 21, but the opposite case may also occur. That is, a case where the subcarrier spacing of the first cell is smaller than the subcarrier spacing of the second cell may occur. In this case, one slot of the first cell may overlap with multiple slots of the second cell. For example, when the first cell has a 15 kHz subcarrier spacing and the second cell has a 30 kHz subcarrier spacing, one slot of the first cell overlaps with two slots of the second cell. In this case, when the first cell is a Pcell, the second cell is an Scell, and a particular period of the first cell is configured to be the second period due to cell DRX, the UE is unable to perform PUCCH transmission during the corresponding period of the Pcell. In the same period, the Scell that is the second cell may be configured to be in the first period by cell DRX, or a cell DRX configuration may not be provided to the second cell. Therefore, a PUCCH untransmittable in the corresponding period of the Pcell may be transmitted through the Scell that is the second cell. In this situation, since one slot of the first cell overlaps with multiple slots of the second cell as described above, the UE needs to determine a slot, among the multiple overlapping slots of the second cell, in which a PUCCH is required to be transmitted. For example, the UE may transmit a PUCCH scheduled in the first cell in the first slot among multiple slots in the second cell overlapping with one slot of the first cell. As another example, the UE may transmit a PUCCH scheduled in the first cell in the last slot among multiple slots in the second cell overlapping with one slot of the first cell. As another example, the UE may transmit a PUCCH scheduled in the first cell in a particular slot configured by a separate higher signal among multiple slots in the second cell overlapping with one slot of the first cell.

<(1-4)th Embodiment: Repeated Transmission>

As a detailed embodiment of the disclosure, when the UE performs repeated transmission of an uplink control signal or data signal (a first signal), if a second period (NON-ACTIVE) is configured by cell DRX, an operation of the UE may need to be defined.

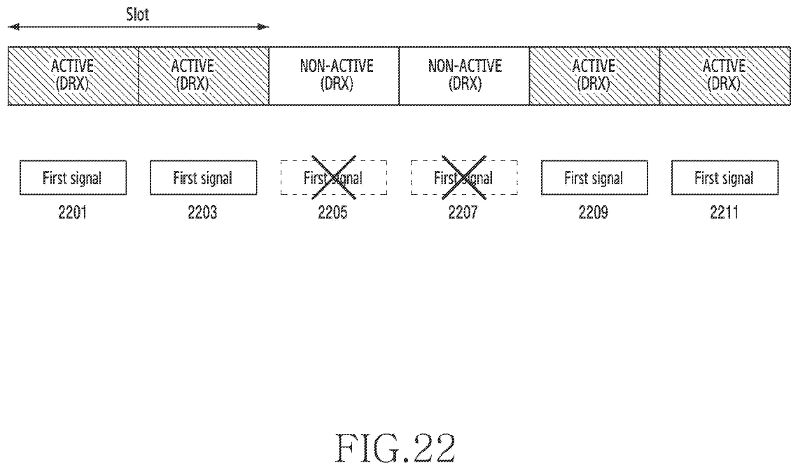

FIG. 22 illustrates an operation of a UE when DTX/DRX is applied in a CA environment in a wireless communication system according to an embodiment of the disclosure. FIG. 22 shows a case where the first signal is scheduled to be repeatedly transmitted four times through four slots starting from the first slot. The time resource of the first signal repeatedly transmitted in each slot is identical. In this case, in a situation where the third slot and the fourth slot are configured to be the second period, and the remaining slots are configured to be the first period, the UE may consider the following methods.
Method A-1: If the second period is configured by a higher signal, the UE drops first signals 2205 and 2207 scheduled third and fourth. Therefore, even if the UE is scheduled to repeatedly transmit the first signal four times, in practice, the UE performs repeated transmission 2201 and 2203 of the first signal only in the first slot and the second slot.
Method A-2: if the second period is configured by an L1 signal, the UE drops the first signals 2205 and 2207 scheduled third and fourth. Therefore, even if the UE is scheduled to repeatedly transmit the first signal four times, in practice, the UE may perform repeated transmission 2201 and 2203 of the first signal only in the first slot and the second slot.
Method A-3: If the second period is configured by a higher signal, the UE does not transmit the first signals 2205 and 2207 scheduled third and fourth and performs the remaining repeated transmission in the subsequent first period. Therefore, the UE performs repeated transmission 2201, 2203, 2209, and 2211 of the first signal, for which four repeated transmissions are scheduled, in the first, second, fifth, and sixth slots.
Method A-4: If the second period is configured by an L1 signal, the UE does not transmit the first signals 2205 and 2207 scheduled third and fourth and may perform the remaining repeated transmission in the subsequent first period. Therefore, the UE may perform repeated transmission 2201, 2203, 2209, and 2211 of the first signal, for which four repeated transmissions are scheduled, in the first, second, fifth, and sixth slots.
Method A-5: A combination of the above methods may be possible. Alternatively, in a case where multiple carriers are configured for the UE, when the third and fourth slots in a cell, in which repeated transmission of the first signal is scheduled, correspond to the second period as illustrated in FIG. 22, but corresponding slots in another cell correspond to the first period, the UE may transmit the first signals scheduled in the third and fourth slots through the other cell. If the subcarrier spacings are different, at least one of the methods described in the (1-3)th embodiment may be considered.

### Second Embodiment. Cell DRX Operation Method 2 in CA Environment

According to an embodiment of the disclosure, two different signals may be scheduled to the UE through multiple carriers while overlapping with each other on time resources. A first combination of possible signals may indicate that a first signal is a PUSCH and a second signal is a PUSCH, a second combination may indicate that a first signal is a PUCCH and a second signal is a PUSCH, and a third combination may indicate that a first signal is a PUCCH and a second signal is a PUCCH. In a case of the first combination, the two different signals may be transmitted simultaneously. In a case of the second combination, if the PUCCH and the PUSCH have the same priority information, UCI included in the PUCCH may be transmitted by being piggybacked on the PUSCH. If the PUCCH and the PUSCH have different priorities, only a signal having higher priority among the two signals may be transmitted. For example, if the priority of the PUCCH is higher than that of the PUSCH, the UE may transmit the PUCCH and drop the PUSCH. Alternatively, only if the PUCCH and the PUSCH have different priorities, the UE may transmit the PUCCH and the PUSCH on different carriers, respectively. The UE may perform this operation only when the UE has a capability to perform the operation (first capability) and receives a relevant higher signal from the base station. Alternatively, even when the PUCCH and the PUSCH have different priorities, the UE may piggyback UCI existing in the PUCCH on the PUSCH. The UE may perform this operation only when the UE has a capability to perform the operation (second capability) and receives a relevant higher signal from the base station. In a case of the third combination, PUCCHs scheduled on different carriers being transmittable may be limited to the case where the respective carriers belong to different PUCCH groups.

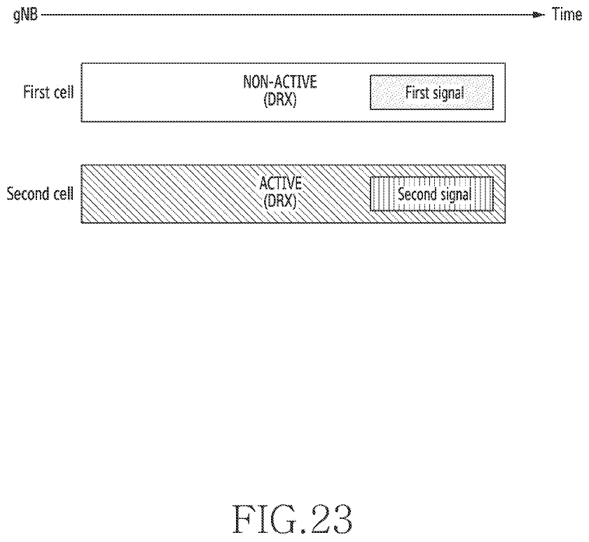

FIG. 23 shows a case where, in a limited case where a PUCCH (first signal) and a PUSCH (second signal) have different priorities, based on the second combination according to an embodiment of the disclosure, when the UE transmits the PUCCH and the PUSCH on different carriers (a first cell and a second cell), a period to which the PUCCH belongs overlaps with the second period of cell DRX and thus the UE may be unable to perform PUCCH transmission. In this case, if the UE is able to perform PUSCH transmission in the second cell, the UE may transmit UCI belonging to the PUCCH by piggybacking the UCI on the PUSCH. This operation may be applied only when a separate higher signal is provided to the UE. Alternatively, this operation may be applied only when the UE has both the first capability and the second capability. This operation may be applied only when a cell DTX-related signal indicating the second period is a higher signal. Alternatively, this operation may be applied only when a cell DTX-related signal indicating the second period is an L1 signal. Alternatively, this operation may be applied only when a cell DTX-related signal indicating the second period is a combination of a higher signal and an L1 signal.

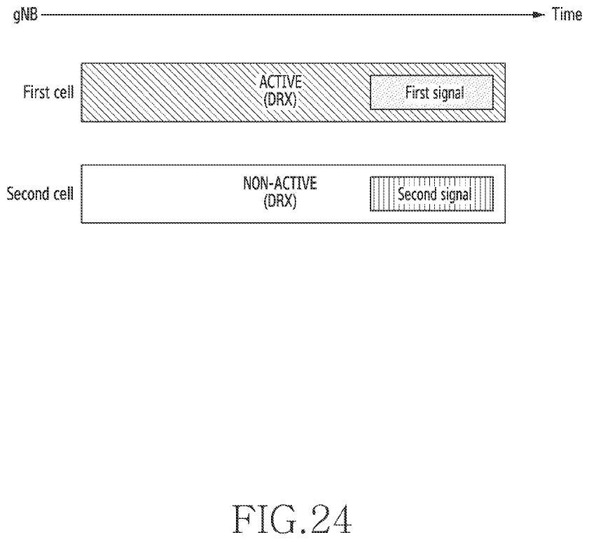

FIG. 24 illustrates an operation of a UE when DTX/DRX is applied in a CA environment in a wireless communication system according to an embodiment of the disclosure. FIG. 24 shows a case where, based on the first combination according to an embodiment of the disclosure, when a PUCCH (first signal) and a PUSCH (second signal) are scheduled on different carriers and at least one symbol overlaps on time resources, the UE may piggyback UCI belonging to the PUCCH on the PUSCH. Under the situation, in a case where the carrier on which the second signal is scheduled overlaps with the second period of cell DTX, UCI belonging to the PUCCH may be piggybacked on the PUSCH, and thus as a result, the UE may be unable to transmit both the control information and data information included in the PUCCH and PUSCH. Therefore, when the second signal overlaps with the second period as illustrated in FIG. 24, the UE does not perform piggyback and may transmit the PUCCH in the first cell. This operation may be applied only when a separate higher signal is provided to the UE. This operation may be applied only when a cell DTX-related signal indicating the second period is a higher signal. Alternatively, this operation may be applied only when a cell DTX-related signal indicating the second period is an L1 signal. Alternatively, this operation may be applied only when a cell DTX-related signal indicating the second period is an L1 signal and the UE fails to properly receive a relevant L1 signal. Alternatively, this operation may be applied only when a cell DTX-related signal indicating the second period is a combination of a higher signal and an L1 signal.

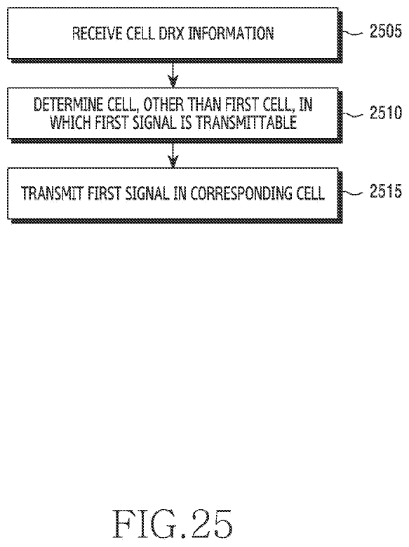

In the first embodiment and the second embodiment, a UE operation in a situation where cell DTX or cell DRX-related first period and second period configuration information is differently provided for each cell (or carrier) in a CA situation has been described. A relevant UE operation flowchart is described with reference to FIG. 25.

FIG. 25 illustrates an operation of a UE in a wireless communication system according to an embodiment of the disclosure.

Referring to FIG. 25, in operation 2505, after receiving a CA configuration, a UE may receive cell DRX information through a higher signal or L1 signal.

Thereafter, in operation 2510, under a situation where uplink signals (first signals) scheduled through a different signal are scheduled in a first cell, when at least one symbol of the time resource of a corresponding first signal overlaps with the second period, the UE may determine whether transmission is possible in a cell other than the first cell.

Then, in operation 2515, when a cell in which transmission is possible is determined, the UE may transmit the first signal in the cell. Therefore, the UE may reduce a transmission delay time.

### Third Embodiment: Coverage Enhancement Method in Environment where Limited Transmission/Reception Antennas are Used

As a method for reducing power consumption at the base station, a method of limiting the number of antennas used for actual signal transmission and reception among the transmission/reception antennas installed in the base station equipment may be considered. For example, if a base station equipped with 128 antennas actually performs signal transmission and reception by using only 64 antennas during a specific period, the power consumption required to operate the antennas may theoretically be reduced by at least half. However, due to the limited number of antennas, the coverage operable by the base station may be relatively reduced. Accordingly, if a related signal providing information on a limited number of antennas is provided to UEs, the UEs may determine that repeated transmission is applied for downlink signal reception or uplink signal transmission. In addition, the repeated transmission may be applicable only to particular signals among downlink signals, and for example, at least one of SSB, PBCH, PDCCH, and PDSCH may be possible. In addition, the repeated transmission may be applicable only to particular signals among uplink signals, and for example, at least one of PUCCH. PUSCH, and PRACH may be possible. The related signal providing information on a limited number of antennas may be a UE-common or UE-specific signal. In addition, the related signal providing information on a limited number of antennas may be indirectly conveyed to the UE by a difference in parameters indicating a power offset value between a PDSCH and a CSI-RS. Alternatively, the related signal providing information on a limited number of antennas may be indirectly conveyed to the UE through a parameter that indicates the maximum power transmission value of the base station. In a situation where the UE has received a related signal providing information on a limited number of antennas in examples, the UE may perform repeated transmissions X times a count indicated by information received in an original scheduling. Alternatively, the base station may directly inform the UE of a repeated transmission count required to be added. Alternatively, the UE may implicitly determine a repeated transmission count required to be added through a related implicit signal providing information on a limited number of antennas. A method of implicit determination may refer to determining a repeated transmission value required to be added, based on information provided by the base station by using a separate standardized table.

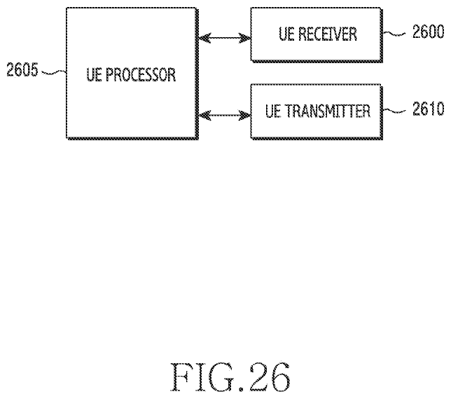

FIG. 26 illustrates a structure of a UE in a wireless communication system according to an embodiment of the disclosure.

Referring to FIG. 26, the UE may include a transceiver, which refers to a UE receiver 2600 and a UE transmitter 2610 as a whole, a memory (not illustrated), and a UE processor 2605 (or UE controller or processor). The UE transceiver 2600 and 2610, the memory, and the UE processor 2605 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

The processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

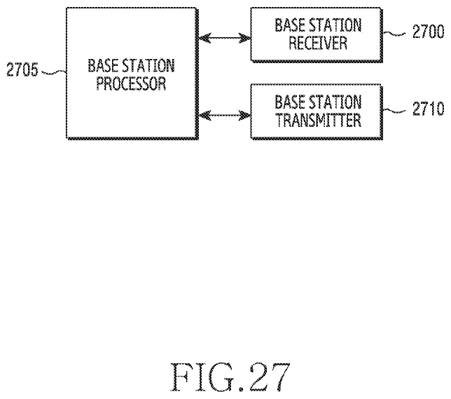

FIG. 27 illustrates a structure of a base station in a wireless communication system according to an embodiment of the disclosure.

Referring to FIG. 27, the base station may include a transceiver, which refers to a base station receiver 2700 and a base station transmitter 2710 as a whole, a memory (not illustrated), and a base station processor 2705 (or base station controller or processor). The base station transceiver 2700 and 2710, the memory, and the base station processor 2705 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet. Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

1. A method performed by user equipment (UE) in a wireless communication system, the method comprising:
receiving, from a base station, a first signal including information related to cell discontinuous reception (DRX) for a first cell; and
identifying a cell DRX non-active period, based on the information related to the cell DRX,
wherein a second signal to the base station is not transmitted in a slot corresponding to the cell DRX non-active period.

2. The method of claim 1, wherein the cell DRX for the first cell and cell DRX for a second cell different from the first cell are independently indicated, respectively.

3. The method of claim 1, wherein the first signal comprises radio resource control (RRC) signaling for configuring the cell DRX or downlink control information (DCI) for indicating the cell DRX.

4. The method of claim 1, wherein the second signal comprises a signal transmitted through physical uplink control channel (PUCCH) repetitions.

5. A user equipment (UE) in a wireless communication system, the UE comprising:
a transceiver; and
a controller coupled to the transceiver,
wherein the controller is configured to:
receive, from a base station, a first signal including information related to cell discontinuous reception (DRX) for a first cell; and
identify a cell DRX non-active period, based on the information related to the cell DRX, and
wherein a second signal to the base station is not transmitted in a slot corresponding to the cell DRX non-active period.

6. The UE of claim 5, wherein the cell DRX for the first cell and cell DRX for a second cell different from the first cell are independently indicated, respectively.

7. The UE of claim 5, wherein the first signal comprises radio resource control (RRC) signaling for configuring the cell DRX or downlink control information (DCI) for indicating the cell DRX.

8. The UE of claim 5, wherein the second signal comprises a signal transmitted through physical uplink control channel (PUCCH) repetitions.

9. A method performed by a base station in a wireless communication system, the method comprising transmitting, to a user equipment (UE), a first signal including information related to cell discontinuous reception (DRX) for a first cell, wherein a second signal from the UE is not received in a slot corresponding to a cell DRX non-active period.

10. The method of claim 9, wherein the cell DRX for the first cell and cell DRX for a second cell different from the first cell are independently indicated, respectively.

11. The method of claim 9, wherein the first signal comprises radio resource control (RRC) signaling for configuring the cell DRX or downlink control information (DCI) for indicating the cell DRX.

12. The method of claim 9, wherein a configured uplink grant and hybrid automatic repeat request HARQ information associated with a slot corresponding to the non-active period are not transmitted to a HARQ entity, and
wherein channel status information (CSI) reporting from the UE is not performed.

13. A base station in a wireless communication system, the base station comprising:
a transceiver; and
a controller coupled to the transceiver,
wherein the controller is configured to transmit, to a user equipment (UE), a first signal including information related to cell discontinuous reception (DRX) for a first cell, and
wherein a second signal from the UE is not received in a slot corresponding to a cell DRX non-active period.

14. The base station of claim 13, wherein the cell DRX for the first cell and cell DRX for a second cell different from the first cell are independently indicated, respectively.

15. The base station of claim 13, wherein the first signal comprises radio resource control (RRC) signaling for configuring the cell DRX or downlink control information (DCI) for indicating the cell DRX.
